(19) United States
(12) Patent Application Publication
(10) Pub. No.: US 2025/0317687 A1
(43) Pub. Date: Oct. 9, 2025

(54) ACOUSTIC SYSTEM AND VEHICLE

(71) Applicant: TS TECH CO., LTD., Asaka-shi, Saitama (JP)

(72) Inventors: Akira MIYOSHI, Tochigi (JP); Tomoyuki KURIMOTO, Tochigi (JP); Munetaka KOWA, Tochigi (JP); Hayato SHIDA, Tochigi (JP); Hiroki ITO, Tochigi (JP); Takuto KOJIMA, Tochigi (JP)

(21) Appl. No.: 18/865,431

(22) PCT Filed: May 11, 2023
(86) PCT No.: PCT/JP2023/017807

§ 371 Date: Nov. 13, 2024

Related U.S. Application Data
(60) Provisional application No. 63/341,506, filed on May 13, 2022.
(60) Provisional application No. 63/349,766, filed on Jun. 7, 2022.

(30) Foreign Application Priority Data
Sep. 29, 2022 (JP) 2022-157057
Apr. 19, 2023 (JP) 2023-068678
Apr. 24, 2023 (JP) 2023-071002

(51) Int. Cl. H04R 3/12; B60N 2/00; B60N 2/879; H04R 1/02

(52) U.S. Cl. CPC H04R 3/12; B60N 2/0022; B60N 2/0023; B60N 2/879; H04R 1/025; B60N 2230/30; H04R 2430/01; H04R 2499/13

(57) ABSTRACT

An acoustic system includes an interior member for a conveyance including at least one speaker; a state detection unit that detects a state of an occupant or the interior member; and a control unit that is connected to the speaker and the state detection unit, and controls the speaker. The control unit includes a state determination unit that determines the state of the occupant or the interior member based on information received from the state detection unit, and an acoustic control unit that controls, when sound is emitted from the speaker, at least one of a volume, a tempo, and a direction of the sound emitted from the speaker, based on the determined state of the occupant or the interior member.

### TECHNICAL FIELD

The present invention relates to an acoustic system and a vehicle, particularly to an acoustic system and a vehicle including an interior member in which a speaker is installed.

### BACKGROUND ART

Conventionally, speakers are provided as acoustic devices at each position in a conveyance cabin, for example, in vehicle doors or conveyance seats. PATENT LITERATURE 1 discloses a conveyance seat including a speaker and a microphone for noise cancellation inside a headrest.

### CITATION LIST

### Patent Literature

PATENT LITERATURE 1: JP 2021-187331 A

### SUMMARY OF INVENTION

### Technical Problem

In the headrest described in PATENT LITERATURE 1, the speaker and the microphone are provided, but sound is output regardless of the state of an occupant. For that reason, depending on the posture of the occupant, the sound emitted from the speaker may cause discomfort. For that reason, it has been desired to generate a suitable sound according to the state of the occupant, for example, to make sound easier to perceive, or to suppress discomfort.

The present invention has been made in view of the above-described problems, and an object of the present invention is to provide an acoustic system and a vehicle that emit a suitable sound according to the state of an occupant.

In addition, in addition to the above-described object, another object is to protect an acoustic device against a load received by a conveyance seat, particularly a load received from an occupant.

In addition, still other objects include improving the ease of attaching a harness or a connector, suppressing an increase in the size of a headrest, and suppressing vibration of the headrest.

### Solution to Problem

The above-described problems are solved by an acoustic system of the present invention, including: an interior member for a conveyance including at least one speaker; a state detection unit that detects a state of an occupant or the interior member; and a control unit that is connected to the speaker and the state detection unit, and that controls the speaker. The control unit includes a state determination unit that determines the state of the occupant or the interior member based on information received from the state detection unit, and an acoustic control unit that controls, when sound is emitted from the speaker, at least one of a volume, a tempo, and a direction of the sound emitted from the speaker, based on the determined state of the occupant or the interior member.

Since the sound control unit controls at least one of the volume, the tempo, and the direction of the sound emitted from the speaker, based on the state of the occupant or the interior member, it is possible to provide the acoustic system that generates a sound suitable for the occupant.

In addition, in the acoustic system, it is preferable that the state detection unit can acquire biometric information of the occupant, it is preferable that the state determination unit determines the state of the occupant based on the biometric information of the occupant, and it is preferable that the acoustic control unit controls the sound emitted from the speaker, based on the state of the occupant.

Since the acoustic control unit controls the sound based on the biometric information of the occupant, a sound more suitable for the occupant can be emitted from the speaker.

In addition, in the acoustic system, it is preferable that the state determination unit determines a wakefulness of the occupant based on the biometric information of the occupant, and it is preferable that the acoustic control unit controls the sound emitted from the speaker, based on the determined wakefulness of the occupant.

Since the acoustic control unit controls the sound emitted from the speaker, based on the wakefulness of the occupant, a more suitable sound can be emitted based on the wakefulness.

In addition, in the acoustic system, it is preferable that when the wakefulness of the occupant decreases, the acoustic control unit increases the volume of the sound emitted from the speaker, or makes the tempo of the sound faster.

When the wakefulness of the occupant decreases, the acoustic control unit increases the volume of the sound emitted from the speaker, or makes the tempo of the sound faster, for example, the wakefulness of the occupant can be raised.

In addition, in the acoustic system, it is preferable that the interior member is a conveyance seat in which the occupant is seated, it is preferable that the conveyance seat includes at least two speakers disposed to be separated from each other in a seat width direction, it is preferable that the state determination unit determines a posture of the occupant or a position of the conveyance seat based on the information received from the state detection unit, and it is preferable that the acoustic control unit controls the sound emitted from the speakers, based on the determined posture of the occupant or the determined position of the conveyance seat.

Since the acoustic control unit controls the sound based on the posture of the occupant or the position of the conveyance seat, a sound more suitable for the occupant can be emitted.

In addition, in the acoustic system, it is preferable that the conveyance seat is rotatable about a rotation axis in a seat up to down direction, it is preferable that the state determination unit determines a rotation angle of the conveyance seat, and it is preferable that the acoustic control unit controls the sound emitted from the speakers, based on the determined rotation angle.

Since the acoustic control unit controls the sound based on the rotation angle of the conveyance seat, a sound more suitable for the occupant can be emitted.

In addition, in the acoustic system, it is preferable that the interior members for the conveyance are a plurality of rows of the conveyance seats disposed side by side in a front to rear direction, it is preferable that the state determination unit determines whether the occupant is seated in the conveyance seat, and it is preferable that the acoustic control unit controls the sound emitted from the speakers according to a seating state of the occupant.

Since the acoustic control unit controls the sound according to the seating state of the occupant, a sound suitable for the seated occupant in the plurality of rows of conveyance seats can be emitted.

In addition, in the acoustic system, it is preferable that the state determination unit determines a position of a head of the occupant, and it is preferable that the acoustic control unit controls the sound emitted from the speakers, based on the determined position of the head of the occupant.

Since the acoustic control unit controls the sound based on the position of the head of the occupant, a sound more suitable for the occupant can be emitted.

In addition, in the acoustic system, it is preferable that the interior member is a conveyance seat in which the occupant is seated, and it is preferable that the conveyance seat includes a damper for suppressing vibration at a position adjacent to the speaker.

Since the damper is provided at a position adjacent to the speaker, for example, vibration of the interior member caused by the sound emitted by the speaker can be suppressed.

In addition, in the acoustic system, it is preferable that the conveyance seat includes a headrest that supports a head of the occupant, it is preferable that the conveyance seat includes at least two speakers inside the headrest, the two speakers being disposed to be separated from each other in a seat width direction, it is preferable that the headrest includes a headrest pillar serving as a skeleton, and it is preferable that the damper is attached to the headrest pillar at a position sandwiched between the two speakers.

Since the damper is attached to the headrest pillar at a position sandwiched between the two speakers, vibration of the headrest caused by the speaker can be suppressed.

In addition, the above-described problems are solved by a vehicle including the acoustic system.

### Advantageous Effects of Invention

According to the acoustic system of the present invention, since the acoustic control unit controls at least one of the volume, the tempo, and the direction of the sound emitted from the speaker, based on the state of the occupant or the interior member, it is possible to provide the acoustic system that generates a sound suitable for the occupant.

In addition, since the acoustic control unit controls the sound based on the biometric information of the occupant, a sound more suitable for the occupant can be emitted from the speaker.

In addition, since the acoustic control unit controls the sound emitted from the speaker, based on the wakefulness of the occupant, a more suitable sound based on the wakefulness is emitted.

In addition, when the wakefulness of the occupant decreases, since the acoustic control unit increases the volume of the sound emitted from the speaker, or makes the tempo of the sound faster, for example, the wakefulness of the occupant can be raised.

In addition, since the acoustic control unit controls the sound based on the posture of the occupant or the position of the conveyance seat, a sound more suitable for the occupant can be emitted.

In addition, since the acoustic control unit controls the sound based on the rotation angle of the conveyance seat, a sound more suitable for the occupant can be emitted.

In addition, since the acoustic control unit controls the sound according to the seating state of the occupant, a sound suitable for the seated occupant in the plurality of rows of conveyance seats can be emitted.

In addition, since the acoustic control unit controls the sound based on the position of the head of the occupant, a sound more suitable for the occupant can be emitted.

In addition, since the damper is provided at a position adjacent to the speaker, for example, vibration of the interior member caused by the sound emitted by the speaker can be suppressed.

In addition, since the damper is attached to the headrest pillar at a position sandwiched between the two speakers, for example, vibration of the headrest caused by the speaker can be suppressed.

### BRIEF DESCRIPTION OF DRAWINGS

FIG. 1 is a view showing a vehicle and a vehicle cabin including an acoustic system according to a first embodiment.

FIG. 2 is a perspective view showing a door and a conveyance seat that are interior members.

FIG. 3A is a descriptive view showing the operation of speakers in the conveyance seat.

FIG. 3B is a view showing another example of a conveyance seat, is a descriptive view for describing how the orientation of sound is changed by using a plurality of speakers, and is a view of a seat back when viewed from the front.

FIG. 3C is a view showing another example of a conveyance seat, is a descriptive view for describing how the orientation of sound is changed by using a plurality of speakers, and is a view of the seat back when viewed from above.

FIG. 4 is a perspective view showing a frame of the conveyance seat.

FIG. 5 is a block diagram showing a hardware configuration of an ECU that controls the acoustic system.

FIG. 6 is a block diagram showing a functional configuration of the acoustic system.

FIG. 7 is a flowchart describing the operation of the acoustic system.

FIG. 8 is a view showing the vehicle cabin in which the orientation of a middle seat is changed.

FIG. 9 is an exploded perspective view of a headrest frame including a damper.

FIG. 10 is a view showing the headrest frame including the damper, and is a view showing a state where a front cover is removed.

FIG. 11 is a cross-sectional view taken along line B-B of FIG. 10, and is a descriptive view for describing a positional relationship between the damper and a connecting member that supports connectors.

FIG. 12A is a view showing another example of a headrest frame.

FIG. 12B is a view showing another example of a headrest frame.

FIG. 12C is a view showing another example of a headrest frame.

FIG. 13 is a descriptive view for describing the position of the damper, and is a schematic view of the conveyance seat when viewed from the front.

FIG. 14 is a descriptive view for describing the position of the damper, and is a schematic view of the conveyance seat when viewed from the side.

FIG. 15 is a left side view of a motorcycle of the second embodiment.

FIG. 16 is a schematic diagram of the first example of a conveyance seat assembly installed in a motorcycle, viewed from the side.

FIG. 17 is a schematic diagram of the conveyance seat assembly of the first example, viewed from above.

FIG. 18 is an oblique view of the back side of the seat of the first example conveyance seat assembly.

FIG. 19 is a schematic diagram of the conveyance seat assembly of the second example, viewed from the side.

FIG. 20 is a schematic diagram of the conveyance seat assembly of the second example, viewed from above.

FIG. 21 is an oblique view of the back side of the seat of the conveyance seat assembly of the second example.

FIG. 22 is a schematic diagram of the conveyance seat assembly of the third example, viewed from the side.

FIG. 23 is a schematic diagram of the conveyance seat assembly of the third example, viewed from above.

FIG. 24 is an oblique view of the back side of the seat of the third example conveyance seat assembly.

FIG. 25 is a schematic diagram of the conveyance seat assembly of the fourth example, viewed from the side.

FIG. 26 is a schematic diagram of the conveyance seat assembly of the fourth example, viewed from above.

FIG. 27 is an oblique view of the back side of the seat of the fourth example conveyance seat assembly.

FIG. 28 is a view schematically showing a configuration of an electric vehicle of a third embodiment.

FIG. 29 is a perspective view of a vehicle seat.

FIG. 30 is a view describing a state where a side portion of a seat back is in a “normal position”.

FIG. 31 is a view describing a state where the side portion of the seat back is in a “protruding position”.

FIG. 32 is a block diagram of the electric vehicle.

FIG. 33 is a view showing a main flow in the control of the electric vehicle.

FIG. 34 is a view showing the flow of control related to an occupant identification process.

FIG. 35 is a view showing the flow of control related to a passenger detection process.

FIG. 36A is a view showing the flow of a mode determination process (part 1).

FIG. 36B is a view showing the flow of the mode determination process (part 2).

FIG. 36C is a view showing the flow of the mode determination process (part 3).

FIG. 37 is a view showing the flow of a mode acquisition control process.

FIG. 38 is a view showing the flow of a component control process.

FIG. 39 is a view showing the flow of a movement device control process.

### DESCRIPTION OF EMBODIMENTS

### First Embodiment

Hereinafter, configurations of an acoustic system 100 and a vehicle V in which the acoustic system 100 is installed according to one embodiment of the present invention will be described with reference to the drawings. However, the embodiment to be described below is provided for easy understanding of the present invention, and does not limit the present invention. Namely, the present invention can be modified or improved without departing from the concept of the present invention, and it goes without saying that the present invention includes equivalents thereof.

In addition, in the following description, contents regarding the materials, shapes, and sizes of components constituting an interior component used in the acoustic system 100 are provided as merely one specific example, and do not limit the present invention.

Incidentally, hereinafter, an automobile capable of autonomous driving will be provided as an example of the vehicle V including the acoustic system 100, and a configuration example thereof will be described.

In addition, in the following description, the “front to rear direction” is a front to rear direction of the vehicle V, and is a direction coinciding with a traveling direction when the vehicle travels. In addition, the “width direction” is a lateral width direction of the vehicle V, and the “up to down direction” is an up to down direction of the vehicle V, and is a direction coinciding with a vertical direction when the vehicle V travels on a horizontal surface.

In addition, in the following description, when various directions are described with the terms “seat” added, such as “seat width direction” and “seat height direction”, the various directions refer to the directions with respect to a conveyance seat S installed in the vehicle V, and when directions are described with the terms “vehicle” added, such as “vehicle inside” and “vehicle outside”, the directions refer to the directions with respect to the vehicle V.

### <Vehicle V>

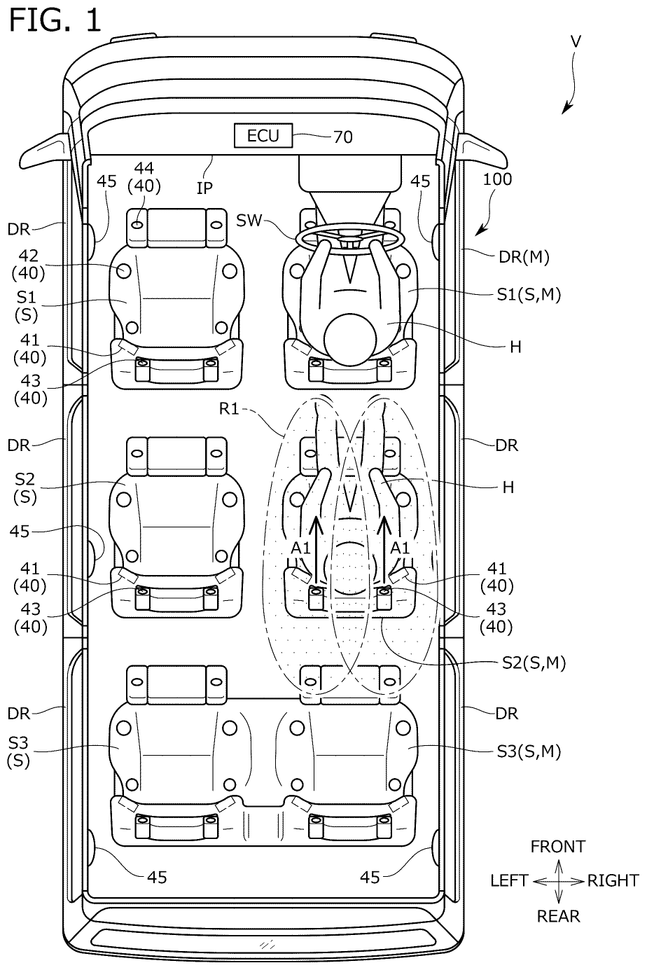

The vehicle V is an automobile including a plurality of rows of the conveyance seats S as shown in FIG. 1. The vehicle V includes a front seat S1 disposed on the front side; a middle seat S2 disposed behind the front seat S1; and a rear seat S3 disposed at a rearmost position. The rear seat S3 is integrally configured such that seats disposed on the right and left are connected to each other, but may be configured such that seats are independent of each other.

Incidentally, the front seat S1, the middle seat S2, and the rear seat S3 basically have the same configuration, and in the following description, are referred to the conveyance seats S unless there is particular need to distinguish therebetween.

In addition, the vehicle V includes a steering wheel SW that is operated by a driver, and an instrument panel IP. The instrument panel IP is provided with an operating panel, and an occupant H of the vehicle V can change the music played in a vehicle cabin, the position of a seat, or the like by inputting an instruction to the operating panel.

Vehicle doors DR that can be opened and closed with respect to a vehicle body are provided on the right and left outer sides of each the conveyance seat S, and the occupant H seated in each conveyance seat S can get in and out of the vehicle V by opening the vehicle doors DR on the right and left outer sides. The vehicle door DR corresponds to an interior member M of the present invention.

### <Configuration of Acoustic System 100>

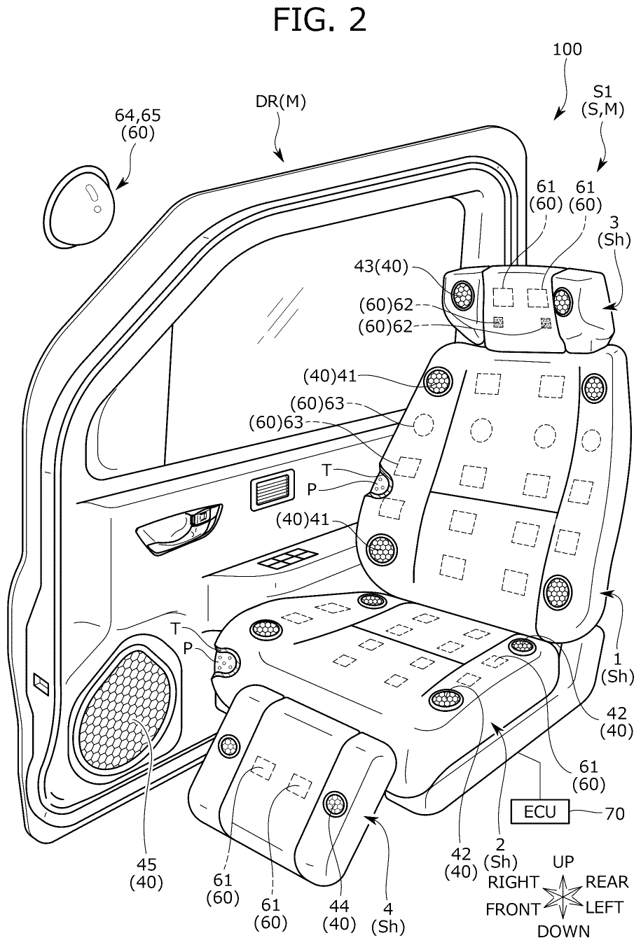

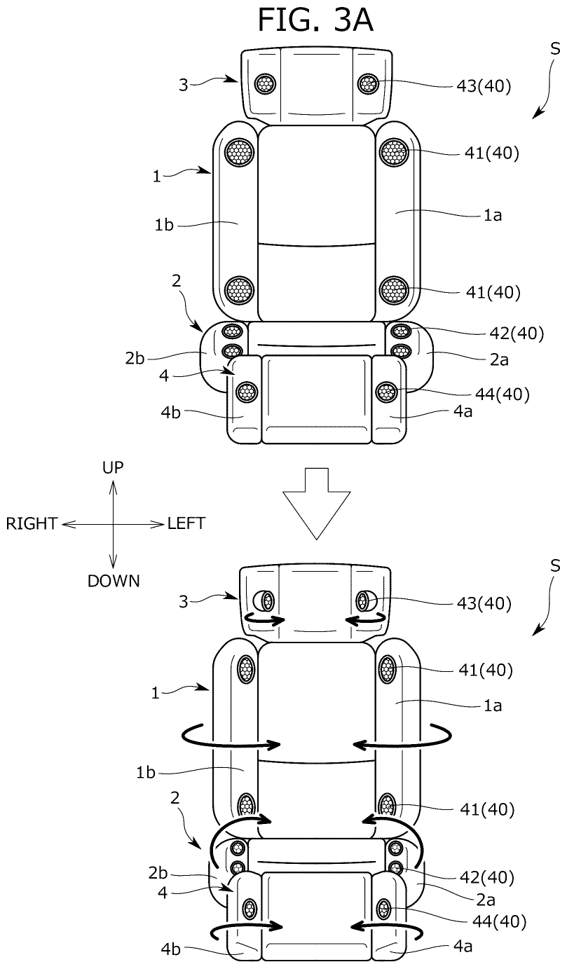

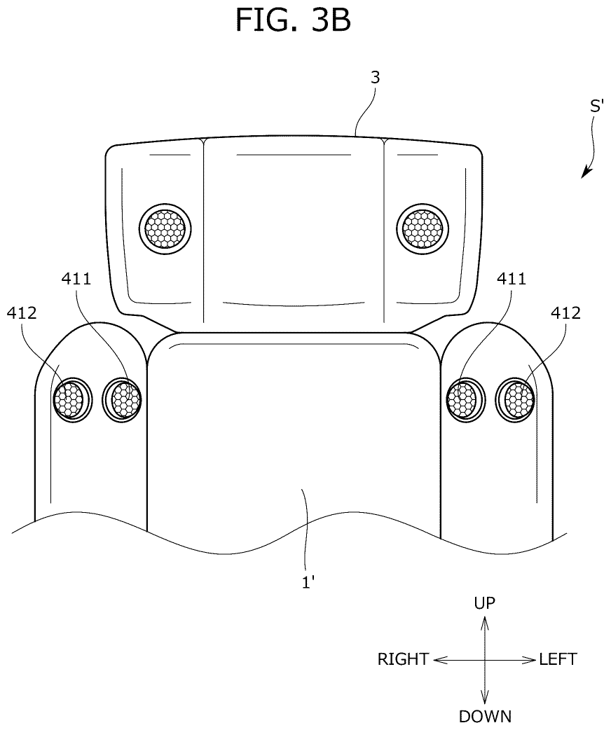

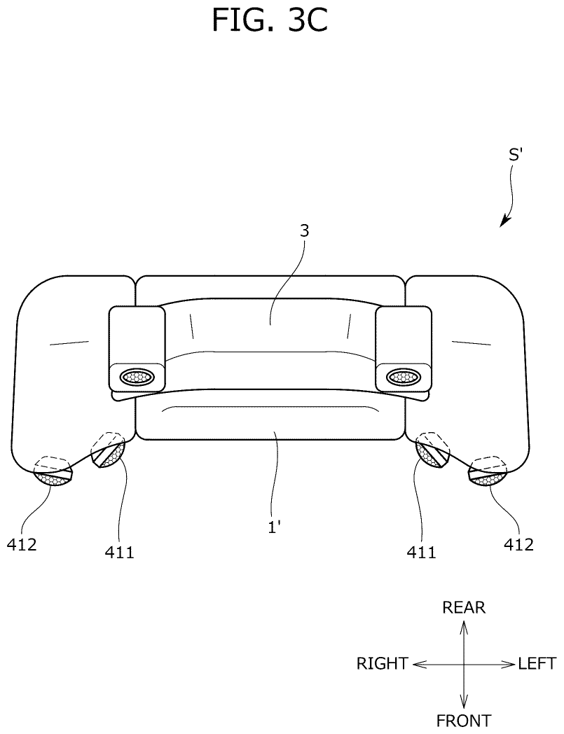

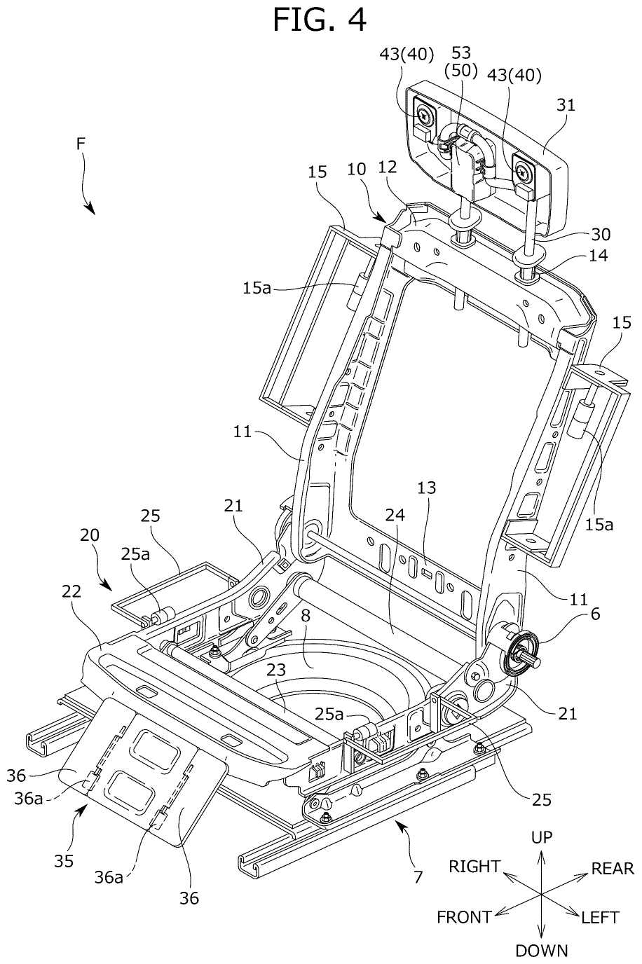

Next, a configuration of the acoustic system 100 according to one embodiment of the present invention will be described. FIG. 2 is a perspective view showing the interior member M of the vehicle V including the acoustic system 100 according to the present embodiment. In FIG. 2, the front seat S1 located on the front right side of the vehicle V and the vehicle door DR located on the right outer side of the front seat S1 are shown as the interior members M. FIG. 3A is a front view showing the conveyance seat S including the front seat S1, the upper part of FIG. 3A shows a state before both side portions of the conveyance seat S are deformed, and the lower part shows a state after both the side portions are deformed. FIGS. 3B and 3C are views showing another example of the conveyance seat S. FIG. 4 is a perspective view showing a frame of the conveyance seat S including the front seat S1. Incidentally, for convenience of illustration, a part of the front seat S1 in FIG. 2 is illustrated with a skin T removed and a pad P exposed.

### <Conveyance Seat S>

A configuration of the conveyance seat S including the front seat S1 will be described. The conveyance seat S includes a seat back 1 that supports the back of the seated occupant H; a seat cushion 2 that supports the thighs and buttocks of the occupant H; and a headrest 3 that is provided on an upper end portion of the seat back 1, and that supports the head of the occupant H. In addition, the conveyance seat S includes an ottoman 4 that supports the legs of the occupant H. Hereinafter, the seat back 1, the seat cushion 2, the headrest 3, and the ottoman 4 may be collectively referred to as a seat body Sh.

### <Speaker 40>

The conveyance seat S is provided with a plurality of speakers 40 that are sound generation devices that emit sound. Each of the speakers 40 is connected to a control unit (ECU) 70, which is provided inside the vehicle, by a cable, and can emit a music, warning sound, or the like in response to an instruction from the ECU 70.

As shown in FIG. 2, back speakers 41 are disposed on the right and left of each of an upper end portion and a lower end portion of the seat back 1, respectively. Cushion speakers 42 are disposed on the right and left of each of a front end portion and a rear end portion of the seat cushion 2, respectively. A headrest speaker 43 is disposed at each of both right and left end portion of the headrest 3. An ottoman speaker 44 is disposed at each of both right and left end portions of the ottoman 4.

In addition, a door speaker 45 is also disposed on the lower side of the vehicle door DR that is the interior member M.

The back speaker 41, the cushion speaker 42, the headrest speaker 43, the ottoman speaker 44, and the door speaker 45 each have the same configuration as the function of emitting sound. Incidentally, in the following description, unless there is particular need to distinguish between positions where the back speaker 41, the cushion speaker 42, the headrest speaker 43, the ottoman speaker 44, and the door speaker 45 are disposed, the back speaker 41, the cushion speaker 42, the headrest speaker 43, the ottoman speaker 44, and the door speaker 45 may be referred to as the speakers 40.

Side portions (a right side portion 1b and a left side portion 1a) of the seat back 1 of the conveyance seat S are configured to be movable in the front to rear direction. Specifically, as shown in the lower part of FIG. 3A, the orientations of the back speakers 41 provided on the right side portion 1b and the left side portion 1a of the seat back 1 can be changed by rotating the right side portion 1b and the left side portion 1a about an axis in the front to rear direction, the axis extending in the up to down direction. The orientations of sound emitted from the back speakers 41 can be changed by changing the orientations of the back speakers 41. The rotation of the right side portion 1b and the left side portion 1a of the seat back 1 is executed by rotating seat back movable portions 15 to be described later. The seat back movable portions 15 are controlled by an acoustic control unit 82 of the ECU 70, and are configured to rotate in response to an instruction from the ECU 70.

The headrest speakers 43 disposed in the headrest 3 are also configured to be movable. The headrest speakers 43 can change the orientations by rotating themselves. The headrest speakers 43 are rotatable about an axis in the up to down direction, but may be configured to rotate about an axis in a right to left direction to change the orientations in the up to down direction.

Headrest movable portions 33 that rotate the headrest speakers 43 are controlled by the acoustic control unit 82 of the ECU 70, and are configured to rotate in response to an instruction from the ECU 70.

In addition, both side portions (a right side portion 2b and a left side portion 2a) of the seat cushion 2 and both side portions (a right side portion 4b and a left side portion 4a) of the ottoman 4 are also configured to be movable. Specifically, as shown in the lower part of FIG. 3A, the orientations of the cushion speakers 42 provided on the right side portion 2b and the left side portion 2a of the seat cushion 2 can be changed by rotating the right side portion 2b and the left side portion 2a of the seat cushion 2 about an axis in the up to down direction, the axis extending in the front to rear direction.

Regarding the ottoman 4, by rotating both side portions (the right side portion 4b and the left side portion 4a) about an axis in an extending direction of the ottoman 4, the orientations of the ottoman speakers 44 provided on both the side portions of the ottoman 4 can be changed, and the directions of the sound emitted from the ottoman speakers 44 can be changed.

The rotation of both the side portions of the seat cushion 2 are executed by operating seat cushion movable portions 25 to be described later. The rotation of both the side portions of the ottoman 4 is executed by operating ottoman movable portions 36 to be described later. The seat cushion movable portion 25 and the ottoman movable portion 36 are controlled by the acoustic control unit 82 of the ECU 70, and are configured to rotate in response to an instruction from the ECU 70.

Incidentally, in the present embodiment, the speakers 40 are provided in each of the seat back 1, the seat cushion 2, the headrest 3, and the ottoman 4; however, this configuration is one example, and the speakers 40 may not necessarily be provided in all of the seat back 1, the seat cushion 2, the headrest 3, and the ottoman 4. For example, the speakers 40 may be provided only at the upper end of the seat back 1 and on the right and left of the headrest 3, and the speakers 40 may not be provided in the seat cushion 2 and the ottoman 4. In addition, the seat cushion 2 and the ottoman 4 may not be provided with the seat cushion movable portions 25 and the ottoman movable portions 36 for rotating the side portions.

In addition, changing the direction of sound is not limited to being performed by rotating the side portion of the conveyance seat S, on which the speaker 40 is provided. For example, as in the case of a conveyance seat S′ shown in FIGS. 3B and 3C, the speaker 40 disposed on each of right and left shoulder portions of a seat back 1′ may be changed to include a first speaker 411 disposed on a seat inner side and a second speaker 412 disposed on a seat outer side. In this case, the first speaker 411 and the second speaker 412 are disposed such that the orientations in which sound is emitted are different from each other. Specifically, the first speaker 411 is disposed such that the direction in which sound is emitted faces the inner side of the conveyance seat S′, and the second speaker 412 is disposed such that the direction in which sound is emitted faces the outer side of the conveyance seat S. Since the speakers 40 disposed in different orientations are disposed close to each other, when sound is generated, the direction of sound can be changed by switching the speaker 40 that is used.

Incidentally, the first speaker 411 and the second speaker 412 themselves may be configured to be movable with respect to the seat back 1′, and may be able to change the directions of sound. In addition, similarly to the conveyance seat S shown in FIG. 3A, the right side portion 1b and the left side portion 1a of the seat back 1′ may be rotated by the seat back movable portions 15 to change the directions of sound. Incidentally, the configuration of the speaker 40 described above may be applied not only to the seat back 1′, but also to the seat cushion 2, the headrest 3, or the ottoman 4.

### <State Detection Unit 60>

In order to detect the state of the occupant H seated in the conveyance seat S, a plurality of state detection units 60 are provided in the conveyance seat S. In more detail, the conveyance seat S is provided with a plurality of seating detection units 61, brain wave detection units 62, and wakefulness detection units 63 serving as the state detection units 60.

### <Seating Detection Unit 61>

The seating detection units 61 are composed of, for example, pressure sensors, and detect the seating state of the occupant H by detecting a load from the occupant H. The seating detection units 61 are disposed, for example, at positions indicated by dotted rectangles in FIG. 2. Specifically, a plurality of the seating detection units 61 are disposed side by side in the up to down direction and the right to left direction on a seating surface of the seat back 1. In addition, a plurality of the seating detection units 61 are disposed side by side in the front to rear direction and the right to left direction on a seating surface of the seat cushion 2. In addition, the seating detection units 61 are disposed side by side in the right to left direction on a contact surface of the headrest 3, which comes into contact with the head of the occupant H. The seating detection units 61 are also disposed side by side in the right to left direction on a seating surface of the ottoman 4. Incidentally, the disposition of the seating detection units 61 is not limited thereto, and a larger number of the seating detection units 61 may be disposed side by side. In addition, the seating detection units 61 may be composed of capacitive sensors.

### <Brain Wave Detection Unit 62>

The brain wave detection units 62 are composed of brain wave sensors that detect brain waves of the occupant H. The emotions, physical condition, or the like of the occupant H can be detected by measuring brain waves emitted from the head of the occupant H. For example, the brain wave detection units 62 can detect, for example, whether the occupant H is in a happy mood, by measuring brain waves.

As indicated by hatched rectangles in FIG. 2, two brain wave detection units 62 are disposed side by side in the right to left direction on a seating surface of the headrest 3. The disposition of the brain wave detection units 62 is not limited thereto, and a larger number of the brain wave detection units 62 may be disposed side by side.

### <Wakefulness Detection Unit 63>

The wakefulness detection units 63 are composed of, for example, biometric sensors (pressure sensors) that detect biometric information such as the heart rate, pulse wave, respiratory rate, and the like of the occupant. The physical condition or wakefulness of the occupant H is detected by measuring biometric information such as heart rate, pulse wave, or respiratory rate using the wakefulness detection units 63. Each of the wakefulness detection units 63 may include a moisture detection sensor that measures the amount of sweat or an odor sensor that measures odor.

For example, as indicated by dotted circles in FIG. 2, the plurality of wakefulness detection units 63 are disposed side by side in the right to left direction on the seating surface of the seat back 1. The disposition of the wakefulness detection units 63 is not limited thereto, and a larger number of the wakefulness detection units 63 may be provided. In addition, the wakefulness detection units 63 may be disposed in the headrest 3 and the seat cushion 2.

As the state detection unit 60, an interior vehicle camera 64 or an infrared camera 65 may be provided at a position where an image of the occupant H can be captured, for example, on a ceiling or in the instrument panel. The posture of the occupant H is determined based on the image captured by the interior vehicle camera 64. In addition, the physical condition of the occupant H is determined by measuring a body temperature of the occupant H using the infrared camera 65.

In addition, a door sensor 66 that detects the open/closed state of the vehicle door DR may be provided as the state detection unit 60.

### <Seat Frame F>

A basic configuration of a seat frame F forming the skeleton of the conveyance seat S will be described with reference to FIG. 4. As shown in FIG. 4, the seat frame F is provided inside the conveyance seat S. The seat frame F is composed of a seat back frame 10 forming the skeleton of the seat back 1; a seat cushion frame 20 forming the skeleton of the seat cushion 2; and a headrest pillar 30 forming the skeleton of the headrest 3. In addition, the seat frame F includes an ottoman frame 35 forming the skeleton of the ottoman 4 at a front end portion of the seat cushion frame 20. In addition, the headrest pillar 30 is provided with a headrest frame 31 that accommodates the headrest speakers 43 and a headrest damper 53.

The conveyance seat S is formed by placing the pad P made of urethane foam or the like on the seat frame F, and covering the pad P with the skin T made of fabric, leather, or the like.

As shown in FIG. 4, the seat back frame 10 is formed in a rectangular frame shape as a whole, and includes a pair of back side frames 11 and 11 disposed on the right and right; an upper frame 12; and a lower frame 13.

The pair of back side frames 11 and 11 are members that are disposed on the right and left of the seat back frame 10 as described above, and that are basically configured to be bilaterally symmetric. The pair of back side frames 11 and 11 are provided to extend in the seat up to down direction. The width of each of the pair of back side frames 11 and 11 in the seat front to rear direction is formed to increase as each of the back side frames 11 and 11 extends from a seat upper side toward a seat lower side. A peripheral edge portion on a seat front side and a peripheral edge portion on a seat rear side are formed in a curved shape to protrude toward the seat front side.

The upper frame 12 is disposed between the pair of back side frames 11 and 11, and connects upper ends of the pair of back side frames 11 and 11. In addition, the lower frame 13 connects lower ends of the pair of back side frames 11 and 11.

The upper frame 12 is provided with a pair of headrest holders 14 through which the headrest pillar 30 of the headrest 3 is inserted.

In addition, the pair of back side frames 11 and 11 are provided with the seat back movable portions 15 and 15, respectively, that rotate the side portions (the right side portion 1b and the left side portion 1a) of the seat back 1. An actuator 15a capable of changing the orientation of the seating surface of the seat back 1 to the right or left is attached to each of the seat back movable portions 15 and 15. By operating the seat back movable portions 15 and 15, seating surfaces of the right side portion 1b and the left side portion 1a of the seat back 1 can be rotated and moved forward, which is a direction toward the occupant, or rearward, which is a direction separated from the occupant.

The actuators 15a are controlled by the ECU 70, and rotate the side portions of the seat back 1 about an axis in the up to down direction in response to an instruction from the ECU 70. By rotating the side portions of the seat back 1, in addition to being able to improve the comfort of the conveyance seat, the orientations of the back speakers 41 provided on the side portions of the seat back 1 can be changed to any angle.

As shown in FIG. 4, the seat cushion frame 20 has a rectangular frame shape in a plan view. The seat cushion frame 20 includes a pair of cushion side frames 21 and 21 extending along the seat front to rear direction at both ends of the seat cushion frame 20 in the seat width direction. In addition, the seat cushion frame 20 includes a pan frame 22 and a front connecting frame 23 that connect front end portions of the pair of cushion side frames 21 and 21 in the seat width direction, and a rear connecting frame 24 that connects rear end portions of the pair of cushion side frames 21 and 21 in the seat width direction. In addition, although not shown, an S-spring is provided to bridge the front connecting frame 23 and the rear connecting frame 24.

In addition, the pair of cushion side frames 21 and 21 are provided with the seat cushion movable portions 25 and 25, respectively, that rotate the side portions (the right side portion 2b and the left side portion 2a) of the seat cushion 2. An actuator 25a capable of changing the orientations of seating surfaces of the side portions of the seat cushion up and down is attached to each of the seat cushion movable portions 25 and 25. The actuators 25a are controlled by the ECU 70, and can rotate the side portions of the seat cushion 2 about an axis in the front to rear direction in response to an instruction from the ECU 70. By rotating the side portions of the seat cushion 2, in addition to being able to improve the comfort of the conveyance seat S, the orientations of the cushion speakers 42 provided on the side portions of the seat cushion 2 can be changed.

The ottoman movable portions 36 that rotate the right and left side portions (the right side portion 4b and the left side portion 4a) of the ottoman 4 are provided on the right and left of the ottoman frame 35. The ottoman movable portions 36 are rotated in the front to rear direction by actuators 36a. More precisely, the ottoman movable portions 36 have the extending direction of the ottoman 4 as an axis, and rotate in a direction perpendicular to the extending direction. The actuators 36a can be controlled by the ECU 70, and can rotate the side portions of the ottoman 4 in response to an instruction from the ECU 70, and therefore, the orientations of the ottoman speakers 44 provided on the side portions of the ottoman 4 can be changed.

### <Reclining Device 6>

A lower end portion of the seat back 1 is connected to a rear end portion of the seat cushion 2, and a reclining device 6 is provided at the connecting portion. By using the reclining device 6, the seat back 1 is rotatable such that the rearward tilt angle of the seat back 1 with respect to the seat cushion 2 can be adjusted.

The reclining device 6 is provided with an angle sensor 6a as one example of the state detection unit 60 that detects the state of the conveyance seat S. The reclining angle (rearward tilt angle) of the seat back 1 in the conveyance seat S can be detected by the angle sensor 6a.

### <Slide Device 7>

The conveyance seat S is provided with a slide device 7 that moves the seat body Sh in a sliding manner in the front to rear direction of the vehicle V. The slide device 7 is provided with a position sensor 7a serving as the state detection unit 60 that detects the state of the seat body Sh, and the position of the seat body Sh in the vehicle front to rear direction can be detected by measuring the position of the seat body Sh using the position sensor 7a.

### <Seat Rotating Device 8>

In addition, the conveyance seat S is provided with a seat rotating device 8 that rotates the seat body Sh to the right or left about a rotation axis in the up to down direction. The seat rotating device 8 is provided with a rotation angle sensor 8a serving as the state detection unit 60 that detects the state of the seat body Sh, and the rotation angle sensor 8a can detect the orientation of the conveyance seat S by measuring a rotation angle of the seat body Sh.

### <Hardware Configuration of Acoustic System 100>

The vehicle V is provided with the electronic control unit (ECU) 70 that is a control unit, and the acoustic system 100 is controlled by the ECU 70. As shown in FIG. 1, the ECU 70 is provided, for example, inside the instrument panel IP. The ECU 70 may be provided on a floor or inside the conveyance seat S.

Incidentally, a control circuit for acoustic control is incorporated into the ECU 70. Furthermore, the ECU 70 can cause the speaker 40 or each drive device (the reclining device 6 or the like), which is included in the conveyance seat S, to operate through the control circuit for acoustic control.

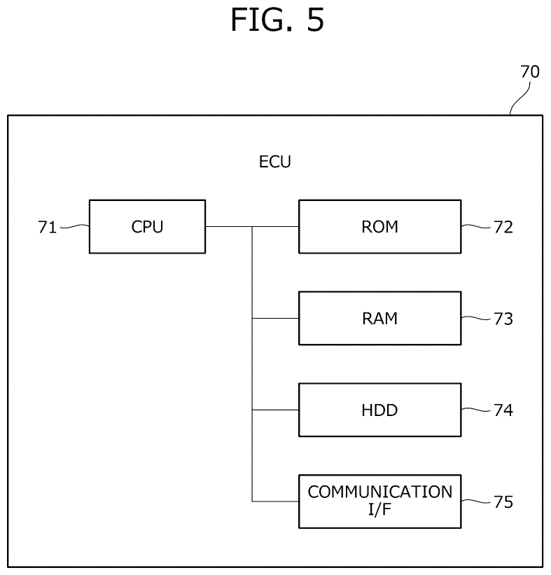

As shown in FIG. 5, the ECU 70 is mainly composed of a central processing unit (CPU) 71 that is a central arithmetic device; a read only memory (ROM) 72, a random access memory (RAM) 73, a hard disk drive (HDD) 74 serving as storage devices; and the like. The ECU 70 includes a communication interface 75 for receiving information or signals from other devices or transmitting signals for operation. In addition, the configurations are connected to each other via a bus to be able to communicate with each other.

The ECU 70 is connected to the angle sensor 6a of the reclining device 6, the position sensor 7a of the slide device 7, the rotation angle sensor 8a of the seat rotating device 8, the seating detection units 61, the brain wave detection units 62, the wakefulness detection units 63, the interior vehicle camera 64, and the infrared camera 65 via the communication interface 75. In addition, the ECU 70 is connected to the seat back movable portions 15, the seat cushion movable portions 25, the headrest movable portions 33, and the ottoman movable portions 36. In more detail, the ECU 70 is connected to the actuators 15a of the seat back movable portions 15, the actuators 25a of the seat cushion movable portions 25, the actuators 33a of the headrest movable portions 33, and the actuators 36a of the ottoman movable portions 36 via cables or harnesses. In addition, the ECU 70 is individually connected to the speakers 40 provided in the seat back 1 and the like, and can cause each of the speakers 40 to emit a music, warning sound, or the like at a predetermined volume in response to an instruction from the ECU 70.

### <Functional Configuration of Acoustic System 100>

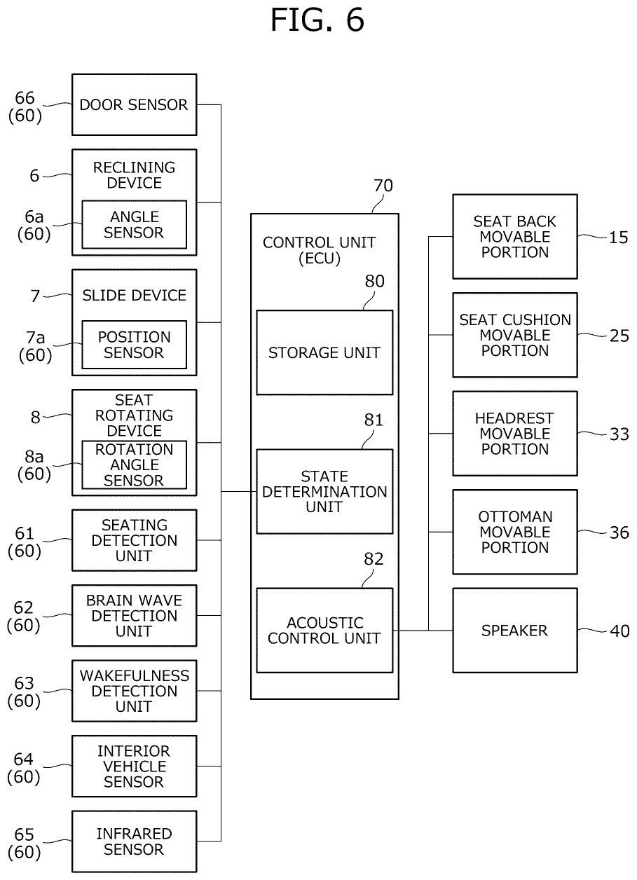

A functional configuration of the acoustic system 100 will be described with reference to FIG. 6. The vehicle V including the speakers 40 and the like in the conveyance seat S realizes various functions by using the state detection units 60, the speakers 40, or the like described above. The acoustic system 100 includes a storage unit 80, a state determination unit 81, and the acoustic control unit 82.

The storage unit 80 stores setting files for controlling various devices as table data. For example, the storage unit 80 stores, as a setting file, a method for controlling the speakers 40 based on information received from the state detection units 60. The acoustic control unit 82 to be described later reads the setting files stored in the storage unit 80, and causes the speakers 40 and various movable portions, which are provided in the conveyance seat S, to operate based on the state of the conveyance seat S or the occupant H determined by the state determination unit 81.

The state determination unit 81 determines the state of the interior member M installed in the vehicle V, and the state of the occupant H seated in the conveyance seat S, based on information received from the state detection units 60.

For example, when the interior member M is the vehicle door DR, the state determination unit 81 determines the open/closed state of the vehicle door DR based on a signal received from the door sensor 66 provided in the vehicle door DR.

In addition, when the interior member M is the conveyance seat S, the state determination unit 81 receives information on the rearward tilt angle of the seat back 1 detected by the angle sensor 6a provided in the reclining device 6, and determines whether the conveyance seat S is in a normal seating posture or in a relaxation mode state where the seat back 1 is tilted rearward.

The position or orientation of the conveyance seat S in the vehicle cabin may be determined based on information on the position or rotation angle detected by the position sensor 7a of the slide device 7 or the rotation angle sensor 8a of the seat rotating device 8.

In addition, the state determination unit 81 determines the state of the occupant H seated in the conveyance seat S using the seating detection units 61, the brain wave detection units 62, and the wakefulness detection units 63 provided in the conveyance seat S.

### <Operation Based on Seating Position or Seating Posture of Occupant H>

The state determination unit 81 determines whether the occupant H is seated in the conveyance seat S, for example, based on signals received from the seating detection units 61 that are the state detection units 60. In addition, when it is determined that the occupant H is seated, the seating position or seating posture of the occupant H is determined based on signals received from the plurality of seating detection units 61 provided in the conveyance seat S. For example, in each conveyance seat S, it is determined whether the seating posture of the occupant H is biased, based on the position of the seating detection unit 61 that measures a largest pressure. For example, when the measurement value of the seating detection unit 61 disposed on the right side is large, the state determination unit 81 determines that the occupant H is seated biased to the right side.

The seating position or seating posture of the occupant H may be determined based on a video of the occupant H captured by the interior vehicle camera 64.

The state determination unit 81 may determine the mood of the occupant H based on brain wave signals received from the brain wave detection units 62 that are the state detection units 60. For example, it is determined whether the occupant H is in a happy mood or a sad mood.

In addition, the state determination unit 81 determines the physical condition or wakefulness of the occupant H based on information regarding to wakefulness received from the wakefulness detection units 63 that are the state detection units 60. For example, it is determined whether the occupant suffers from conveyance sickness based on the heart rate, pulse wave, and respiration of the occupant. In addition, it is determined whether the wakefulness of the occupant H is high or low.

Incidentally, the wakefulness is defined, for example, as a value that is set to zero when the occupant is in a deep sleep state and that increases as the occupant becomes more wakeful. Regarding wakefulness, for example, when a heart rate sensor is used as the wakefulness detection unit 63, the wakefulness state of the occupant H is determined by comparing a heart rate of the occupant H when the occupant H get in the conveyance and a heart rate when a measurement is performed. In addition, when a respiration sensor is used as the wakefulness detection unit 63, a wakefulness state is determined by comparing a respiratory rate when the occupant H gets in the conveyance and a respiratory rate when a measurement is performed. Regarding wakefulness, a wakefulness state may be determined based on brain waves measured by the brain wave sensors or a posture determined by the seating detection units.

In addition, when the state of the occupant H is determined, the posture, physical condition, and wakefulness of the occupant H may be determined based on a video captured by the interior vehicle camera 64 or the infrared camera 65 provided inside the vehicle as the state detection unit 60.

When sound is generated from the speaker 40, the acoustic control unit 82 controls at least one of the volume, tempo, and direction of the sound emitted from the speaker 40, based on the state of the occupant H, the interior member (the conveyance seat S or the vehicle door DR), or the like determined by the state determination unit 81. Incidentally, the “tempo of sound” refers to, for example, the performance speed or beat speed of the music played from the speaker 40.

When the state determination unit 81 determines that the seating position or seating posture of the occupant H is biased to one side (for example, the right side) in the right to left direction, the acoustic control unit 82 increases the volume of the sound emitted from the other side (for example, the left side) of the speakers 40 provided on both right and left sides of the conveyance seat S. By performing control in such a manner, a sound suitable for the seating position or seating posture of the occupant H can be generated, so that discomfort felt by the occupant H can be suppressed.

The acoustic control unit 82 may control the sound emitted from the speaker 40, based on the position of the head of the occupant H, particularly, the positions of the ears. For example, the acoustic control unit 82 changes the direction of sound to face the head by causing the orientation of the speaker 40 to be changed.

When the orientation of the back speaker 41 provided in the seat back 1 is changed, the acoustic control unit 82 causes the seat back movable portion 15 to operate.

When the orientation of the cushion speaker 42 provided in the seat cushion 2 is changed, the seat cushion movable portion 25 is operated. When the orientation of the headrest speaker 43 provided in the headrest 3 is changed, the headrest movable portion 33 is operated.

When the orientation of the ottoman speaker 44 provided on the ottoman 4 is changed, the ottoman movable portion 36 is operated.

When the orientation of the speaker 40 is changed, the speaker 40 itself may be moved to tilt as in the case of the headrest speaker 43. In addition, as in the case of the speakers 40 provided in the seat back 1, the seat cushion 2, and the ottoman 4, the tilting of a bank portion or the side portions may be changed.

When the wakefulness detection unit 63 determines that the physical condition of the occupant H is poor, the acoustic control unit 82 reduces the volume of the sound emitted from the speaker 40. In addition, when a warning sound or music is being emitted from the speaker 40, the volume of the sound is reduced even in the middle of playback.

In addition, when the vehicle V is provided with a plurality of the conveyance seats S, the volume of the sound emitted from the speakers 40 of the conveyance seat S in which the occupant H who is determined to be in poor physical condition is seated may be reduced.

In addition, when the occupant H is determined to be in a happy mood based on brain waves measured by the brain wave detection unit 62, the volume of the sound being emitted from the speaker 40 may be increased or the music may be changed to music with a faster tempo to further enhance the mood.

In a case where the occupant H is not the driver, when it is determined that the wakefulness of the occupant H is low, the acoustic control unit 82 may lower the wakefulness of the occupant H by reducing the volume of the sound emitted from the speaker 40.

When the vehicle V is provided with the plurality of the conveyance seats S, the volume of the sound emitted from the speaker 40 of the conveyance seat S in which the occupant H with low wakefulness is seated may be lowered, or the music may be changed to music with a slow tempo.

In a case where the occupant H is the driver, when it is determined that the wakefulness is low, it is preferable that the acoustic control unit 82 increases the volume of the sound emitted from the speaker 40 or changes the music to music with a fast tempo. The wakefulness is increased by increasing a stimulus imparted to the driver.

As a stimulus generating device, a vibration generating device or a light generating device may be provided in addition to the speaker 40. The vibration generating device may be provided integrally with the speaker 40. In addition, the light generating device may also be integrated with the speaker 40. By integrating the vibration generating device or the light generating device with the speaker 40, the vibration generating device or the light generating device can be compactly stored in the conveyance seat S.

In a case where the conveyance seat S is provided with a vibration device, or in a case where there is a light generation device such as lighting in the surroundings, when it is determined that the wakefulness is low, the vibration device or the light generation device may impart vibration or light to notify or warn the driver that the wakefulness is low.

<Wakefulness Countermeasure when Occupant H is the Driver>

In determining a wakefulness, a predetermined threshold value may be set, and a volume that is operated by the acoustic control unit 82 may be determined thereon.

For example, when the wakefulness of the driver is in a first wakefulness state lower than a first threshold value, the stimulus (volume, vibration, or the like) imparted to the driver is increased more than normal (set to a first stimulus generation state). Namely, the acoustic control unit 82 increases the volume of the sound emitted from the speaker 40 more than normal, or increases the vibration imparted by the vibration generating device more than normal.

In addition, when the wakefulness of the driver is in a second wakefulness state lower than a second threshold value that is lower than the first threshold value, it is preferable that the stimulus (volume, vibration, or the like) imparted to the driver is increased more than when the wakefulness of the driver is in the first wakefulness state. Namely, the speaker 40 or the vibration device is set to a second stimulus generation state.

In addition, the notification level or warning level may be set to be larger than that in the first wakefulness state by generating vibration from the vibration generating device or emitting light from the light generating device.

In addition, when a state where the wakefulness of the driver is lower than normal continues for a predetermined time or more, for example, 20 seconds or more, the stimulus (volume, vibration, or the like) imparted to the driver is increased more than normal. Namely, the speaker 40 or the vibration device is set to the first stimulus generation state or the second stimulus generation state.

Incidentally, even after sound, vibration, or the like is imparted to the driver, namely, even after the first stimulus generation state or the second stimulus generation state is enabled, when the state where the wakefulness of the driver is lower than normal (the first wakefulness state or the second wakefulness state) continues for a predetermined time or more (for example, 15 seconds or more), it is preferable that the stimulus (sound, vibration, or the like) imparted to the driver is increased more than normal.

Incidentally, instead of the first stimulus generation state or the second stimulus generation state or in addition to the first stimulus generation state or the second stimulus generation state, the ECU 70 may restrict the traveling state of the vehicle V. For example, the vehicle V may be guided to a nearby parking lot or a rest area. The guidance may be performed by sound. When the vehicle V is a conveyance capable of autonomous driving, the vehicle V may be switched to an autonomous driving mode, and may be moved to a parking lot or a rest area. The ECU 70 may lower the traveling speed of the vehicle V, or prohibit the vehicle V from traveling.

<Wakefulness Countermeasure for Seat Other than Driver's Seat>

When the occupant H is seated in a seat other than a driver's seat (a passenger seat or a rear seat), the sound emitted from the speaker 40 provided in the seat other than the driver's seat is controlled by the acoustic control unit 82 based on the wakefulness of the occupant H. Namely, the acoustic control unit 82 causes the speaker 40 to operate such that discomfort to the occupant H seated in the seat other than the driver's seat is suppressed.

For example, when the acoustic control unit 82 detects that the wakefulness of the occupant H in a seat other than the driver's seat is lower than the first threshold value, namely, that the occupant is slightly drowsy, the acoustic control unit 82 reduces the volume of the sound emitted from at least one of the speakers 40 provided in the seat other than the driver's seat such that the wakefulness is lowered. In addition, when music is played from the speakers 40, the acoustic control unit 82 changes the music to music with a slower tempo.

When the conveyance seat S in which the occupant H is seated is the passenger seat, the volume of the sound emitted from at least one of the speakers 40 provided in the passenger seat, preferably the volume of the sound emitted from all the speakers 40 provided in the passenger seat is reduced, or the music is changed to music with a slower tempo. In this case, the volume of the sound emitted from at least one of the speakers 40 provided in a rear seat other than the passenger seat, preferably the volume of the sound emitted from all the speakers 40 may be reduced. In addition, the music played from the speakers 40 of the rear seat may be changed to music with a slower tempo.

When it is detected that the wakefulness of the occupant H seated in a rear seat (middle seat S2 or the rear seat S3) is lower than the first threshold value, namely, when it is detected that the occupant H seated in the rear seat is slightly drowsy, the volume of at least one of the speakers 40 provided in the rear seat is reduced, or preferably, the volumes of all the speakers 40 of the rear seat are reduced. In this case, the music that is played may be changed to music with a slower tempo. In this case, it is preferable that the acoustic control unit 82 reduces the volume of the sound emitted from at least one of the speakers 40 provided in a seat other than the rear seats, preferably in the passenger seat, preferably the volume of the sound emitted from all the speakers 40 of the passenger seat. In addition, in this case, the acoustic control unit 82 may change the music played from the speakers 40 to music with a slower tempo.

### <When Middle Seat S2 is Rotated>

As shown in FIG. 1, when the middle seat S2 faces forward, the sound emitted from the headrest speaker 43 and the back speaker 41 is directed in the direction of arrow A1 in FIG. 1, and a range R1 where the sound spreads is around the occupant H seated in the middle seat S2.

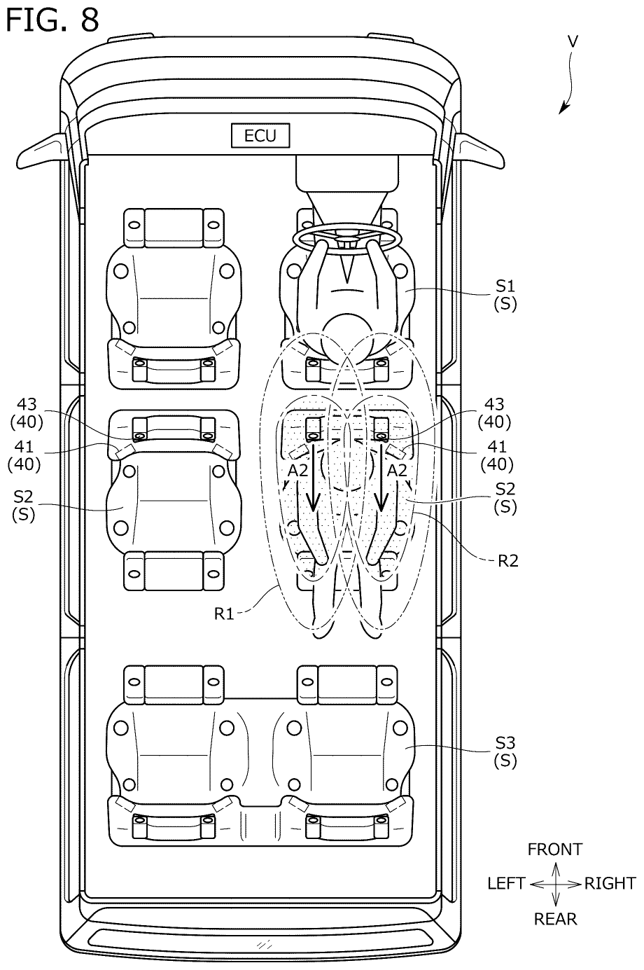

On the other hand, as shown in FIG. 8, when the middle seat S2 in which the occupant H is seated is rotated to face rearward (in the direction of arrow A2 in FIG. 8), the positions of the back speaker 41 and the headrest speaker 43 of the middle seat S2 become closer to the driver seated in the front. For that reason, the sound emitted from the back speaker 41 or the headrest speaker 43 provided in the middle seat S2 behind the driver's seat imparts discomfort to the driver.

For that reason, when the position of the speaker 40 provided in the middle seat S2 is closer to the driver's seat than normal (when the seat is not rotated), for example, when the middle seat S2 is rotated 90 degrees or 180 degrees, it is preferable that the sound emitted from the speaker 40 (the back speaker 41 or the headrest speaker 43) of the middle seat S2 is controlled by the acoustic control unit 82 not to cause discomfort to the driver.

Specifically, when the rotation angle of the middle seat S2 is acquired from the rotation angle sensor 8a that is the state detection unit 60, the state determination unit 81 determines the orientation of the middle seat S2. When the rotation angle is 180 degrees, and the seating detection units 61 of the front seat S1 on a driver's seat side determine that the driver is seated in the driver's seat, in order to suppress imparting discomfort to the driver, the acoustic control unit 82 controls the speaker 40 of the middle seat S2 to lower the volume. As shown in FIG. 8, the range R1 where the sound spreads becomes narrower similarly to a range R2, and it is difficult for the sound to reach the driver, and therefore, discomfort to the driver can be suppressed.

In addition, the acoustic control unit 82 may change the orientation (the direction of arrow A2) of the headrest speaker 43 provided in the middle seat S2 such that the headrest speaker 43 faces further toward the seat inner side. In addition, in order to suppress discomfort of the driver, the volume of the headrest speaker 43 in the driver's seat may be increased.

When the state determination unit 81 determines that the occupant H is at work or in study, the acoustic control unit 82 may temporarily increase the volume of a warning sound or music. When it is determined that the wakefulness of the occupant H increases to a certain value or more and that the occupant H is no longer drowsy, the volume of the sound emitted from the speaker 40 is reduced, or the generation of sound is stopped.

The determination of whether the occupant H is at work or in study may be performed, for example, by checking whether a switch provided in the vehicle V to indicate that the occupant H is at work or in study is operated. In addition, the determination may be made based on whether a table (not illustrated) provided in the vehicle V is in use or whether a reading light (not illustrated) is in use.

When the state determination unit 81 determines that the conveyance seat S is in a relaxation mode state, the acoustic control unit 82 may restrict the volume of the sound emitted from at least one of the speakers 40 provided in the conveyance seat S, or may prohibit the generation of sound.

The relaxation mode state refers to a state where the seat back 1 of the conveyance seat S is tilted further rearward by the reclining device 6 than in a normal driving posture.

For example, when the angle sensor 6a of the reclining device 6 detects that the rearward tilt angle is 45 degrees or more, the state determination unit 81 determines that the conveyance seat S is in the relaxation mode state.

When the conveyance seat S is in the relaxation mode state, the acoustic control unit 82 lowers the volume of the speakers 40 provided in the conveyance seat S in the relaxation mode state, or stops the generation of sound. When the conveyance seat S in the relaxation mode state is the driver's seat, this process may not be performed.

When the vehicle V is capable of autonomous driving, the state determination unit 81 determines whether the vehicle V is in a manual driving state or an autonomous driving state, and the acoustic control unit 82 may control the speaker 40 provided in the conveyance seat S based on the determination result.

It is preferable that when the vehicle V is in the autonomous driving state, the acoustic control unit 82 increases the volume of the speaker 40 or increases vibration emitted from the vibration generating device more than when the vehicle V is in the manual driving state. When a light generating device is provided, it is preferable that the intensity of light is increased.

In addition, it is preferable that the volume of a guidance sound or a notification by vibration or light when the vehicle V returns from the autonomous driving state to the manual driving state is increased or intensified more than that of a guidance sound or a notification when the autonomous driving state continues. In addition, instead of executing this process in all the seats, the guidance sound or notification may be increased only in the driver's seat.

When hearing characteristics (for example, high-frequency recognition ability, age, or the like) of the seated occupant H are registered in the storage unit 80 in advance, the acoustic control unit 82 may change the sound emitted from the speaker 40 to a sound that is easier for the occupant H to hear, based on the hearing characteristics of the seated occupant H.

In addition, when the state determination unit 81 detects, through a microphone 67 provided inside the vehicle, that the occupants H are in conversation inside the vehicle, or that the occupant H is on the phone inside the vehicle, the acoustic control unit 82 may control the sound emitted from the speaker 40. For example, the sound emitted from the speaker 40 is restricted to a predetermined volume or less, or the generation of sound is prohibited.

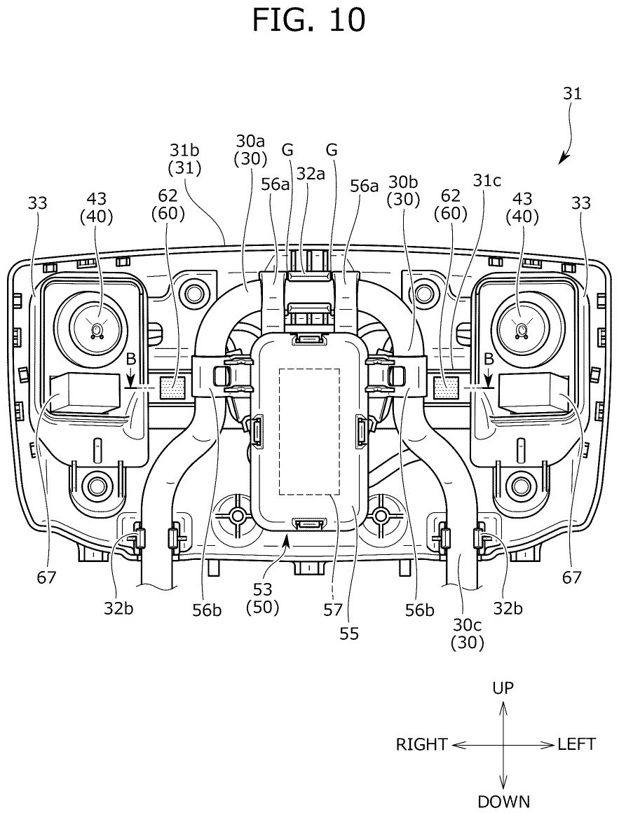

For example, when the microphone 67 detects a conversation between the occupants H inside the vehicle, and the state determination unit 81 determines that the occupants H are in conversation, the acoustic control unit 82 reduces the volume of the speakers 40 of the conveyance seats S in which the occupants H in conversation are seated. In addition, when the state determination unit 81 determines that the occupant H is on the phone, the acoustic control unit 82 prohibits the speaker 40 from generating sound. Incidentally, as shown in FIG. 10, the microphone 67 is provided inside the headrest 3.

### <Operation of Acoustic System 100>

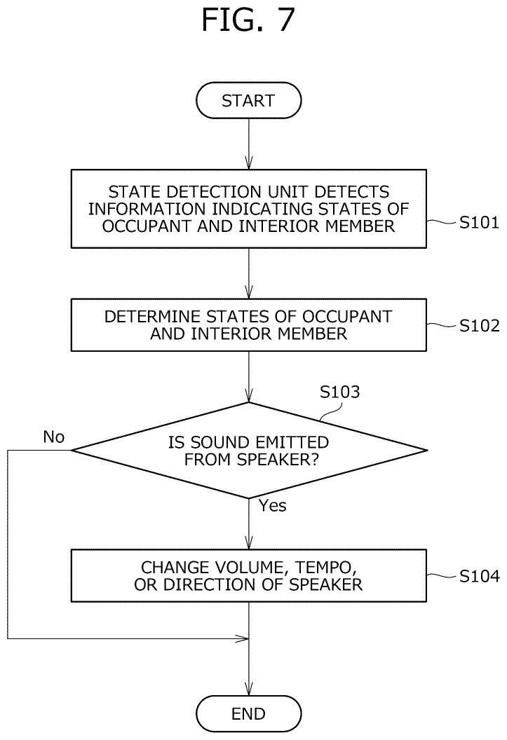

The operation of the acoustic system 100 will be described with reference to a flowchart shown in FIG. 7. Incidentally, the process of the speaker 40 of the vehicle V is executed by the CPU 71 of the ECU 70 reading a program from the ROM 72 or the HDD 74 and loading the program into the RAM 73.

In the acoustic system 100, in step S101, the state detection units 60 of the ECU 70 detect information indicating the state of the occupant H and information indicating the state of the interior member M of the vehicle V (information detection step). For example, the seating detection units 61 that are the state detection units 60 measure a pressure received from the occupant H. In addition, the state of the conveyance seat S is measured from the angle sensor 6a of the reclining device 6 or the rotation angle sensor 8a of the seat rotating device 8. The measured information is stored in the storage unit 80.

In step S102, the state determination unit 81 of the ECU 70 determines the state of the occupant H and the state of the interior member M based on the information received from the state detection units 60. For example, when the seating detection unit 61 disposed on the right side of the conveyance seat S receives more pressure than the seating detection unit 61 disposed on the left side, the state determination unit 81 determines that the posture of the occupant H is biased to the right side. In addition, when the rotation angle sensor 8a of the seat rotating device 8 detects that the rotation angle of the conveyance seat S is 180 degrees, the state determination unit 81 determines that the conveyance seat S faces rearward.

Next, in step S103, the ECU 70 determines whether sound is to be emitted from the speakers 40 (sound generation step).

When sound is to be emitted or is being emitted from the speakers 40 (Yes in step S103), the process proceeds to step S104. When no sound is emitted from the speakers 40 (No in step S103), the process ends, and subsequently, the state of the occupant H and the state of the interior member M are measured by the state detection units 60.

When sound is to be emitted or is being emitted from the speakers 40, in step S104, the acoustic control unit 82 of the ECU 70 controls at least one of the volume, tempo, and direction of the sound that is to be emitted or is being emitted from the speakers 40, based on the state of the occupant H or the state of the interior member M (acoustic control step).

For example, when the posture of the occupant H is biased to the right side, the acoustic control unit 82 increases the volume of the speaker 40 located on the left side more than the volume of the speaker 40 located on the right side. Accordingly, for example, discomfort of the sound felt by the occupant H can be suppressed.

In addition, when the middle seat S2 located behind the front seat S1 on the driver's seat side is rotated 180 degrees as shown in FIG. 8, the headrest speaker 43 and the back speaker 41 of the front seat S1 and the headrest speaker 43 and the back speaker 41 of the middle seat S2 approach each other. For that reason, the acoustic control unit 82 can suppress discomfort of the sound felt by the driver and the occupant H seated in the middle seat S2 by reducing the volume of the sound emitted by the headrest speaker 43 of the middle seat S2 and the back speaker 41 of the seat back 1.

### <Damper 50>

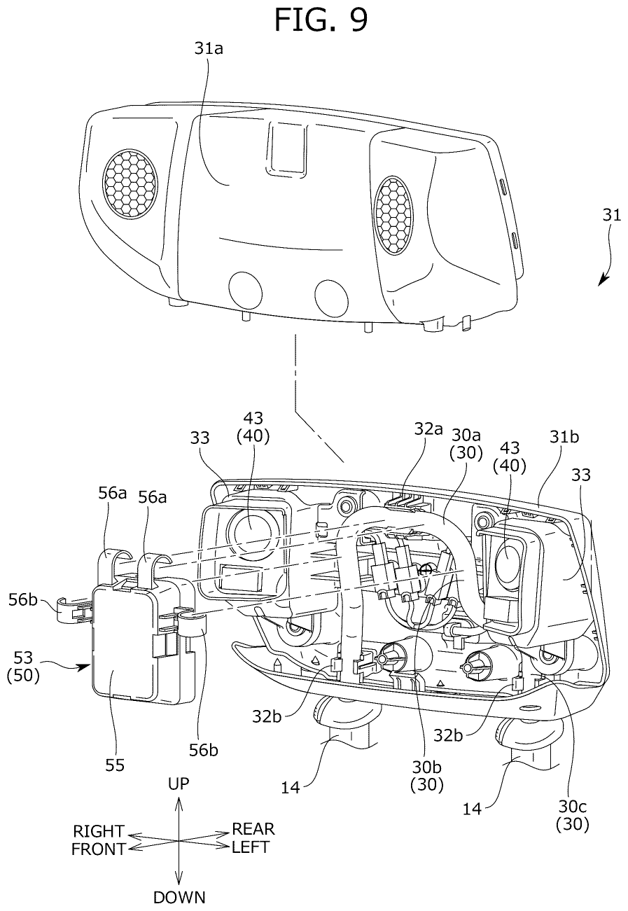

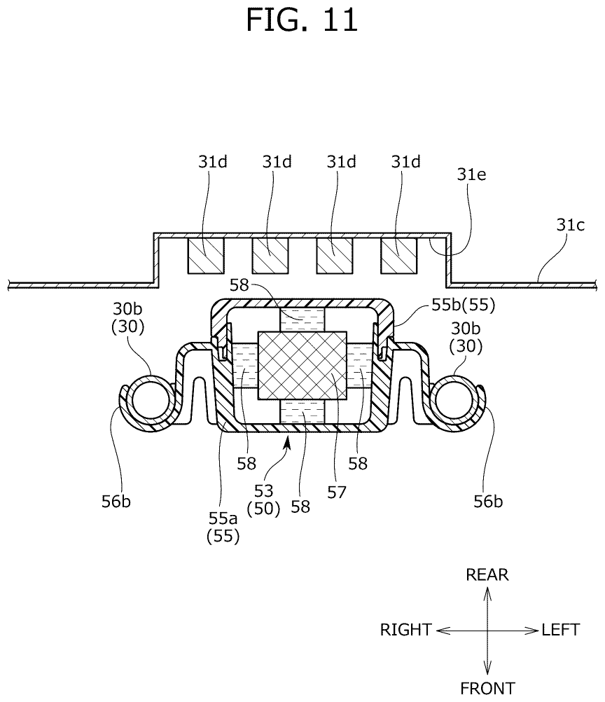

Next, a configuration of the headrest 3 including a damper 50 (the headrest damper 53) that is a vibration reduction member will be described. FIGS. 9 to 11 are views showing an internal structure of the headrest 3 including the damper 50, FIG. 9 is an exploded perspective view of the headrest frame 31, and FIG. 10 is a view showing a state where a front cover 31a of the headrest frame 31 is removed. FIG. 11 is a cross-sectional view taken along line B-B of FIG. 10, and is a descriptive view for describing a positional relationship between the damper 50 and a connecting member 31c that supports connectors 31d.

The headrest frame 31 is composed of the headrest pillar 30 that supports the headrest 3, and the front cover 31a and a rear cover 31b that cover the headrest pillar 30. In addition, the headrest damper 53 that is the damper 50 is attached to the headrest pillar 30. The headrest speakers 43 and the microphones 67 are provided on the right and left of the headrest pillar 30. The headrest speakers 43 are attached to be rotatable by the headrest movable portions 33. The headrest movable portions 33 are connected to each other by the connecting member 31c. Incidentally, although not shown, the headrest frame 31 is covered with the skin T.

In addition, harnesses and the connectors 31d are attached to the connecting member 31c that connects attachment members (the headrest movable portions 33) of the headrest speakers 43 and the microphones 67 disposed on the right and left. As shown in FIG. 11, it is preferable that the harnesses and the connectors 31d are disposed between the connecting member 31c and the headrest damper 53. By disposing the harnesses and the connectors 31d between the connecting member 31c and the headrest damper 53, the harnesses and the connectors 31d can be protected against loads from the front and rear.

In addition, as shown in FIG. 11, it is preferable that a recess 31e recessed rearward is provided at a position facing the headrest damper 53 and that the harnesses and the connectors 31d are attached to the recess 31e. By providing the recess 31e, it is made easier to ensure a space where the harnesses and the connectors 31d are disposed.

In addition, the brain wave detection units 62 are attached to the connecting member 31c. Not only the brain wave detection units 62 but also other biometric detection sensors, pulse wave sensors, and wakefulness sensors may be provided on the connecting member 31c. Harnesses for various sensors are disposed along the harness for the speakers 40 or the microphones 67. For example, it is preferable that, similarly to the harness for the headrest speakers 43 or the microphones 67, the harnesses for the various sensors are disposed through the inside the headrest pillar 30.

It is preferable that the brain wave detection units 62 are disposed close to the front cover 31a, which is located in front of the headrest pillar 30 and the headrest damper 53, at positions where the brain wave detection units 62 avoid the headrest pillar 30 and the headrest damper 53 when viewed from the front (occupant side). By disposing the brain wave detection units 62 in such a manner, the influence of the headrest speakers 43 is suppressed, and the detection accuracy can be improved.

In addition, by disposing the headrest damper 53 in front of the harnesses and the connectors 31d, the harnesses and the connectors 31d can be protected against a load from the front.

As shown in FIG. 10, the headrest pillar 30 is formed by being bent into an inverted U-shape when viewed from the front. In more detail, the headrest pillar 30 is composed of an upper portion 30a extending in the right to left direction; upper pillar portions 30b extending downward from both right and left end portions of the upper portion 30a; and lower pillar portions 30c that are bent rearward from lower ends of the upper pillar portions 30b and then extend downward.

A cover fixing portion 32 extending forward holds the headrest pillar 30, so that the rear cover 31b of the headrest frame 31 is fixed to the headrest pillar 30. In more detail, the cover fixing portion 32 is composed of an upper fixing portion 32a provided on the upper side of the rear cover 31b, and two lower fixing portions 32b provided on the lower side. The upper fixing portion 32a holds the upper portion 30a of the headrest pillar 30, and the lower fixing portions 32b hold the lower pillar portions 30c of the headrest pillar 30.

In addition, the headrest damper 53 is attached to the headrest pillar 30. By providing the headrest damper 53 inside the headrest 3, the vibration transmitted to the headrest 3 is transmitted to the headrest damper 53, and the headrest damper 53 resonates, thereby making it possible to suppress the vibration of the headrest 3.

The headrest damper 53 includes a weight 57; elastic members 58 that cover the weight 57; a body casing 55 that stores the weight 57 and the elastic members 58; and a damper attachment portion 56 that attaches the body casing 55 to the headrest pillar 30. As shown in FIG. 11, the weight 57 is elastically supported inside the body casing 55 via the elastic members 58 so as to be able to vibrate.

The weight 57 is made of metal (for example, cast iron), and in the present embodiment, is formed in a quadrangular prism shape. The elastic members 58 that elastically support the weight 57 are composed of rectangular members formed in a sheet shape, and hold the weight 57 by sandwiching the weight 57 therebetween from the front, rear, right, left, top, and bottom. The elastic members 58 are made of a urethane foam material or a rubber material formed with a desired thickness.

### <Damper Attachment Portion 56>

The body casing 55 is divided into two portions in the front to rear direction, and is composed of a storage portion 55a disposed on the front side, and a lid portion 55b disposed on the rear side. The storage portion 55a and the lid portion 55b are each formed from a synthetic resin. In addition, the body casing 55 is provided with the damper attachment portion 56 that is connected to the headrest pillar 30.

In more detail, side attachment portions 56b are provided at both side portions of the storage portion 55a of the body casing 55, and two upper attachment portions 56a are provided at an upper end portion of the storage portion 55a. Holding portions having a curled shape and provided at tips of the damper attachment portion 56 hold the headrest pillar 30, so that the headrest damper 53 can be fixed to the headrest pillar 30.

In the headrest damper 53 shown in FIGS. 9 and 10, the two upper attachment portions 56a extend from an upper surface of the body casing 55 to the upper portion 30a of the headrest pillar 30, and hold the upper portion 30a. The upper attachment portions 56a are attached to avoid the upper fixing portion 32a for fixing the rear cover 31b of the headrest frame 31. In other words, the upper fixing portion 32a holds the center of the upper portion 30a, and the two upper attachment portions 56a of the headrest damper 53 hold the upper portion 30a to sandwich the upper fixing portion 32a of the rear cover 31b therebetween. Incidentally, it is preferable that there are gaps G between the upper attachment portions 56a and the upper fixing portion 32a. Since there are the gaps G between the upper attachment portions 56a and the upper fixing portion 32a, ease of attachment is improved.

In addition, the side attachment portions 56b are provided to extend from side surfaces of the body casing 55 to the upper pillar portions 30b of the headrest pillar 30, and to hold the upper pillar portions 30b.

Tips of the upper attachment portions 56a and the side attachment portions 56b are formed in a curled shape, and the headrest damper 53 can be attached by fitting the headrest pillar 30 into the curled tips.

Vibration of the headrest 3 is reduced by attaching the headrest damper 53 inside the headrest 3 including the headrest speakers 43 on the right and left. Therefore, the acoustic characteristics of the headrest speakers 43 can be improved, and discomfort of sound felt by the occupant H can be suppressed.

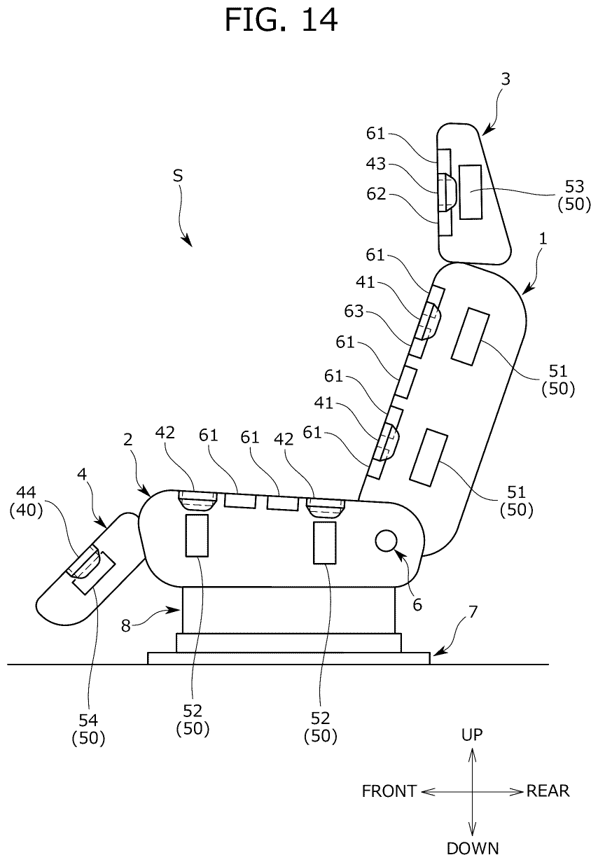

In addition, it is preferable that the headrest damper 53 is disposed at a position overlapping the headrest speakers 43 and the microphones 67 in a side view (refer to FIG. 14). An increase in the size of the headrest 3 in the front to rear direction can be suppressed by disposing the headrest damper 53 in such a manner.

Incidentally, in the headrest damper 53 shown in FIGS. 9 and 10, the two upper attachment portions 56a hold the upper portion 30a with the upper fixing portion 32a of the rear cover 31b sandwiched therebetween; however, this configuration is one example, and other configurations may be adopted.

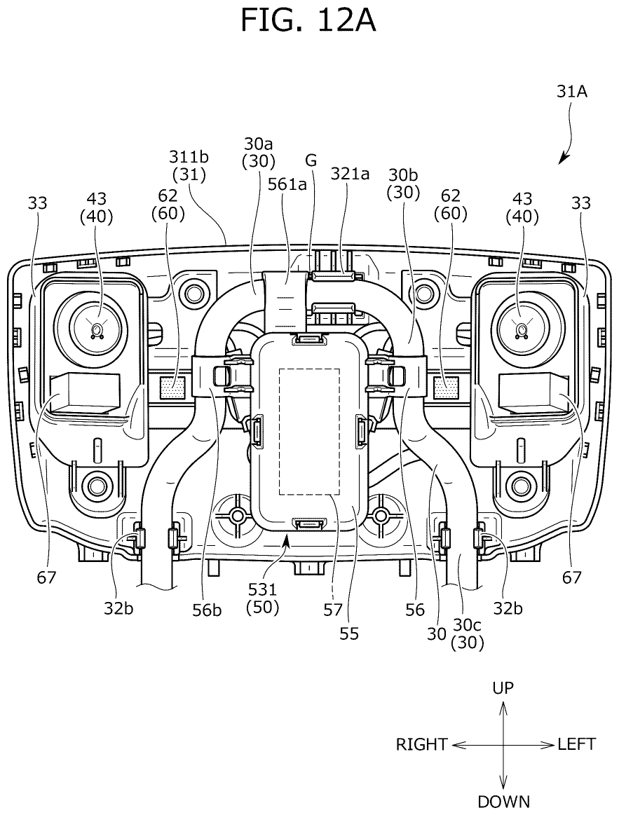

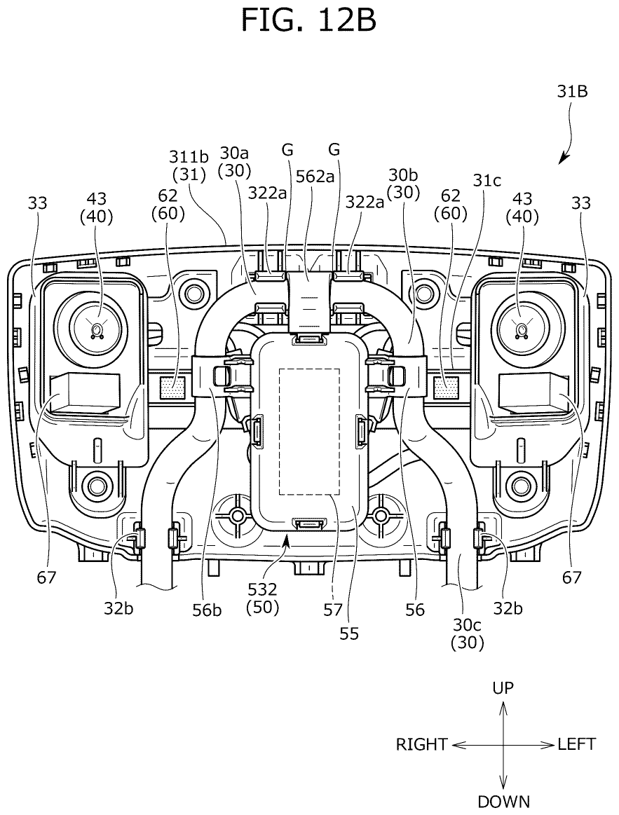

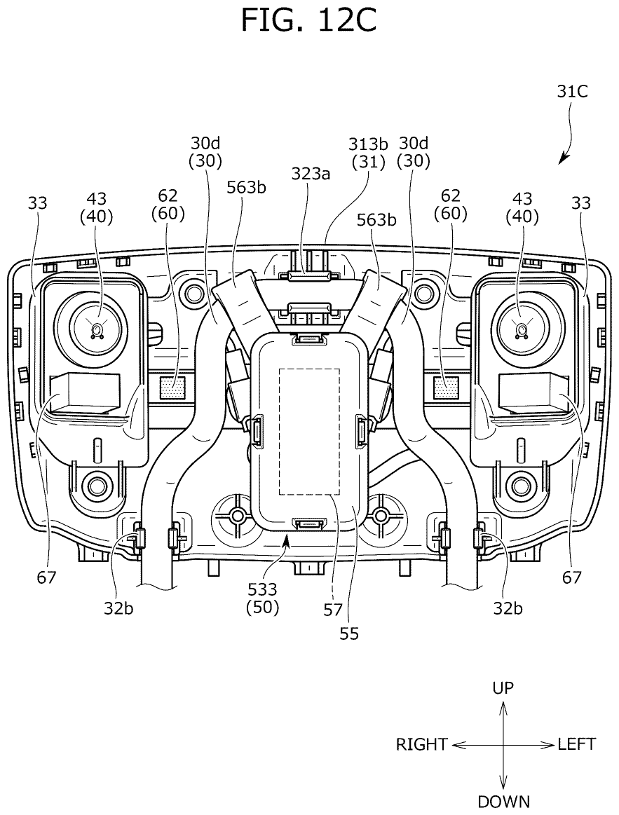

For example, as in the case of a headrest frame 31A shown in FIG. 12A, an upper fixing portion 321a for fixing the rear cover 31b and an upper attachment portion 561a for attaching a headrest damper 531 may be disposed in a staggered manner. In other words, the upper fixing portion 321a and the upper attachment portion 561a may be disposed offset from each other in the right to left direction, and may be attached not to interfere with each other. The attachment between the damper attachment portion 56 and the upper fixing portion 321a is stabilized by disposing the upper fixing portion 321a and the upper attachment portion 561a in such a manner. In addition, when there are the gap G between the upper attachment portion 561a and the upper fixing portion 321a, ease of attachment is improved.

In addition, as in the case of a headrest frame 31B shown in FIG. 12B, one upper attachment portion 562a extending from a headrest damper 532 may hold the center of the upper portion 30a, and two upper fixing portions 322a extending from a rear cover 312b may hold the upper portion 30a of the headrest pillar 30 so as to avoid the upper attachment portion 562a.

In addition, as in the case of a headrest frame 31C shown in FIG. 12C, two upper attachment portions 563a extending from a headrest damper 533 may be attached to hold bent portions 30d of the headrest pillar 30. Since the upper attachment portions 563a hold the bent portions 30d, the positions of the upper attachment portions 563a are restricted, so that the number of the damper attachment portions 56 can be reduced. For example, one or both of the side attachment portions 56b provided in the headrest damper 53 shown in FIG. 11 can be omitted, and the size of the damper attachment portion 56 can be reduced.

The weight 57 of the headrest damper 53 that is a vibration reduction member or the body casing 55 that stores the weight 57 may be attached to the connecting member 31c other than the headrest pillar 30. In addition, the weight 57 or the body casing 55 may be attached to both the headrest pillar 30 and the connecting member 31c.

In addition, the lid portion 55b of the body casing 55 may be formed integrally with the connecting member 31c. It is preferable that the body casing 55 of the headrest damper 53 and the connecting member 31c are made of resin, and the body casing 55 and the connecting member 31c can be made lighter by being made of resin than when the body casing 55 and the connecting member 31c are made of metal.

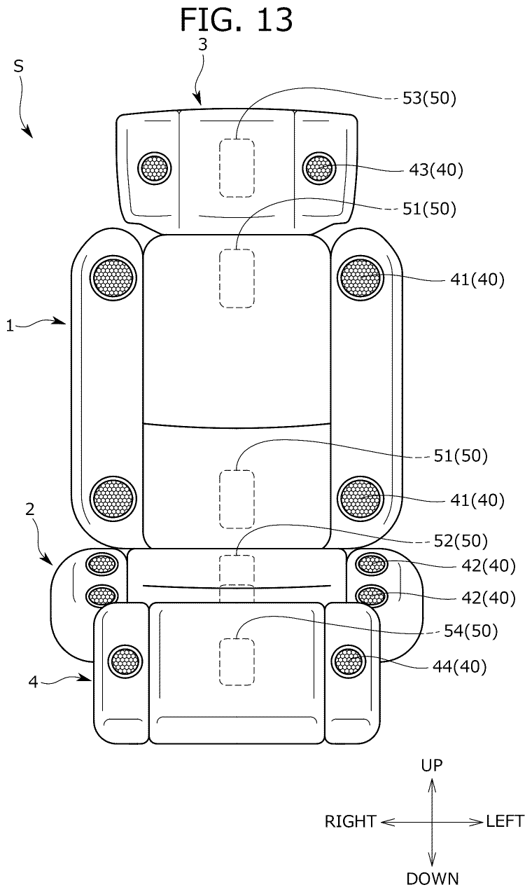

In the conveyance seat S of the present embodiment, the damper 50 that is a vibration suppression member is disposed inside the headrest 3; however, the location where the damper 50 is disposed is not limited to the inside of the headrest 3. Another example of the damper 50 disposed in the conveyance seat S will be described with reference to FIGS. 13 and 14.

As in the case of a back damper 51 shown in FIG. 13, the damper 50 may be disposed inside the seat back 1. Preferably, it is preferable that the damper 50 is disposed at an upper portion or a lower portion of the seat back 1 between a pair of the back speakers 41 that are disposed on the right and left to be separated from each other in the seat width direction.

The back damper 51 provided at the upper portion of the seat back 1 is attached to the upper frame 12 or the pad P.

The back damper 51 provided at the lower portion of the seat back 1 is attached to the lower frame 13 or the pad P of the seat back 1.

As shown in FIG. 14, it is preferable that the back damper 51 is disposed behind the back speakers 41. By disposing the back damper 51 in the vicinity of the pair of right and left back speakers 41, the effect of reducing vibration is improved, and discomfort to the occupant H is suppressed.

As in the case of a cushion damper 52 shown in FIG. 13, the damper 50 may be disposed inside the seat cushion 2. Preferably, it is preferable that the cushion damper 52 is disposed at a front portion or a rear portion of the seat cushion 2 between a pair of the cushion speakers 42 that are disposed on the right and left to be separated from each other in the seat width direction.

The cushion damper 52 provided at the front portion of the seat cushion 2 is attached to the pan frame 22, the front connecting frame 23, or the pad P. In addition, the cushion damper 52 provided at the rear portion of the seat cushion 2 is attached to the rear connecting frame 24 or the pad P.

In addition, it is preferable that as shown in FIG. 14, the cushion damper 52 is disposed below the cushion speakers 42. By disposing the cushion damper 52 in the vicinity of the pair of right and left cushion speakers 42 between the cushion speakers 42, the effect of reducing vibration is improved, and discomfort to the occupant H is suppressed.

As in the case of an ottoman damper 54 shown in FIG. 13, the damper 50 may be disposed inside the ottoman 4. Preferably, it is preferable that the ottoman damper 54 is disposed in the ottoman 4 between the ottoman speakers 44 that are disposed on the right and left to be separated from each other in the seat width direction. The ottoman damper 54 is attached to the ottoman frame 35 or the pad P of the ottoman 4.

It is preferable that the ottoman damper 54 attached to the ottoman 4 is disposed at a position overlapping the ottoman speakers 44 in a side view. By disposing the ottoman damper 54 in such a manner, an increase in size in the front to rear direction when the ottoman is stored can be suppressed.

Incidentally, the conveyance seat S may be provided with a vibration detection unit that detects vibration characteristics, and the damper 50 may be operated, based on the detection result of the vibration detection unit, only when a predetermined vibration, for example, a vibration that causes significant discomfort to the seated occupant wants to be reduced.

The embodiment of the present invention has been described above with reference to the drawings. The acoustic system 100 of the present embodiment is installed in a vehicle; however, the present invention is not limited to the acoustic system 100 installed in a ground-traveling conveyance with wheels, such as an automobile or a train, and can also be applied to the acoustic system 100 installed in, for example, an aircraft, a ship, or the like that moves in environments other than the ground.

### Second Embodiment

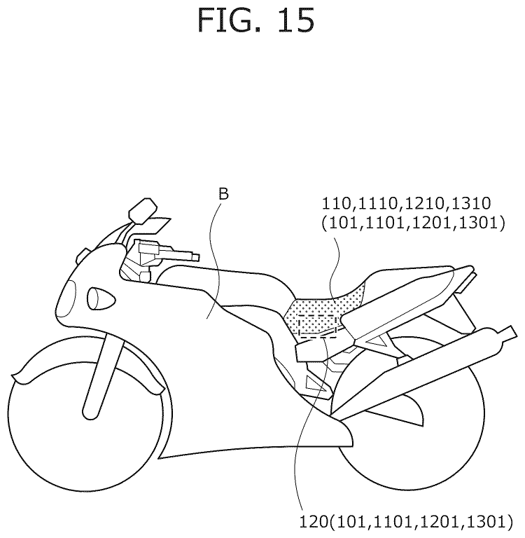

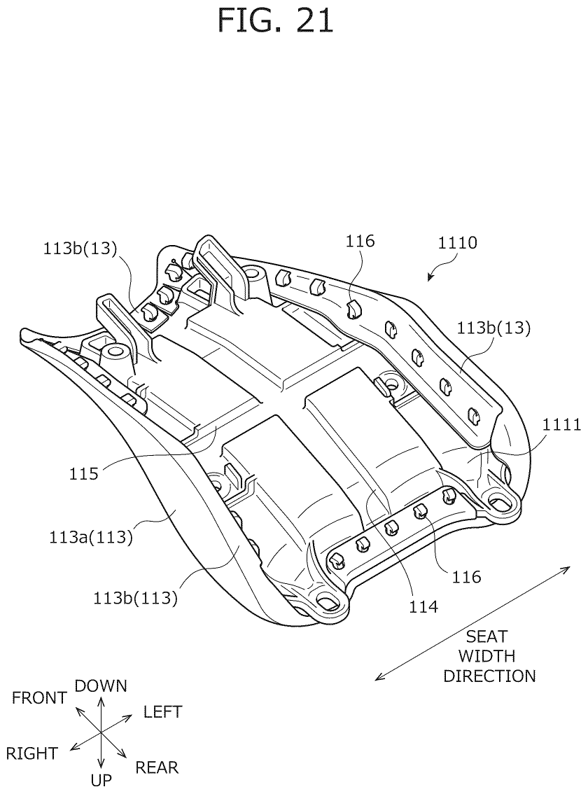

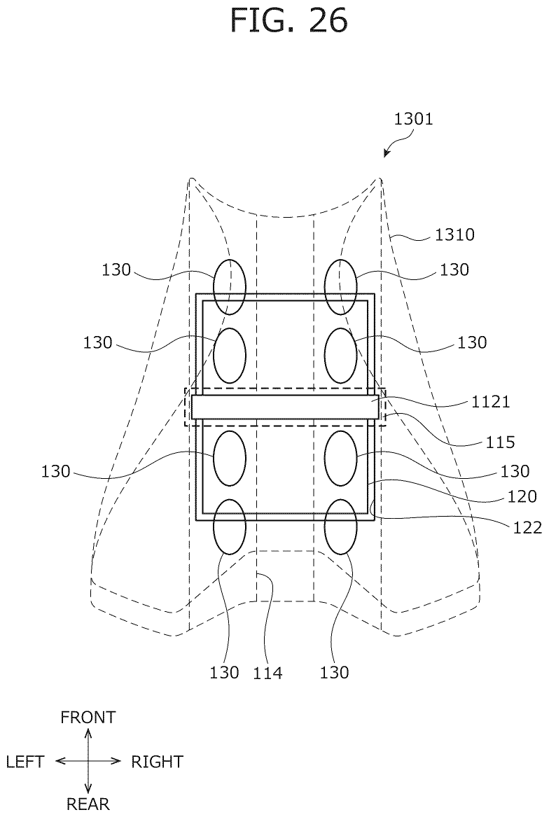

The second embodiment of the present invention is described below using FIGS. 15 through 27.

The second embodiment relates to a conveyance seat assembly, and in particular, to a conveyance seat assembly equipped with a seat and a battery.

### BACKGROUND ART

In order to accommodate more batteries, it is known that saddle-riding motorcycles are equipped with a battery mounted below the seat (see, for example, Patent Publication No. JP 2011-20603 A).

### SUMMARY OF THE INVENTION

### Problem to be Solved

However, when the battery is installed below the seat, the battery support member used when replacing the battery, for example, is placed between the battery and the seat, and the position of the seat may be raised by the battery support member. To lower the position of the seat without changing the shape of the seat, the height of the battery must be lowered, which reduces the battery capacity.

The purpose of the present invention is to provide a conveyance seat assembly in which the position of the seat is prevented from becoming higher even when a battery is installed below.

The above-described problems are solved by a conveyance seat assembly of the present invention, including: a seat in which an occupant is seated; a battery disposed below the seat; and a battery support member, which supports the battery, between the seat and the battery. A recess is formed on a lower surface of the seat, which faces the battery, and at least a part of the battery support member is inserted into the recess.

Since the recess is formed on the lower surface of the seat, at least a part of the battery support member that supports the battery is inserted into the recess thereof. For that reason, even when the battery is provided below the seat, an increase in position can be suppressed. In addition, since the height of the battery is not lowered, a reduction in battery capacity is suppressed.

In addition, in the conveyance seat assembly, it is preferable that the battery support member is provided to extend in a seat front to rear direction and a seat width direction, and it is preferable that the recess formed on the lower surface of the seat is formed along a direction in which the battery support member extends.

Since the recess is formed in the lower surface of the seat in alignment with the direction in which the battery support member extends, the battery support member can be efficiently accommodated in the recess, and a further increase in the position of the seat can be suppressed.

In addition, in the conveyance seat assembly, it is preferable that a seat movement mechanism that changes a position of the seat is provided on the lower surface of the seat, and it is preferable that the seat movement mechanism is disposed at a position where the seat movement mechanism avoids the recess formed in the seat.

Since the seat movement mechanism is disposed at a position where the seat movement mechanism avoids the recess, an increase in the size of the seat, particularly an increase in size in a height direction can be suppressed.

In addition, in the conveyance seat assembly, it is preferable that a plurality of seat movement mechanisms that change a position of the seat are provided on the lower surface of the seat, and it is preferable that the plurality of the seat movement mechanisms are disposed along the direction in which the recess extends.

In addition to improving rigidity due to the recess, since the plurality of seat movement mechanisms are disposed along the direction in which the recess extends, stable support is made possible by the seat movement mechanisms.

In addition, in the conveyance seat assembly, it is preferable that the plurality of seat movement mechanisms are disposed at bilaterally symmetrical positions on the lower surface of the seat.

Since the seat movement mechanisms are disposed at bilaterally symmetrical positions, the seat can be stably moved.

In addition, in the conveyance seat assembly, it is preferable that the seat movement mechanism is an air cell that is inflated and deflated by supplying and discharging air.

Since the seat movement mechanism is an air cell, the movement of the seat can be precisely controlled.

In addition, in the conveyance seat assembly, it is preferable that a plurality of the air cells are provided, and it is preferable that the plurality of air cells are disposed at bilaterally symmetrical positions on the lower surface of the seat.

Since the plurality of air cells are disposed at bilaterally symmetrical positions, the seat can be stably moved.

In addition, in the conveyance seat assembly, it is preferable that the recess is formed at a center of the lower surface of the seat in a seat width direction.

Since the recess is formed at the center in the seat width direction, the right-left balance of the rigidity of the seat can be improved.

In addition, in the conveyance seat assembly, it is preferable that a length of the recess in a longitudinal direction is longer than a length of the battery support member in the longitudinal direction.

Since the length of the recess in the longitudinal direction is set to be larger than the length of the battery support member in the longitudinal direction, it becomes easier to insert the battery support portion into the recess.

In addition, in the conveyance seat assembly, it is preferable that a length of the recess in a lateral direction is longer than a length of the battery support member in the lateral direction.

Since the length of the recess in the lateral direction is set to be larger than the length of the battery support member in the lateral direction, it becomes easier to insert the battery support portion into the recess.

### Advantageous Effects of Invention

According to the conveyance seat assembly of the present invention, since the recess is formed on the lower surface of the seat, at least a part of the battery support member that supports the battery is inserted into the recess thereof. For that reason, even when the battery is provided below the seat, an increase in position can be suppressed. In addition, since the height of the battery is not lowered, a reduction in battery capacity is suppressed.

In addition, since the recess is formed in the lower surface of the seat in alignment with the direction in which the battery support member extends, the battery support member can be efficiently accommodated in the recess, and a further increase in the position of the seat can be suppressed.

In addition, since the seat movement mechanism is disposed at a position where the seat movement mechanism avoids the recess, an increase in the size of the seat, particularly an increase in the height direction can be suppressed.

In addition, in addition to improving rigidity due to the recess, since the plurality of seat movement mechanisms are disposed along the direction in which the recess extends, stable support is made possible by the seat movement mechanisms.

In addition, since the seat movement mechanisms are disposed to be bilaterally symmetric, the seat can be stably moved.

In addition, since the seat movement mechanism is an air cell, the movement of the seat can be precisely controlled.

In addition, since the plurality of air cells are disposed at bilaterally symmetrical positions, the seat can be stably moved.

In addition, since the recess is formed at the center in the seat width direction, the right-left balance of the rigidity of the seat can be improved.

In addition, since the length of the recess in the longitudinal direction is set to be larger than the length of the battery support member in the longitudinal direction, it becomes easier to insert the battery support portion into the recess.

In addition, since the length of the recess in the lateral direction is set to be larger than the length of the battery support member in the lateral direction, it becomes easier to insert the battery support portion into the recess.

### FORMS FOR CARRYING OUT THE INVENTION

### First Embodiment

The configuration of the conveyance seat assembly of the second embodiment will be described below with reference to the drawings. However, the embodiment described below is an example to facilitate understanding of the invention and does not limit the invention. In other words, the invention may be changed and improved without departing from its purpose, and of course, the invention includes equivalents thereof.

In the following, an assembly of a conveyance seat and a battery (a conveyance seat assembly) mounted on a motorcycle will be cited as an example of a conveyance seat assembly, and an example of its configuration will be described.

In the following description, the “front-back direction” refers to the front-back direction of the motorcycle seat, and is the direction that coincides with the direction in which the motorcycle travels when traveling. The “seat width direction” refers to the width direction of the motorcycle seat, and is the same direction as the left and right directions as viewed from the occupant seated in the seat. The “vertical direction” is the vertical direction of the motorcycle seat and coincides with the vertical direction when the motorcycle is traveling on a horizontal surface.

### <Basic Configuration of the Conveyance Seat Assembly 101>

As shown in FIG. 15, the conveyance seat assembly 101 of this embodiment is a conveyance seat assembly 101 installed in the body B of a motorcycle, and consists of a conveyance seat 110 that constitutes a seating portion, a battery 120 that is positioned below the conveyance seat 110, and a battery support member 121 that supports the battery 120. The battery support member 121 supports the battery 120.

The conveyance seat 110 mainly comprises a bottom plate 111 that serves as a base substrate on the vehicle body B, a cushion material (not shown) that is placed on the bottom plate 111, and a skin material 113 that covers the bottom plate 111 and the cushion material.

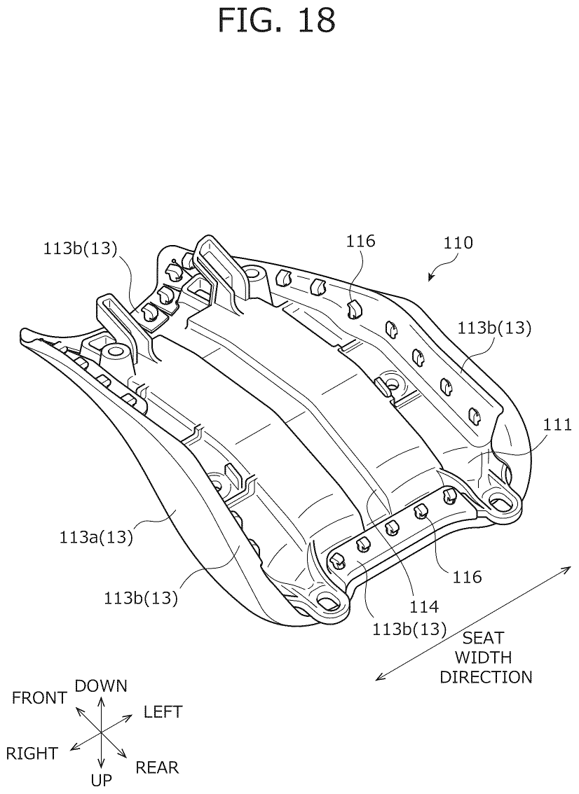

In the conveyance seat 110, as shown in FIG. 18, the surface skin terminal is processed by attaching an engagement hole provided in the terminal of the skin material 113 to an engaging pawl 116 provided on the back surface of the bottom plate 111, and an attachment method that does not use a tacker needle or the like is adopted.

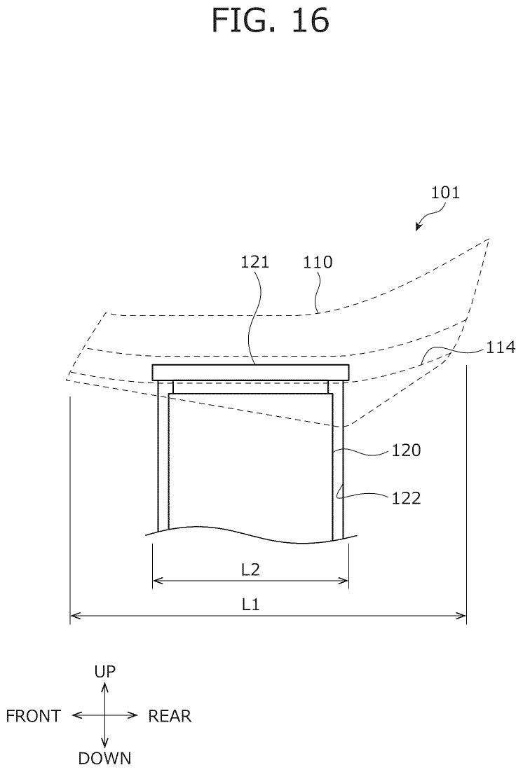

As shown in FIG. 16, the bottom plate 111 is a plate long in the front-back direction of the seat and is the base substrate of the conveyance seat 110, which is formed in a curved shape to match the outer shape of the car body B.

The bottom plate 111 is formed as a synthetic resin molded product using a resin material with a relatively high flexural modulus, such as glass fiber reinforced polypropylene (GFPP), as raw material.

Although it is preferable to use a relatively rigid resin material for the bottom plate 111, conventional raw materials such as polypropylene and polyethylene may be used without any particular limitation.

A plurality of engaging pawls 116 protruding from the back surface of the outer circumference of the bottom plate 111 are formed on the back surface of the outer circumference portion of the bottom plate 111, spaced at predetermined intervals over the entire circumference portion of the bottom plate 111.

The cushion material is made of an elastic member using urethane foam or the like, is a cushion pad long in the front-back direction of the seat, and is formed slightly larger than the outer shape of the bottom plate 111.

The skin material 113 is a covering material constituting the appearance of the conveyance seat 110, as shown in FIG. 18, and has a front surface-side skin material 113a and a back surface-side skin material 113b attached to a terminal portion of the front surface-side skin material 113a.

The front surface-side skin material 113a is made of a covering material using polyvinyl chloride leather, etc. To describe it in detail, the front surface-side skin material 113a is formed by pasting a soft polyvinyl chloride layer onto the surface of a fabric such as a knitted fabric.

The back surface-side skin material 113b is made of a less elastic covering material than the front surface-side skin material 113a, and is formed from a mesh-like fabric such as, for example, a queen's coat. In detail, the back surface-side skin material 113b is formed by laminating a soft polyvinyl chloride layer to the surface of a knitted or other fabric.

In the above configuration, the skin material 113 is suitable as a skin material for motorcycles that are directly exposed to wind and rain by adopting polyvinyl chloride leather or the like as the material of the front surface-side skin material 113a on the front side.

In addition, by forming the back surface-side skin material 113b from a mesh-like material, the skin material can be made lighter, and its drainage and ventilation properties can be improved.

In the vehicle body B, a battery accommodation portion 122 is provided below the conveyance seat 110, and a replaceable battery 120 is housed in the battery accommodation portion 122. In the case of an electric two-wheeled vehicle, by housing a replaceable battery, when the battery charge becomes low, it can be replaced with a fully charged battery and the vehicle can immediately be driven.

A battery support member 121 is provided on the top surface of the battery 120 to secure the battery 120 to the battery accommodation portion 122. The battery support member 121 may be used not only to secure the battery 120 to the battery accommodation portion 122, but also as a handle for replacing the battery.

When replacing the battery 120, the user (passenger) of the vehicle raises the conveyance seat 110, unfastens the battery, lifts the battery support member 121 on the battery, and removes it from the battery accommodation portion 122. After the battery 120 is replaced, the new battery is inserted into the battery accommodation portion 122 and secured by the battery support member 121.

In the case of electric two-wheeled vehicles, the battery 120 is larger and is frequently replaced, so the battery support member 121 and other battery-related parts are also larger, and the position of the conveyance seat tends to be higher than that of a conventional seat because the battery support member 121 and other battery-related parts are placed below the conveyance seat. The position of the conveyance seat tends to be higher than that of the conventional seat.

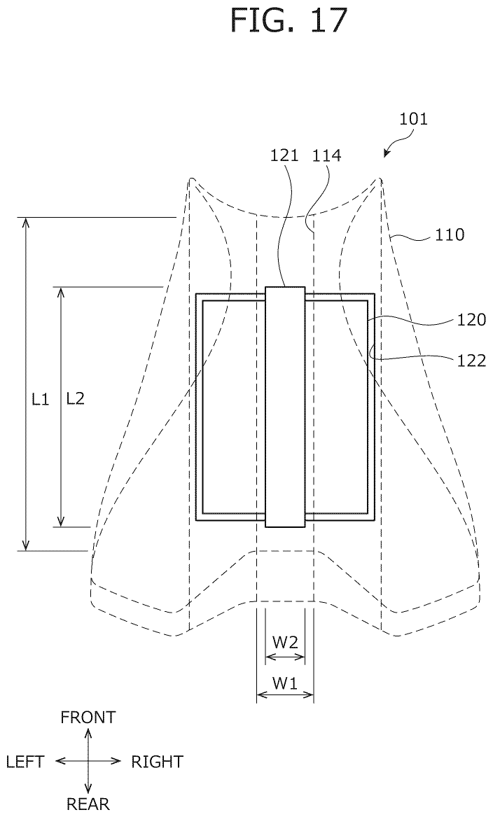

In this embodiment, the conveyance seat 110 is configured such that a first recess 114 extending in the front-back direction of the seat is formed in the surface opposite the battery 120, more particularly in the bottom surface of the bottom plate 111, as shown in FIG. 18, and at least a portion of the battery support member 121 is accommodated in the first recess 114, as shown in FIGS. 16 and 17.

The configuration of the first recess 114 formed in this embodiment is described as follows: since the battery support member 121 is provided to extend in the front-back direction of the seat, the first recess 114 formed on the underside of the conveyance seat 110 to accommodate the battery support member 121 is also formed to extend in the front-back direction in accordance with that direction. This allows for easy insertion. The first recess 114 is formed at an approximate center position in the sheet width direction. By forming the first recess 114 at an approximate central position, the left-right balance of the sheet rigidity can be improved.

The longitudinal length L1 (length in the front-back direction) of the first recess 114 is formed to be longer than the longitudinal length L2 of the battery support member 121. By making the length of the first recess 114 longer than the length of the battery support member 121 in the longitudinal direction, it becomes easier to insert the battery support member 121 into the first recess 114.

As shown in FIG. 17, the length W1 in the lateral direction (seat width direction) of the first recess 114 is formed to be longer than the length W2 in the lateral direction (seat width direction) of the battery support member 121. By making the length W1 of the first recess 114 longer than the length W2 of the battery support member 121 in the lateral direction, it becomes easier to insert the battery support member 121 into the first recess 114.

### Second Example

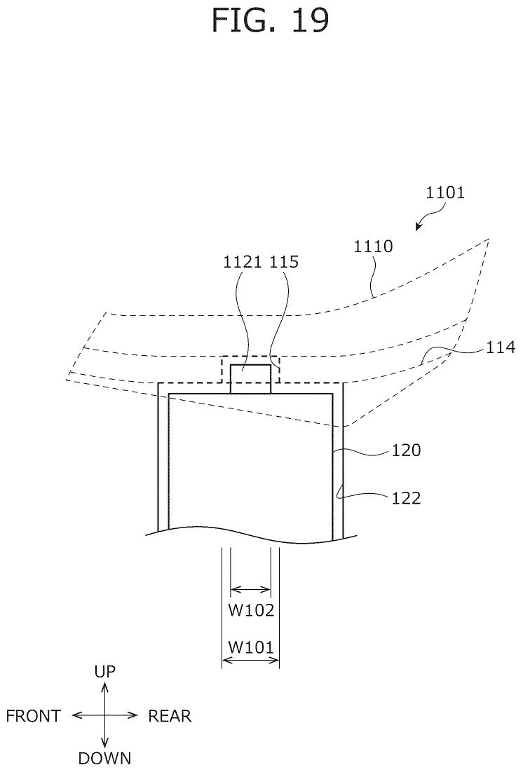

The second example of the second embodiment is described using FIGS. 19 to 21. The direction in which the battery support member 121 extends is not only in the front-back direction of the conveyance seat. As in the conveyance seat assembly 1101 shown in FIGS. 19 to 21, its battery support member 1121 may be provided to extend along the seat width direction.

In such a case, furthermore, a second recess 115 along the seat width direction may be formed. By forming the first recess 114 and the second recess 115 in accordance with the shape of the battery support member 1121, it is easier to insert the battery support member into the recesses and to prevent the sheet from being positioned higher.

Other configurations are the same as in the first example, so the same codes are used and their detailed descriptions are omitted.

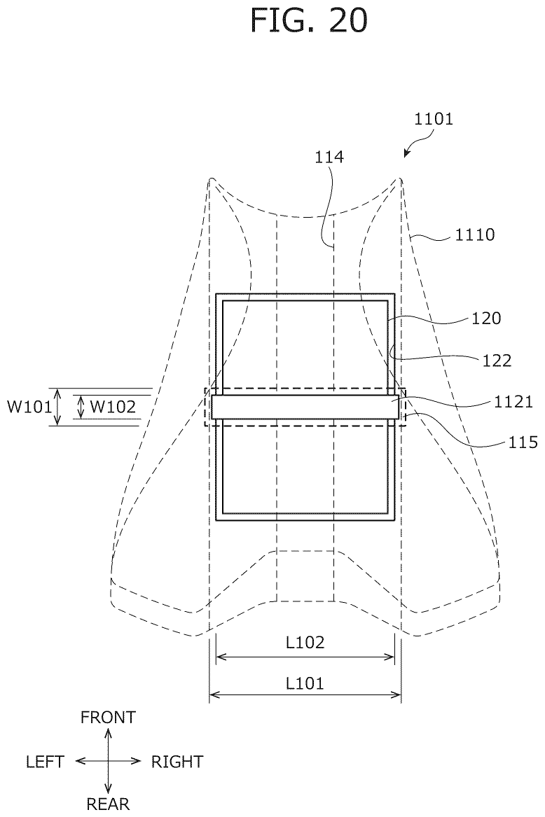

When the battery support member 1121 is provided along the seat width direction, as shown in FIG. 20, the length L101 in the longitudinal direction (seat width direction) of the second recess 115 to be accommodated is formed to be longer than the length L102 in the longitudinal direction (seat width direction, left-right direction) of the battery support member 121.

When the battery support member 121 is provided along the seat width direction, as shown in FIG. 20, the length W101 in the lateral direction (seat front-back direction) of the second recess 115 to be accommodated is formed to be longer than the length W102 in the lateral direction (seat front-back direction) of the battery support member 1121. This formation makes it easier to insert the battery support member 1121 into the second recess 115.

In the examples shown in FIGS. 19 to 22, the first recess 114 extending in the front-back direction is also formed, but the recess may be formed only in the seat width direction. The combination of the first recess 114 extending in the front-back direction and the second recess 115 extending in the sheet width direction can improve strength.

### Third Example

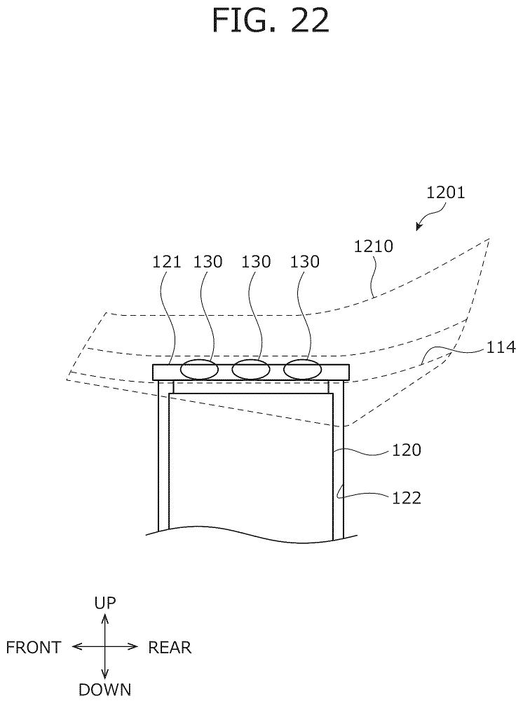

Using FIGS. 22 to 24, a third example conveyance seat assembly 1201 will be described. The third example conveyance seat assembly 1201 is an assembly comprising a conveyance seat 1210 and a battery 120, and a battery support member 121 is provided between the conveyance seat 1210 and the battery 120 to mount the battery 120. Furthermore, a plurality of air cells 130 are provided between the conveyance seat 1210 and the battery 120. The air cells 130 function as a seat moving mechanism to change the position of the conveyance seat 1210. The air cells 130 are connected to an unshown air inlet tube, which is inflated and deflated by supplying and expelling air, thereby adjusting the position of the conveyance seat 1210.

Other configurations are similar to the conveyance seat assembly 101 of the first example and the conveyance seat assembly 1101 of the second example, so the same codes are applied and detailed descriptions are omitted.

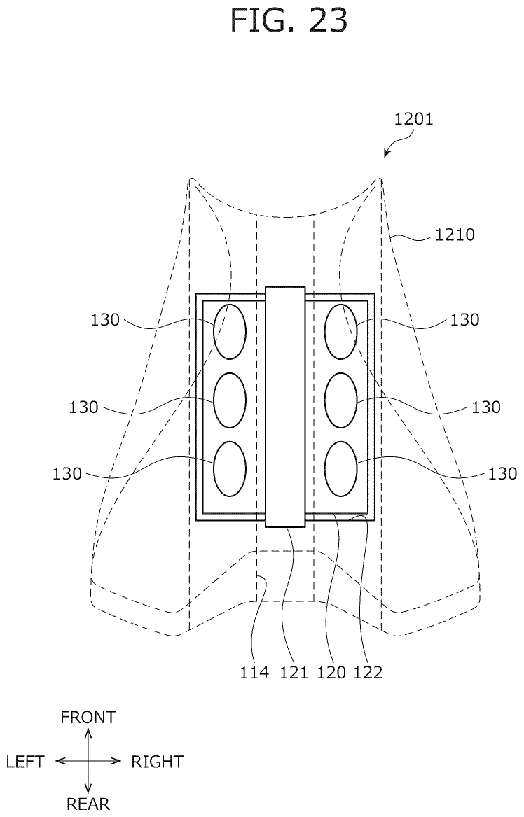

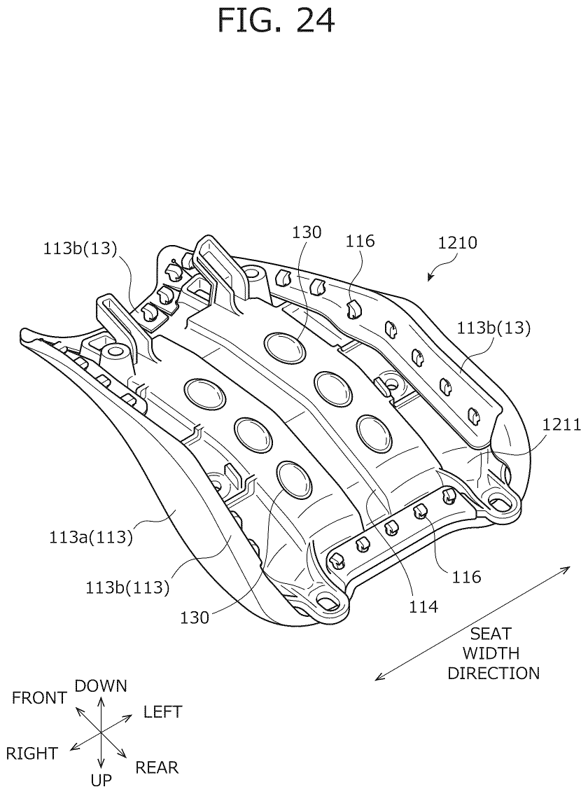

As shown in FIGS. 23 and 24, a first recess 114 is formed in the lower surface of the conveyance seat 1210. The air cell 130, which is a seat moving mechanism, is located at a position avoiding this first recess 114. In other words, the air cell 130 is positioned on the lower surface of the conveyance seat 1210 where the first recess 114 is not formed. By so arranging the air cell 130, the air cell 130 does not overlap with the battery support member 121 in the vertical direction, and the conveyance seat 1210 can be made larger, especially in the height direction.

The plurality of air cells 130 are arranged in line along the direction in which the first recess 114 extends (front-back direction). This arrangement enables stable support by the air cells 130.

The air cells 130 are arranged in symmetrical positions across the first recess 114 on the lower surface of the conveyance seat 1210. By positioning the air cells 130 in symmetrical positions, the conveyance seat 1210 can be moved in a stable manner.

In the example shown in FIG. 24, two parallel rows of three air cells 130 are provided in the front-back direction, but this is just one example; three or more air cells 130 may be arranged in parallel, or three or more rows may be provided in parallel.

The provision of air cells 130 as a seat moving mechanism is an example and is not limited to this. For example, a mechanical structure to change the position may be provided instead of the air cell 130. By using the air cell 130, the position of the conveyance seat 1210 can be precisely controlled.

### Fourth Example

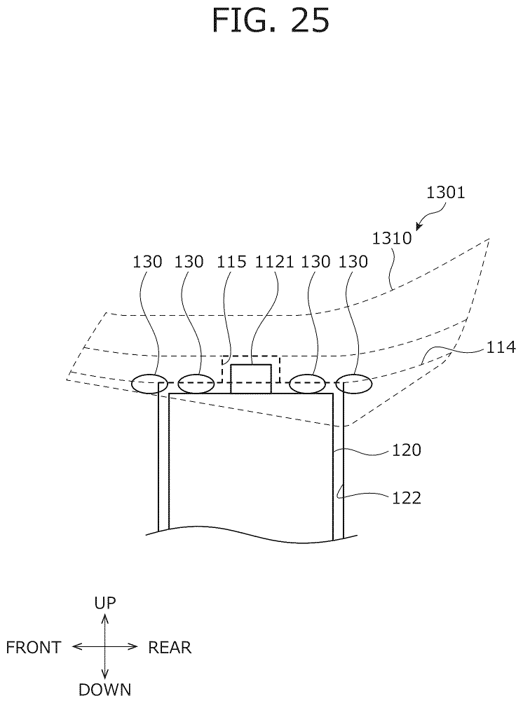

The fourth example conveyance seat assembly 1301 is described using FIGS. 25 to 27. The conveyance seat assembly 1301 of the fourth example is an assembly comprising a conveyance seat 1310 and a battery 120, and a battery support member 1121 extending in the seat width direction is provided between the conveyance seat 1310 and the battery 120. As in the third example conveyance seat assembly 1201, a plurality of air cells 130, which are seat moving mechanisms, are provided in line between the conveyance seat 1310 and the battery 120.

As in the second example conveyance seat assembly 1101, a first recess 114 extending in the front-back direction and a second recess 115 extending in the seat width direction are formed in the lower surface of the conveyance seat 1310, and the battery support member 1121 is accommodated in the second recess 115. Other configurations are the same as those of the conveyance seat assemblies 101, 1101, and 1201 of the first through third examples, so the same symbols shall be applied and the description thereof shall be omitted.

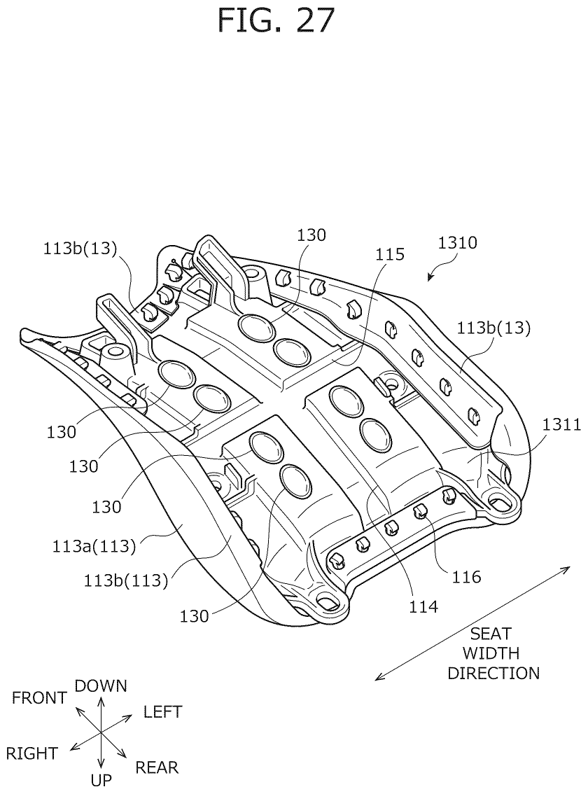

As shown in FIG. 27, the air cell 130 is disposed at a position avoiding the first recess 114 and the second recess 115 on the lower surface of the conveyance seat 1310. In other words, the air cell 130 is disposed at a position where the first recess 114 and the second recess 115 are not formed in the lower surface of the conveyance seat 1310. As a result, they do not overlap with the battery support member 1121 in the vertical direction, thereby reducing the size of the seat, especially in the height direction.

The plurality of air cells 130 are arranged in line along the direction in which the first recess 114 extends (front-back direction). This arrangement enables stable support by the air cells 130.

In the example shown in FIG. 27, the air cells 130 are arranged in symmetrical positions across the first recess 114 on the underside of the conveyance seat 1310. In addition, four air cells 130 aligned in the front-back direction are provided in two parallel rows. By arranging a plurality of air cells 130 in symmetrical positions in this manner, the conveyance seat 1310 can be moved stably.

The above figures illustrate the second embodiment of the invention. Although the conveyance seat assembly of the second embodiment is mounted on a motorcycle, the present invention is not limited to conveyance seat assemblies for motorcycles. The conveyance seat assembly may be a conveyance seat assembly for a four-wheeled or three-wheeled vehicle that is mounted on a ground vehicle with wheels, such as a car or train. It may also be a conveyance seat assembly installed in an aircraft or ship that moves other than on the ground.

### Third Embodiment

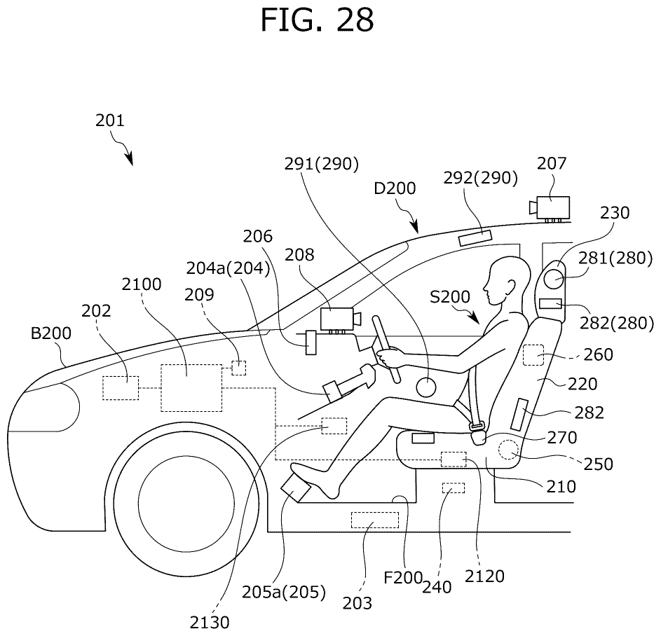

Hereinafter, a third embodiment of the present invention will be described with reference to FIGS. 28 to 39.

The third embodiment relates to an electric vehicle and a vehicle seat, particularly to an electric vehicle that includes a rotating machine that transmits torque to wheels, a vehicle interior component provided in a vehicle seat or a vehicle door, a control unit that controls the rotating machine, and a component control unit that controls the vehicle interior component, and that does not include an engine and a transmission and a clutch mechanism connected to the engine, and a vehicle seat.

### BACKGROUND ART

Generally, in a manual transmission vehicle (MT vehicle) in which a multi-stage manual transmission is installed, the gear ratio (transmission ratio) is changed in response to the operation of a clutch pedal and a shift lever by a driver. Meanwhile, in an electric vehicle in which a multi-stage manual transmission is not provided, since operations are not required during shifting, it is difficult for the driver to find driving entertaining.

Therefore, an electric vehicle capable of reproducing the manual shifting operation of an MT vehicle in a simulated manner has been known (for example, JP 6787507 B2 and JP 2020-156260 A).

The electric vehicle described in JP 6787507 B2 and JP 2020-156260 A includes a simulated clutch pedal for simulating the operation of a clutch mechanism; a simulated shift lever for simulating the operation of a transmission, and a torque control unit that controls torque of a rotating machine, and in a manual mode (MT mode), the torque control unit imparts the sensation of driving an MT vehicle to the driver by controlling torque of the rotating machine based on the operations of the simulated clutch pedal and the simulated shift lever.

### SUMMARY OF INVENTION

### Technical Problem

However, in the electric vehicle described in JP 6787507 B2 and JP 2020-156260 A, in the MT mode, since there is no change to a vehicle interior component provided in a vehicle seat or a vehicle door, it is difficult for the driver to recognize the sensation of driving an MT vehicle.

For this reason, when the driver performs a manual shifting operation in the electric vehicle in a simulated manner, discomfort is imparted to the driver, which is a risk, or sufficient fun is not imparted to the driver, which is a risk.

The present invention has been made in view of the above-described problems, and an object of the present invention is to provide an electric vehicle and a vehicle seat capable of improving comfort and entertainment of an occupant in an MT mode.

### Solution to Problem

The above-described problems are solved by an electric vehicle of the present invention including: a rotating machine that transmits torque to wheels; a vehicle interior component provided in a vehicle seat or a vehicle door; a control unit that controls the rotating machine; and a component control unit that controls the vehicle interior component, the electric vehicle not including an engine and a transmission and a clutch mechanism connected to the engine. The control unit includes a mode switching unit that switches a mode between a manual mode in which the rotating machine is controlled to simulate a manual transmission in response to an operation by the occupant and a normal mode in which the rotating machine is controlled differently from the manual mode. When the mode is switched to the manual mode by the mode switching unit, the component control unit controls the vehicle interior component.

With the above-described configuration, in the MT mode, since not only components used for the manual shifting operation of an MT vehicle, but also the vehicle interior component provided in the vehicle seat or the vehicle door are controlled, it is easy for the occupant to have more fun. In addition, in the MT mode, since the vehicle interior component provided in the vehicle seat or the vehicle door is controlled to reproduce an MT vehicle in a simulated manner, a driver can drive with a sensation close to that of the manual shifting operation of an MT vehicle.

Therefore, comfort and entertainment of the occupant in the MT mode can be improved.

In this case, the vehicle interior component includes a movable body that is attached inside of the vehicle seat, and that operates to protrude a part of the vehicle seat toward a seated occupant side from a normal position. When the mode is switched to the manual mode by the mode switching unit, the component control unit may control the movable body.

With the above-described configuration, in MT mode, since the movable body provided in the vehicle seat is controlled to protrude toward the side of the occupant seated in the vehicle seat (seated occupant), the occupant easily feels a sense of restraint similar to that of a sports vehicle due to the movable body. Therefore, safety, feeling, or entertainment of the occupant in the MT mode can be further improved.

In this case, when a predetermined condition is satisfied in the manual mode, the component control unit may change an amount of protrusion of the movable body.

With the above-described configuration, since the amount of protrusion of the movable body changes depending on the predetermined condition (for example, a change in vehicle speed, road situations, or the like), the occupant easily feels a sense of restraint due to the movable body that changes depending on the situation. Therefore, safety, feeling, or entertainment of the occupant in the MT mode can be even more improved.

In this case, the vehicle interior component may be a seat belt device provided in the vehicle seat. The seat belt device may include a seat belt that restrains the occupant, and a belt retractor that extractably winds the seat belt. When the mode is switched to the manual mode by the mode switching unit, the component control unit may control the belt retractor.

With the above-described configuration, in the MT mode, since the seat belt is controlled by the belt retractor to tighten the seat belt around the occupant seated in the vehicle seat, the occupant is more likely to feel a sense of restraint by the seat belt, as in a sports car. Therefore, safety, feeling, or entertainment of the occupant in the MT mode can be further improved.

In this case, the vehicle seat may include a seat body including a seat cushion and a seat back, and a rail device that supports the seat body so as to be movable forward and rearward with respect to a vehicle body floor or a reclining device that rotatably connects the seat back to the seat cushion. When the mode is switched to the manual mode by the mode switching unit, the component control unit may control the rail device or the reclining device.

With the above-described configuration, in the MT mode, since the seat body is operated by the rail device or the reclining device, the occupant easily feels a seating comfort similar to that of a sports vehicle. Therefore, comfort or entertainment of the occupant in the MT mode can be further improved.

In this case, the mode switching unit may be switchable between the manual mode, the normal mode, and an autonomous driving mode in which the electric vehicle is capable of autonomous driving. An amount of movement of the seat body or the seat back when the mode is switched to the autonomous driving mode by the mode switching unit may be more restricted than an amount of movement of the seat body or the seat back when the mode is switched to the manual mode.

With the above-described configuration, since the amount of movement of the seat body is restricted in the autonomous driving mode, the occupant can assume a relaxed posture. Therefore, a sense of restraint or a sense of freedom can be imparted to the occupant depending on the mode.

In this case, the control unit may include an identification information acquisition unit that acquires identification information of the occupant, a mode setting unit that sets the mode in response to an operation by the occupant, and a storage unit that stores the mode set by the mode setting unit, in association with the identification information of the occupant. The mode switching unit may switch the mode based on the mode associated with the identification information of the occupant.

With the above-described configuration, since the mode can be switched to suit the occupant, for example, driving can be started in a preferred mode without the need to input a mode each time. In addition, the mode can be restricted from being switched to the MT mode by an occupant who is prohibited from driving an MT vehicle (a person who holds a license limited to driving automatic transmission vehicles) or a novice occupant.

Therefore, convenience of the occupant in the MT mode can be improved.

In this case, the storage unit may store restriction information that restricts the occupant from driving a manual transmission vehicle, in association with the identification information of the occupant. When the restriction information is stored in the storage unit, the mode switching unit may restrict the mode from being switched to the manual mode.

With the above-described configuration, since the mode is restricted from being switched to the MT mode due to the restriction information that restricts the occupant from driving MT vehicles, a situation where an occupant who does not hold a license that allows the driving of MT vehicles drives in the MT mode can be suppressed.

In this case, the electric vehicle may include a passenger detection unit that detects a passenger different from the occupant. When the passenger is detected by the passenger detection unit, the mode switching unit may restrict the mode from being switched to the manual mode.

With the above-described configuration, since the mode is restricted from being switched to the MT mode depending on the presence or absence of the passenger, safety when the passenger is in the vehicle can be further improved.

In addition, the above-described problems are solved by a vehicle seat of the present invention that is mounted in an electric vehicle including a rotating machine that transmits torque to wheels, and not including an engine and a transmission and a clutch mechanism connected to the engine, the vehicle seat including: a seat body; a vehicle interior component provided in the seat body; a component control unit that controls the vehicle interior component; and an acquisition unit that acquires a switching signal to switch between a manual mode in which the rotating machine is controlled to simulate a manual transmission in response to an operation by an occupant and a normal mode in which the rotating machine is not controlled to simulate the manual transmission. When the switching signal is acquired by the acquisition unit, the component control unit may control the vehicle interior component.

With the above-described configuration, in the MT mode, since the vehicle interior component provided in the vehicle seat or the vehicle door is controlled, it is easy for the occupant to have more fun. In addition, in the MT mode, since the vehicle interior component provided in the vehicle seat or the vehicle door is controlled to reproduce an MT vehicle in a simulated manner, a driver can drive with a sensation close to that of the manual shifting operation of an MT vehicle.

Therefore, comfort and entertainment of the occupant in the MT mode can be improved.

### Advantageous Effects of Invention

According to the present invention, comfort and entertainment of the occupant in the MT mode can be improved.

In addition, safety, feeling, or entertainment of the occupant in the MT mode can be further improved.

In addition, safety, feeling, or entertainment of the occupant in the MT mode can be even more improved.

In addition, comfort or entertainment of the occupant in the MT mode can be further improved.

In addition, a sense of restraint or a sense of freedom can be imparted to the occupant depending on the mode.

In addition, convenience of the occupant in the MT mode can be improved.

In addition, a situation where an occupant who does not hold a license that allows the driving of MT vehicles drives in the MT mode can be suppressed.

In addition, safety when a passenger is in the vehicle can be improved.

### DESCRIPTION OF EMBODIMENTS

Hereinafter, an embodiment according to the present invention will be described with reference to FIGS. 28 to 39.

In the following description, as shown in FIG. 28, the “front to rear direction” refers to a front to rear direction when viewed from an occupant (hereinafter, may be referred to as a seated occupant) of a vehicle seat S200, and is a direction coinciding with a traveling direction of a vehicle. The “seat width direction” is a lateral width direction of the vehicle seat S200, and coincides with a right to left direction when viewed from the occupant of the vehicle seat S200. In addition, as shown in FIG. 28, the “up to down direction” is an up to down direction of the vehicle, and is a direction coinciding with a vertical direction when the vehicle travels on a horizontal surface.

### <Overall Configuration of Electric Vehicle>

As shown in FIG. 28, an electric vehicle 201 of the present embodiment is, for example, a four-wheeled electric vehicle (EV vehicle) capable of autonomous driving, and includes a vehicle body B200; the vehicle seat S200 which is disposed in an interior space of the vehicle body B200, and in which the occupant is seated; and a vehicle door D200 which is disposed to partition the interior space and an exterior space of the vehicle body B200 off from each other, and through which the occupant gets in and out of the vehicle.

Incidentally, in the following embodiment, the electric vehicle 201 is, as an example, a standard passenger car, but can also be applied to any type of vehicle such as a station wagon or a sport utility vehicle (SUV). In addition, the electric vehicle 201 is not limited to an EV vehicle capable of autonomous driving, and may be an EV vehicle incapable of autonomous driving. In addition, the electric vehicle 201 is not limited to a four-wheeled autonomous vehicle, and may be, for example, a three-wheeled vehicle (two wheels in the front and one wheel in the rear).

As shown in FIG. 28, the electric vehicle 201 is an electric vehicle that does not include an engine and a transmission and a clutch mechanism connected to the engine, and includes a rotating machine 202 that transmits torque to wheels, and a battery 203 for driving the vehicle that supplies electric power to the rotating machine 202.

In addition, the electric vehicle 201 does not include a mechanical manual transmission, and travels upon the rotating machine 202 being rotated by electric power, but includes a simulated shift device 204 that simulates the operation of the transmission, and a simulated clutch device 205 for simulating the operation of the clutch mechanism.

Further, the electric vehicle 201 includes a touch panel 206 that can be operated by the occupant; an exterior vehicle camera 207 that captures an image of the surroundings of the vehicle body B200; an interior vehicle camera 208 that captures an image of the interior of the vehicle body B200; and a vehicle speed sensor 209 that detects a vehicle speed.

The electric vehicle 201 is switchable, for example, between a manual driving mode in which a driver performs driving operations and an autonomous driving mode in which driving operations by the driver are not required, which are traveling modes, depending on an operation by the occupant.

Further, the electric vehicle 201 is switchable between a manual mode (hereinafter, MT mode) in which the rotating machine 202 is controlled to simulate a manual transmission in response to an operation by the occupant and a normal mode (hereinafter, EV mode) of the electric vehicle 201 in which the rotating machine 202 is controlled differently from the MT mode, which are the manual driving modes.

In the present embodiment, an example in which the electric vehicle 201 is switchable between the MT mode, the EV mode, and the autonomous driving mode which are traveling modes will be described. The occupant can perform switching between the modes by selecting a traveling mode using the touch panel 206.

The MT mode is a traveling mode in which the torque characteristics of the electric vehicle 201 are changed in response to the operation of the simulated shift device 204 and the simulated clutch device 205 to simulate a manual transmission.

The EV mode is a traveling mode in which the torque characteristics of the electric vehicle 201 are automatically changed without depending on the operation of the simulated shift device 204 and the simulated clutch device 205, as in an automatic transmission vehicle.

The autonomous driving mode is a traveling mode in which the situation of the electric vehicle 201 is determined based on signals output by various sensors and a signal input by the occupant, and the electric vehicle 201 is allowed to travel autonomously according to the determination result.

As shown in FIG. 28, the rotating machine 202 is provided on the front side of the vehicle body B200, and includes a traveling motor 202a that is, for example, a three-phase AC motor. An output shaft of the traveling motor 202a is connected to the front wheels via a shaft. The traveling motor 202a is controlled by a motor ECU 2110 to be described later based on an instruction torque transmitted from an ECU 2100 to be described later.

As shown in FIG. 28, the battery 203 is disposed below a vehicle body floor F200, and stores electric energy to be used to drive the rotating machine 202.

The simulated shift device 204 includes a simulated shift lever 204a for selecting a shift position; a vibration imparting unit 204b that imparts vibration to the driver; and a shift lever sensor 204c that detects a shift position.

The simulated shift lever 204a is provided in the vicinity of a driver's seat of the electric vehicle 201 at a position where the driver can operate the simulated shift lever 204a, and has a shape similar to that of a shift lever provided in a typical manual transmission vehicle (MT vehicle).

The simulated shift lever 204a is an operating unit for selecting one of shift positions, which correspond to a plurality of virtual gear stages with different torque characteristics, in the MT mode. The shift positions include, for example, forward ranges of 1st, 2nd, 3rd, 4th, and 5th gears, and a reverse range for reverse travel. The torque characteristics of each virtual gear stage are preset to torque characteristics simulating the gear stages of an MT vehicle. The shift position selected by the driver using the simulated shift lever 204a is detected by the shift lever sensor 204c, and is transmitted to the ECU 2100.

In order to notify the driver of various information, the vibration imparting unit 204b generates vibration that can be sensed by the driver. For example, when the traveling mode has transitioned to the MT mode, the vibration imparting unit 204b notifies the driver that the simulated shift lever 204a can be operated, or vibrates according to a change in torque characteristics to impart the operational feel of an MT vehicle to the driver.

The simulated clutch device 205 includes a simulated clutch pedal 205a for selecting a shift position; a resistance force imparting portion 205b for bringing the simulated clutch pedal 205a closer to the operational feel of an MT vehicle; and a pedal sensor 205c for detecting the amount of depression of the simulated clutch pedal 205a.

The simulated clutch pedal 205a is provided in the vicinity of the driver's seat of the electric vehicle 201 at a position where the simulated clutch pedal 205a can be depressed, and has a shape similar to that of a clutch pedal provided in a typical MT vehicle.

The simulated clutch pedal 205a is depressed when the driver operates the simulated shift lever 204a, and serves to simulate the sensation of driving in the MT mode. The amount of depression of the simulated clutch pedal 205a is detected by the pedal sensor 205c, and is transmitted to the ECU 2100.

The resistance force imparting portion 205b generates a resistance force in a direction in which the simulated clutch pedal 205a returns, in response to the operation of the simulated clutch pedal 205a. For example, the resistance force imparting portion 205b imparts a resistance according to a change in torque characteristics to impart the operational feel of an MT vehicle to the driver.

As shown in FIG. 28, the touch panel 206 is provided on the front side inside the vehicle body B200 of the electric vehicle 201 (for example, on the instrument panel) at a position where the touch panel 206 can be operated by the occupant. The touch panel 206 allows the occupant to input an operation thereto, and has the function of a display device that displays information to the occupant.

For example, the touch panel 206 is used for input operations such as setting or selecting a traveling mode, setting the torque of the rotating machine 202 in the MT mode, setting the vehicle seat S200 or the vehicle door D200 in the MT mode, selecting a range in the EV mode, and setting a destination in the autonomous driving mode. Information input to the touch panel 206 is transmitted to the ECU 2100.

In addition, the touch panel 206 displays, for example, a screen for a setting or selection by the occupant, information to the occupant, a video or the like acquired from the exterior vehicle camera 207 or the interior vehicle camera 208, and the like. Contents displayed on the touch panel 206 are controlled by the ECU 2100.

As shown in FIG. 28, the exterior vehicle camera 207 is provided outside the vehicle body B200 of the electric vehicle 201 (for example, on the roof) at a position where the exterior vehicle camera 207 can capture an image of the surroundings of the electric vehicle 201. The electric vehicle 201 can determine the state of the surroundings of the electric vehicle 201 based on image information captured by the exterior vehicle camera 207.

For example, by capturing an image of the surroundings of the electric vehicle 201, other vehicles traveling nearby can be detected, and whether a high-risk road with consecutive curves can be detected.

Information captured by the exterior vehicle camera 207 is transmitted to the ECU 2100 as captured image data.

As shown in FIG. 28, the interior vehicle camera 208 is provided on the front side inside the vehicle body B200 of the electric vehicle 201 (for example, on the instrument panel) at a position where the interior vehicle camera 208 can capture an image of the occupant (driver or passenger). The electric vehicle 201 can determine the state of the occupant based on image information captured by the interior vehicle camera 208.

For example, identification information of the driver (driver ID) can be recognized by capturing an image of the face of the driver. In addition, by capturing an image of the occupant, it can be detected that the driver or a passenger is seated in the vehicle seat S200. In other words, the interior vehicle camera 208 has the function of a seating sensor or a passenger detection sensor.

Information captured by the interior vehicle camera 208 is transmitted to the ECU 2100 as captured image data.

As shown in FIG. 28, the vehicle speed sensor 209 is provided inside the vehicle body B200, and detects the traveling speed of the electric vehicle 201. The electric vehicle 201 can determine whether the electric vehicle 201 is in traveling condition or whether the electric vehicle 201 travels at high speed, based on the detection value of the vehicle speed sensor 209. Information detected by the vehicle speed sensor 209 is transmitted to the ECU 2100 as vehicle speed data.

### <Configuration of Vehicle Seat>

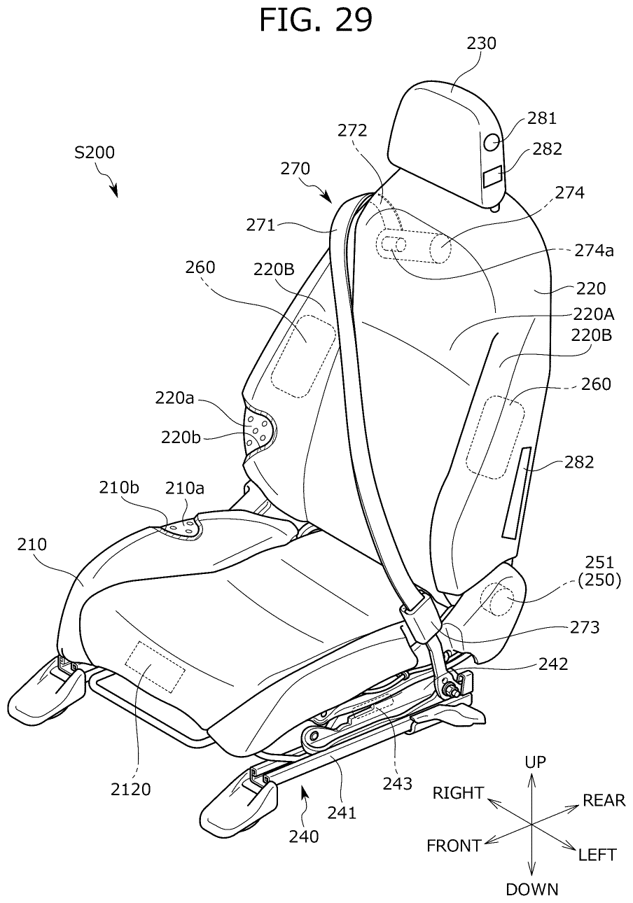

As shown in FIGS. 28 and 29, the vehicle seat S200 is mounted on the vehicle body B200, and includes a seat body including a seat cushion 210, a seat back 220, and a headrest 230; a rail device 240 that supports the seat body so as to be movable forward and rearward with respect to the vehicle body floor F200; a reclining device 250 that rotatably connects the seat back 220 to the seat cushion 210; a seat movement device 260 that operates to protrude a part of the seat back 220; a seat belt device 270 that is attached inside the seat back 220, and that restrains the upper body of the seated occupant; and a seat notification device 280 that notifies the occupant of various information.

As shown in FIG. 29, the seat cushion 210 is a seating portion that supports the occupant from below, and is configured by placing a pad material 210a on a cushion frame serving as a skeleton, and covering the pad material 210a with a skin material 210b.

The seat back 220 is a backrest portion that supports the back of the occupant from behind, and is configured by placing a pad material 220a on a back frame 221 serving as a skeleton, and covering the pad material 220a with a skin material 220b.

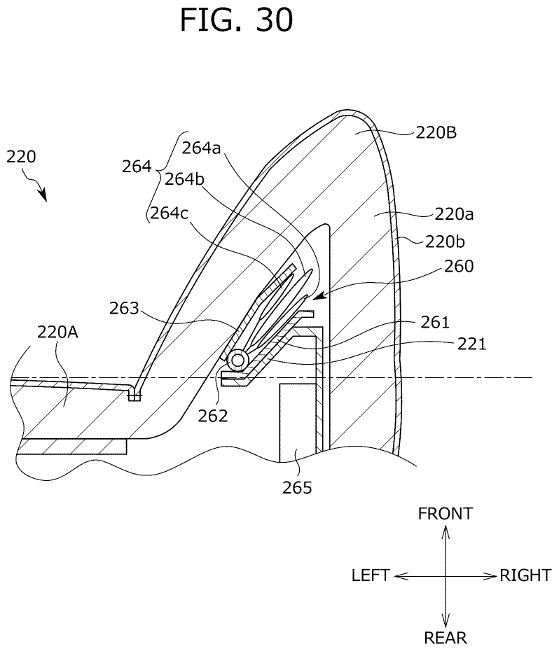

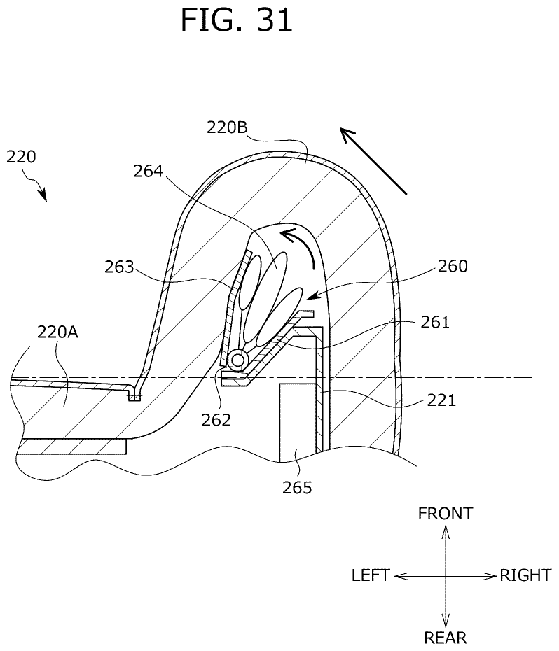

As shown in FIGS. 30 and 31, the seat back 220 is composed of a central portion 220A located at a central portion of the seat back 220 in the seat width direction, and right and left side portions 220B (side bolster portions) located outside the central portion 220A in the seat width direction.

As shown in FIG. 29, the rail device 240 is an electric device that moves the seat body forward and rearward with respect to the vehicle body floor F200. The rail device 240 includes a lower rail 241 extending in the front to rear direction, is fixed to the vehicle body floor F200; an upper rail 242 extending in the front to rear direction, and fixed to the seat cushion 210; and a rail drive motor 243 that moves the upper rail 242 in the front to rear direction with respect to the lower rail 241.

When the occupant is seated on the seat cushion 210, upon the occupant operating a switch (not illustrated) or upon a seat ECU 2120 to be described later receiving a control signal, the rail drive motor 243 is driven to move the seat body forward and rearward with respect to the vehicle body floor F200.

As shown in FIG. 29, the reclining device 250 is an electric device that tilts the seat back 220 with respect to the seat cushion 210. The reclining device 250 is attached to the left side in the seat width direction, and including a rotation motor 251 that tilts the seat back 220 to a predetermined angle.

When the occupant is seated on the seat cushion 210, upon the occupant operating a switch (not illustrated) or upon the seat ECU 2120 receiving a control signal, the rotation motor 251 is driven to tilt the seat back 220 in the front to rear direction with respect to the seat cushion 210.

As shown in FIGS. 29 to 31, the seat movement device 260 is an electric device that operates to protrude the side portion 220B of the seat back 220. The seat movement device 260 is, for example, a movable body including an air cell, and by filling the seat movement device 260 with compressed air, the seat movement device 260 is bulged toward an occupant (seated occupant) side, and protrudes from a normal position to a protruding position. Then, the seat movement device 260 is deflated and returns to the normal position as the filled compressed air is discharged.

Specifically, the seat movement device 260 is a side support member that supports the seated occupant from the side, and is disposed between the pad material 220a and the back frame 221 in the side portion 220B of a lower portion of the seat back 220. The seat movement device 260 is attached to a front surface of the back frame 221 in a folded state.

The seat movement device 260 operates to protrude the pad material 220a of the side portion 220B towards the seated occupant side.

The seat movement device 260 has a substantially pentagonal shape that is long in the up to down direction, and is mainly composed of a base member 261 supported by the back frame 221; a rotating member 263 disposed at a seat front position with respect to the base member 261, and attached to be rotatable with respect to the base member 261 via a rotating shaft 262; a plurality of bags 264 disposed between the base member 261 and the rotating member 263, and supported on a front surface of the base member 261; and an air supply unit 265 that is attached inside the seat body, and supplies compressed air to the bags 264.

The base member 261 is attached to the front surface of the back frame 221, and extends to protrude in the seat width direction along the front surface of the back frame 221.

The rotating shaft 262 is attached to an inner end portion of a front surface of the base member 261 in the seat width direction.

The rotating member 263 is attached to the base member 261 to be rotatable in the seat front to rear direction, and can protrude and push the side portion 220B of the seat back 220 toward a seat front side by rotating toward the front of the seat. The rotating member 263 is a plate body having a curved shape that is slightly curved toward the front of the seat. For that reason, the contact area between the rotating member 263 and the pad material 220a is somewhat reduced, and the pushing force of the rotating member 263 is efficiently transmitted to the pad material 220a.

Incidentally, when the seat back 220 is in the normal position, the rotating member 263 is disposed at a position closer to a base member 261 side. In addition, the rotating member 263 may be biased toward the base member 261 side by a biasing spring (biasing member) (not illustrated).

The plurality of bags 264 are supported by the base member 261, and by filling the plurality of bags 264 with compressed air, the plurality of bags 264 can be bulged toward the seat front side to push the rotating member 263 toward the front of the seat. Namely, the plurality of bags 264 can rotate the rotating member 263 toward the front of the seat.

The plurality of bags 264 are disposed at different positions in the seat front to rear direction and the seat width direction, and are configured with different sizes.

In detail, the plurality of bags 264 are composed of three air cells, and among the plurality of bags 264, a first bag 264a located farthest toward the seat front side is configured with the smallest capacity compared to the other air cells. Furthermore, a second bag 264b is configured with the largest capacity, and a third bag 264c is configured with a medium capacity.

With the above-described configuration, the protruding direction or the amount of protrusion of the side portion 220B of the seat back 220 can be adjusted by bulging the plurality of bags 264 having different positions and sizes.

In addition, the occurrence of wrinkles or slack in the skin material 220b of the seat back 220 can be suppressed by adjusting the protruding direction or the amount of protrusion of the side portion 220B of the seat back 220.

The air supply unit 265 is attached inside the seat body, and supplies compressed air to the bags 264. The air supply unit 265 supplies compressed air to the bags 264 and discharges the compressed air from the bags 264 using an air pump.

When the occupant is seated on the seat cushion 210, upon the occupant operating a switch (not illustrated) or upon the seat ECU 2120 to be described later receiving a control signal, the air supply unit 265 is driven to adjust the movement range of the bags 264.

The seat movement device 260 can bulge to move the side portion 220B of the seat back 220 from the “normal position” shown in FIG. 30 to the “protruding position” shown in FIG. 31.

In the “normal position” shown in FIG. 30, the seat movement device 260 is disposed between the back frame 221 and the skin material 220b in the seat front to rear direction. Specifically, the seat movement device 260 is attached to the front surface of the back frame 221, and is disposed on a back surface of the pad material 220a.

Furthermore, by receiving a supply of compressed air from the air supply unit 265, the bags 264 in a folded state are bulged and deployed toward the front of the seat to push the rotating member 263 toward the front of the seat, so that the side portion 220B is moved toward the front of the seat. As a result, the side portion 220B is moved to the “protruding position”.

Incidentally, by discharging the compressed air inside the bags 264 using the air supply unit 265, the bags 264 in an inflated state are deflated to lower the side portion 220B downward toward the rear of the seat. As a result, the side portion 220B of the seat back 220 returns from the “protruding position” to the “normal position”.

In the present embodiment, the seat movement device 260 is attached to the seat back 220, but is not particularly limited thereto, and may be attached to the seat cushion 210.

In addition, the seat movement device 260 may be configured to be operated by a mechanical mechanism (a link mechanism, a hinge mechanism). Incidentally, the air supply unit 265 may be configured as a motor-type or hydraulic drive device or the like.

As shown in FIG. 29, the seat belt device 270 is mainly composed of a seat belt 271 that restrains the upper body of the seated occupant; a belt guide 272 that is provided at a right upper end of the seat back 220, and that guides the seat belt 271; a belt buckle 273 that is provided on the rail device 240, and that is detachably connected to the seat belt 271; and a belt retractor 274 that is attached to the back frame 221, and that extractably winds the seat belt 271.

The seat belt 271 extends up and down along the shoulders of the occupant, and restrains the right shoulder of the occupant to the seat back 220.

The belt guide 272 is attached at a position above the belt retractor 274 on the right side of the seat back 220, and guides the seat belt 271, which is extracted from the belt retractor 274, toward the belt buckle 273 on the lower left.

The belt buckle 273 is provided on an outer surface on the left side of the rail device 240, and is detachably connected to a belt tongue plate (not illustrated) attached to a tip portion of the seat belt 271.

The belt retractor 274 is a winding device that winds an upper end of the seat belt 271. The belt retractor 274 includes a winding motor 274a for winding the seat belt 271.

When the occupant is seated on the seat cushion 210, upon the occupant operating a switch (not illustrated) or upon the seat ECU 2120 to be described later receiving a control signal, the winding motor 274a is driven to adjust a sense of restraint of the upper body of the seated occupant.

As shown in FIG. 28, the seat notification device 280 is a device that is provided in the vehicle seat S200, and that notifies the occupant of a message or the like. The seat notification device 280 includes a sound output device 281 that outputs sound, and a light-emitting device 282 composed of a plurality of LED elements.

As shown in FIG. 29, the sound output device 281 is a speaker that is provided in the headrest 230, and that outputs a sound such as a beep sound, an alarm sound, a voice message, or a music.

The sound output device 281 can notify the occupant seated on the seat cushion 210 of various information upon the seat ECU 2120 receiving a control signal.

As shown in FIG. 29, the light-emitting device 282 is a lighting device that is provided in the seat back 220 and the headrest 230, and that emits light inside the vehicle.

The light-emitting device 282 can notify the occupant of various information upon the seat ECU 2120 receiving a control signal and controlling the emission of light of each of the LED elements and the timing thereof.

### <Configuration of Vehicle Door>

As shown in FIG. 28, the vehicle door D200 is configured by covering a door lining base material serving as a substrate with a door skin material. The vehicle door D200 includes a door notification device 290 that notifies the occupant of various information.

As shown in FIG. 28, the door notification device 290 is a device that is provided in the vehicle door D200, and that notifies the occupant of a message or the like. The door notification device 290 includes a door sound output device 291 that outputs a sound, and a door light-emitting device 292 composed of a plurality of LED elements.

As shown in FIG. 28, the door sound output device 291 is a speaker that is provided in a central portion on the vehicle interior side of the vehicle door D200, and that outputs a sound such as a beep sounds, an alarm sound, a voice message, or a music.

The door sound output device 291 can notify the occupant seated on the seat cushion 210 of various information upon a door ECU 2130 to be described later receiving a control signal.

As shown in FIG. 28, the door light-emitting device 292 is a lighting device that is provided at an upper portion on the vehicle interior side of the vehicle door D200, and that emits light inside the vehicle.

The door light-emitting device 292 can notify the occupant of various information upon the door ECU 2130 receiving a control signal and controlling the emission of light of each of the LED elements and the timing thereof.

### <Hardware Configuration of Electric Vehicle>

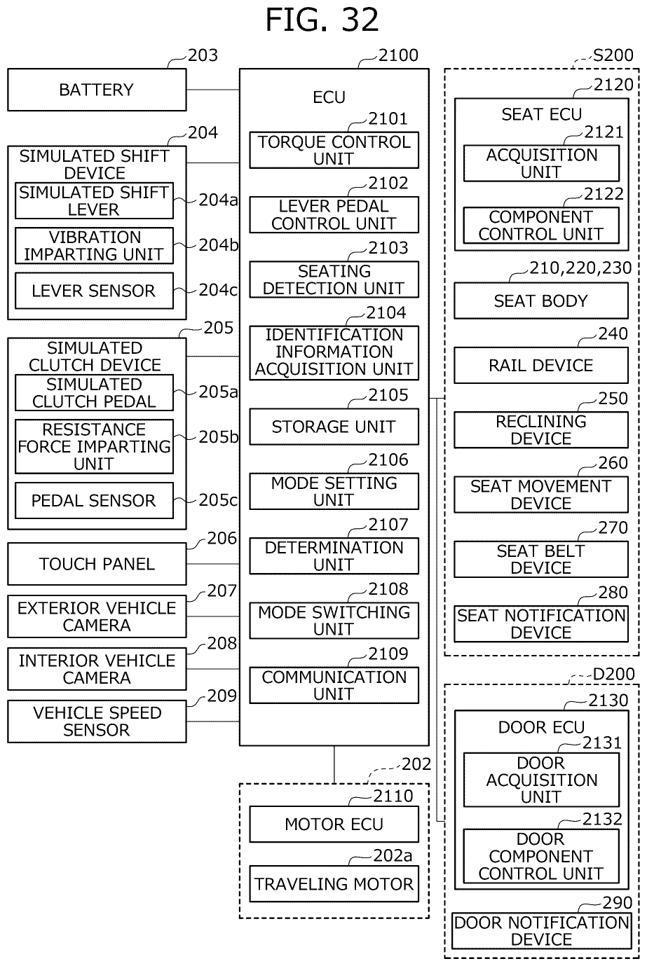

As shown in FIG. 32, the electric vehicle 201 includes the ECU 2100 that controls the traveling of the vehicle, and the motor ECU 2110, the seat ECU 2120, and the door ECU 2130 as subordinate ECUs of the ECU 2100.

Each ECU has a control circuit, and is mainly composed of a central processing unit (CPU) that is a central arithmetic device; a read only memory (ROM), a random access memory (RAM), a hard disk drive (HDD) serving as storage devices; and the like.

The CPU is a central arithmetic processing unit, and executes various programs or controls each portion. Namely, the CPU reads out a program from the ROM or the HDD, and executes the program using the RAM as a working region. The CPU executes control of each configuration and various arithmetic processing according to the programs stored in the ROM or the HDD.

The ROM stores various programs and various data. The RAM serves as a working region to temporarily store a program or data.

The HDD may be a solid state drive (SSD), and stores various programs including an operating system, and various data.

The ECU 2100 of the present embodiment incorporates a control circuit that performs torque control to determine a torque value to be instructed to the rotating machine 202. The ECU 2100 is connected to the rotating machine 202, the battery 203, the simulated shift device 204, the simulated clutch device 205, the touch panel 206, the exterior vehicle camera 207, the interior vehicle camera 208, and the vehicle speed sensor 209. The configurations are connected to each other via a bus to be able to communicate with each other.

Incidentally, in addition thereto, various actuators, input devices, or output devices, or various sensors may be installed in the electric vehicle 201.

When the electric vehicle 201 is in the MT mode, the driver is allowed to perform a simulated manual shifting operation by a torque control unit 2101 of the ECU 2100, which will be described later.

The ECU 2100 uses a known technique for simulating a manual transmission, and controls the drive torque of the rotating machine 202. In the torque control of the rotating machine 202, the ECU 2100 performs calculations based on the assumption that the traveling state of the electric vehicle 201 is realized by an MT vehicle in which a virtual engine and a virtual transmission are installed.

The motor ECU 2110 controls the traveling motor 202a based on an instruction torque transmitted from the ECU 2100.

In addition, when the electric vehicle 201 is in the MT mode, the ECU 2100 can cause a lever pedal control unit 2102 to be described later to notify the driver of various information or to impart the operational feel of an MT vehicle to the driver.

Further, when the electric vehicle 201 is in the MT mode, the ECU 2100 transmits various information to the seat ECU 2120 or the door ECU 2130. Furthermore, the seat ECU 2120 or the door ECU 2130 can notify the driver of various information, or impart the operational feel of an MT vehicle to the driver.

When the electric vehicle 201 is in the autonomous driving mode, the ECU 2100 determines the surrounding situation of the electric vehicle 201 and the situation of the electric vehicle 201 itself, and performs control of the electric vehicle 201.

When the electric vehicle 201 is in the autonomous driving mode, in order to allow the electric vehicle 201 to travel autonomously, the ECU 2100 determines the surrounding situation of the electric vehicle 201 and the situation of the electric vehicle 201 itself based on input information via the touch panel 206 or information obtained from the exterior vehicle camera 207 and the vehicle speed sensor 209. Then, the ECU 2100 performs an autonomous driving control process to control the accelerator, brake, and steering operations according to the determination result.

In the present embodiment, when the electric vehicle 201 is in the autonomous driving mode, torque control to simulate a manual transmission is not performed. However, the present invention is not limited thereto, and even when the electric vehicle 201 is in the autonomous driving mode, torque control to simulate a manual transmission may be performed.

Incidentally, when torque control to simulate a manual transmission is performed, the torque control amount may be more restricted than when the electric vehicle 201 is in the MT mode.

### <Regarding Functions of ECUs>

Next, the functions of the ECU 2100, the seat ECU 2120, and the door ECU 2130 will be described with reference to FIGS. 32 to 39. Functional units of each ECU are realized by the cooperation of hardware devices (specifically, the CPU and the memories) constituting each ECU with software devices (control circuits).

### <ECU>

As shown in FIG. 32, the ECU 2100 includes, as main components, the torque control unit 2101 that determines an instruction torque; the lever pedal control unit 2102 that controls the simulated shift device 204 or the simulated clutch device 205; a seating detection unit 2103 that detects an occupant; an identification information acquisition unit 2104 that acquires identification information of the occupant; a storage unit 2105 that stores various programs and various data; a mode setting unit 2106 that sets a traveling mode; a determination unit 2107 that determines restrictions on the MT mode; a mode switching unit 2108 that switches the traveling mode; and a communication unit 2109 that transmits and receives various data.

### (Torque Control Unit 2101)

The torque control unit 2101 determines an instruction torque based on the traveling mode of the electric vehicle 201, operation information of the simulated shift lever 204a, the simulated clutch pedal 205a, and an accelerator pedal (not illustrated), input information via the touch panel 206, a vehicle speed detected by the vehicle speed sensor 209, and the like. The determined instruction torque is transmitted to the motor ECU 2110 by the communication unit 2109.

### (Lever Pedal Control Unit 2102)

The lever pedal control unit 2102 controls the vibration imparting unit 204b of the simulated shift device 204 and the resistance force imparting portion 205b of the simulated clutch device 205 when the traveling mode has transitioned to the MT mode.

In detail, when a switching signal to switch the traveling mode to the MT mode is input, the lever pedal control unit 2102 notifies the driver that the simulated shift lever 204a can be operated, by controlling the vibration imparting unit 204b to impart vibration to the simulated shift lever 204a.

In addition, when a signal to change the torque characteristics in the MT mode is input, the lever pedal control unit 2102 controls the vibration imparting unit 204b to vibrate the simulated shift lever 204a based on the set instruction torque.

Further, when a signal to change the torque characteristics in the MT mode is input, the lever pedal control unit 2102 controls the resistance force imparting portion 205b to impart a resistance force to the simulated clutch pedal 205a based on the set instruction torque.

Incidentally, the resistance force of the simulated clutch pedal 205a may be settable by an occupant. For example, an occupant who prefers a stronger sense of restraint can further increase a sense of restraint by setting the amount of protrusion of the bags 264 to be larger.

In addition, the simulated shift device 204 may be configured to be provided with a resistance force imparting portion that imparts a resistance force to the simulated shift lever 204a.

In such a manner, in the MT mode, since the operational feel of the simulated shift lever 204a or the simulated clutch pedal 205a is changed, the reproducibility of the operational feel of an MT vehicle can be further increased.

### (Seating Detection Unit 2103)

When the interior vehicle camera 208 detects that an occupant (driver or passenger) is seated, the seating detection unit 2103 detects that the occupant is seated. Incidentally, the seating detection unit 2103 is not limited to detecting seating using the interior vehicle camera 208, and may detect seating using, for example, a plurality of pressure sensors disposed on the seating surface of the seat cushion 210 or the seat back 220.

In other words, the seating detection unit 2103 functions as a driver detection unit that detects an occupant (driver) and a passenger detection unit that detects a passenger other than the driver.

### (Identification Information Acquisition Unit 2104)

The identification information acquisition unit 2104 acquires identification information of an occupant (driver) seated in the driver's seat. Here, the identification information is information used to identify the seated occupant (personal authentication), and corresponds to, for example, ID information of the driver, image information showing a face image or a fingerprint image of the driver, voiceprint information of the driver, or the like.

When the seating detection unit 2103 detects that the driver is seated, the identification information acquisition unit 2104 acquires a face image of the driver using the interior vehicle camera 208. The identification information of the driver can be relatively easily obtained by capturing a face image of the driver using the interior vehicle camera 208.

In addition, the identification information acquisition unit 2104 may acquire not only the identification information of the driver seated in the driver's seat, but also identification information of a passenger.

When the seating detection unit 2103 detects that an occupant is seated, the identification information acquisition unit 2104 acquires a face image of the occupant using the interior vehicle camera 208, and when identification information (ID) of the occupant is registered in a mode management table of the storage unit 2105, which will be described later, the identification information acquisition unit 2104 reads the identification information. When the identification information of the occupant is not registered in the mode management table of the storage unit 2105, new identification information (new ID) is issued and stored in the mode management table, in association with the face image of the occupant.

Incidentally, a method for acquiring identification information is not limited to the above-described method, and the identification information acquisition unit 2104 may acquire the identification information by communicating with a smartphone carried by the occupant. In this case, when a person carrying a smartphone is seated in the vehicle seat S200, the communication unit 2109 may automatically acquire identification information of the occupant by communicating with a smartphone of the occupant.

In addition, the occupant may input the identification information through the touch panel 206, and the identification information may be acquired by receiving data related to the content of the input operation. Alternatively, the identification information may be acquired by recording the voice of the occupant using a microphone installed inside the vehicle.

### (Storage Unit 2105)

The storage unit 2105 stores various control programs for controlling the electric vehicle 201, information on shift characteristics, control information of the lever pedal control unit 2102, and the like.

In addition, when the seating detection unit 2103 detects that a passenger is seated, the storage unit 2105 stores passenger information indicating that an occupant is seated. Further, the storage unit 2105 stores the mode management table for managing the identification information of the occupant acquired by the identification information acquisition unit 2104.

The mode management table is data for managing a traveling mode set for each occupant. In detail, the mode management table defines a corresponding relationship between the identification information of the occupant acquired by the identification information acquisition unit 2104 and an initial traveling mode set by the occupant identified by the identification information.

To describe with one example, in a case where a driver with identification information “aaaa” sets the initial traveling mode to the MT mode, when it is detected that the driver with the identification information “aaaa” is seated, the MT mode is automatically applied.

The mode management table stores license-related information, for example, information on whether the occupant is permitted to drive an MT vehicle, information that the occupant holds a license limited to driving automatic transmission vehicles, or information that the occupant does not hold a driver's license, in association with the identification information of the occupant. When the occupant is not permitted to drive an MT vehicle or has restrictions on driving, restriction information regarding restrictions on driving an MT vehicle is stored.

The license-related information is stored, for example, by an input operation on the touch panel 206 by the occupant. Incidentally, information on whether the driver is permitted to drive an MT vehicle and the like may be acquired by capturing the driver's license of the driver using the interior vehicle camera 208.

### (Mode Setting Unit 2106)

When the seating detection unit 2103 detects a driver, the mode setting unit 2106 sets the initial traveling mode to one of the MT mode, the EV mode, and the autonomous driving mode, in association with the identification information of the driver.

In the present embodiment, when the identification information of the occupant acquired by the identification information acquisition unit 2104 is not stored in the storage unit 2105, the mode setting unit 2106 is configured to set an initial traveling mode, together with storing the identification information of the occupant. In other words, when the electric vehicle 201 is driven for the first time, an initial traveling mode is set, and when the electric vehicle 201 is driven the next time and onward, the preferred mode is automatically applied. For that reason, the occupant can start driving in the preferred mode without the need to input a mode each time.

Incidentally, the ECU 2100 may set the normal mode (EV mode) as an initial setting instead of setting an initial traveling mode for each occupant (identification information), and may switch the traveling mode to the MT mode or the autonomous driving mode depending on an operation by the occupant.

When the identification information of the occupant acquired by the identification information acquisition unit 2104 is not stored in the storage unit 2105, the mode setting unit 2106 accepts the setting of the initial traveling mode. In addition, in a case where the identification information of the occupant is registered in the mode management table, when the occupant changes the setting of the initial traveling mode, the mode setting unit 2106 accepts the setting of the initial traveling mode.

The occupant can initially set the initial traveling mode to one of the MT mode, the EV mode, or the autonomous driving mode by performing an input operation on the touch panel 206.

### (Determination Unit 2107)

The determination unit 2107 determines whether the occupant is restricted from switching the traveling mode to the MT mode.

A driver who does not hold a license that permits the driving of MT vehicles is restricted from setting the initial traveling mode to the MT mode and from switching the traveling mode to the MT mode when the traveling mode is switched.

In addition, when there is an occupant (passenger) other than the driver in the electric vehicle 201, the mode is restricted from being switched to the MT mode.

In detail, when the traveling mode is set by the mode switching unit 2108, the determination unit 2107 determines whether information indicating that the driver is not permitted to drive an MT vehicle (for example, information indicating that the driver holds a license limited to driving automatic transmission vehicles, or information indicating that the driver does not hold a driver's license) is stored in the mode management table of the storage unit 2105, in association with the identification information of the driver acquired by the identification information acquisition unit 2104.

Then, when information indicating that the driver is not permitted to drive an MT vehicle is stored in association with the identification information of the driver, the occupant is notified that the traveling mode cannot be switched to the MT mode, and is notified to switch the traveling mode to the EV mode or the autonomous driving mode.

In addition, when the traveling mode is set by the mode switching unit 2108, the determination unit 2107 determines whether the passenger information is stored in the storage unit 2105.

Then, when the passenger information is stored, the occupant is notified that the traveling mode cannot be switched to the MT mode, and is notified to switch the traveling mode to the EV mode or the autonomous driving mode.

Incidentally, in the present embodiment, in a case where the occupant switches the traveling mode, when the mode is restricted from being switched to the MT mode, the mode is restricted from being switched to the MT mode by not displaying a button for switching to the MT mode on the touch panel 206. However, the present invention is not limited thereto, and the button for switching to the MT mode may be displayed on the touch panel 206, and switching to the MT mode may be prevented even when the button is touched.

### (Mode Switching Unit 2108)

The mode switching unit 2108 reads an initial traveling mode, which corresponds to the identification information of the driver detected by the seating detection unit 2103, from the storage unit 2105, and switches the initial traveling mode to one of the MT mode, the EV mode, and the autonomous driving mode. In addition, the mode switching unit 2108 switches the traveling mode to one of the MT mode, the EV mode, and the autonomous driving mode depending on an input operation on the touch panel 206 by the driver. Here, the touch panel 206 functions as a switching operating unit that switches the mode.

Incidentally, the present invention is not limited to an input operation on the touch panel 206, and a mode switching button for switching the mode may be provided, and the mode may be switched in response to the pressing operation of the mode switching button. Alternatively, the mode may be switched in response to a voice input via a microphone installed inside the vehicle.

When the initial traveling mode is the MT mode, the result determined by the determination unit 2107 based on the restriction information and the passenger information indicates that the MT mode is not under restriction, and there is no switching to another mode, the mode switching unit 2108 switches the traveling mode to the MT mode.

In addition, when the initial traveling mode is the EV mode and there is no switching to another mode, the traveling mode is switched to the EV mode. When the initial traveling mode is the autonomous driving mode and there is no switching to another mode, the traveling mode is switched to the autonomous driving mode.

Incidentally, when an operation for switching to the MT mode is performed in the EV mode or the autonomous driving mode, in a case where the result determined by the determination unit 2107 based on the restriction information and the passenger information indicates that the MT mode is not under restriction, the traveling mode is switched to the MT mode.

In such a manner, the mode switching unit 2108 can switch the mode between the MT mode, the EV mode, and the autonomous driving mode.

In addition, since the initial traveling mode is set by the mode setting unit 2106, the mode switching unit 2108 can automatically switch the mode based on the mode associated with the identification information of the occupant.

Further, when a passenger is detected by the seating detection unit 2103, the mode switching unit 2108 does not accept an operation for switching to the MT mode on the touch panel 206, and when a passenger is not detected, the mode switching unit 2108 accepts an operation on the touch panel 206.

### (Communication Unit 2109)

The communication unit 2109 executes the transmission and reception of data between the ECU 2100, the rotating machine 202 (motor ECU 2110), the battery 203, the simulated shift device 204, the simulated clutch device 205, the touch panel 206, the exterior vehicle camera 207, the interior vehicle camera 208, the vehicle speed sensor 209, the vehicle seat S200 (seat ECU 2120), the vehicle door D200 (door ECU 2130) through an in-vehicle network.

For example, the communication unit 2109 communicates with various sensors, the touch panel 206, or the like, and receives signals output by the various sensors and a signal input by the occupant.

In addition, the communication unit 2109 transmits control signals to the rotating machine 202, the simulated shift device 204, and the simulated clutch device 205 based on information from the torque control unit 2101 and the lever pedal control unit 2102.

Further, the communication unit 2109 transmits control signals to the rail device 240, the reclining device 250, the seat movement device 260, the seat belt device 270, the seat notification device 280 provided in the vehicle seat S200, and the door notification device 290 provided in the vehicle door D200, based on information from the torque control unit 2101, the mode switching unit 2108, or the determination unit 2107.

### <Seat ECU>

The seat ECU 2120 controls vehicle interior components provided in the vehicle seat S200 according to the traveling mode. As shown in FIG. 32, the seat ECU 2120 includes, as main components, an acquisition unit 2121 that acquires a control signal from the ECU 2100; and a component control unit 2122 that controls the rail device 240, the reclining device 250, the seat movement device 260, the seat belt device 270, and the seat notification device 280 provided in the vehicle seat S200.

### (Acquisition Unit 2121)

The acquisition unit 2121 acquires control signals from the ECU 2100 through the in-vehicle network to control the rail drive motor 243 of the rail device 240, the rotation motor 251 of the reclining device 250, the air supply unit 265 of the seat movement device 260, the winding motor 274a of the seat belt device 270, and the sound output device 281 and the light-emitting device 282 of the seat notification device 280.

### (Component Control Unit 2122)

When the traveling mode is switched to the MT mode by the mode switching unit 2108, the component control unit 2122 controls the vehicle interior components provided in the vehicle seat S200. In detail, when the acquisition unit 2121 acquires control signals from the ECU 2100, the component control unit 2122 controls the vehicle interior components such as the rail drive motor 243, the rotation motor 251, the air supply unit 265, the winding motor 274a, the sound output device 281, and the light-emitting device 282 based on a control pattern.

In more detail, when a predetermined condition is satisfied in the MT mode by the mode switching unit 2108, the component control unit 2122 controls the amounts of movement of the vehicle interior components. Examples of the predetermined condition include when a signal to change the torque characteristics in the MT mode is input, when a signal to start the MT mode is input, when a signal to change the amount of movement based on an operation by the occupant is input, and the like.

Here, the control pattern is information that defines control parameters such as the amounts of movement of the vehicle interior components (the amount of forward and rearward movement of the seat body, the amount of rotation of the seat back 220, the amount of protrusion of the bags 264, the amount of winding of the seat belt 271), a sound output pattern of the sound output device 281, and a light-emitting pattern of the light-emitting device 282. The control patterns are stored in a control pattern table stored in a non-volatile memory of the seat ECU 2120.

Incidentally, even when the traveling mode is switched to the EV mode or the autonomous driving mode by the mode switching unit 2108, the component control unit 2122 may control the vehicle interior components provided in the vehicle seat S200. In this case, it is preferable that the control pattern to be referenced is switched depending on the mode. In other words, the amounts of movement of the vehicle interior components (for example, the amount of forward and rearward movement of the seat body, the amount of rotation of the seat back 220, the amount of protrusion of the bags 264, and the amount of winding of the seat belt 271) when the traveling mode is switched to the EV mode or the autonomous driving mode by the mode switching unit 2108 are more restricted than the amounts of movement of the vehicle interior components when the traveling mode is switched to the MT mode.

For example, in the EV mode, a control pattern in which the amounts of movement of the vehicle interior components are smaller than those in a control pattern referenced in the MT mode may be set. Further, in the autonomous driving mode, a control pattern in which the amounts of movement of the vehicle interior components are significantly smaller than those in the control pattern referenced in the MT mode may be set, and control of the vehicle interior components may be prohibited.

In such a manner, in the EV mode or the autonomous driving mode, since the amounts of movement of the vehicle interior components provided in the vehicle seat S200 are restricted, the occupant can assume a more relaxed posture compared to in the MT mode. Therefore, a sense of restraint or a sense of freedom can be imparted to the occupant depending on the mode.

Further, the component control unit 2122 may restrict control of the vehicle interior components based on the state of the battery 203. In detail, when the remaining battery charge is a predetermined value or less, the component control unit 2122 is prohibited from controlling the vehicle interior components.

For example, when the remaining battery charge is the predetermined value or less, a control pattern in which the amount of forward and rearward movement of the seat body, the amount of rotation of the seat back 220, the amount of protrusion of the bags 264, and the amount of winding of the seat belt 271 are smaller than that in a control pattern referenced when the remaining battery charge is sufficient may be set. Further, when the remaining battery charge is the predetermined value or less, and charging is required, control of the vehicle interior components is prohibited.

Incidentally, when not only the remaining battery charge, but also it is detected that the battery 203 is abnormal, control of the vehicle interior components may be restricted.

In such a manner, the electric vehicle 201 can suppress excessive consumption of electric power by restricting control of the vehicle interior components based on the state of the battery 203.

Incidentally, the electric vehicle 201 may not only control the vehicle interior components, but also restrict torque control by the torque control unit 2101 and the control of the simulated shift device 204 or the simulated clutch device 205 by the lever pedal control unit 2102, based on the state of the battery 203.

The control of the rail device 240 by the component control unit 2122 will be specifically described. When the acquisition unit 2121 acquires a switching signal to switch the traveling mode to the MT mode, the component control unit 2122 controls the rail drive motor 243 to move the seat body rearward with respect to the vehicle body floor F200, based on the control pattern.

In such a manner, when the traveling mode is switched to the MT mode, the seat body moves with respect to the vehicle body floor F200, so that a seating comfort similar to that of a sports vehicle can be imparted to the occupant. In addition, the occupant can be informed that the traveling mode has transitioned to the MT mode.

In addition, when a signal to change the torque characteristics in the MT mode is input, the component control unit 2122 controls the rail drive motor 243 to move the seat body with respect to the vehicle body floor F200, based on the set instruction torque. In such a manner, when the traveling mode is switched to the MT mode, the seat body moves with respect to the vehicle body floor F200 based on the torque, so that the sensation of driving an MT vehicle can be imparted to the occupant.

The control of the reclining device 250 by the component control unit 2122 will be specifically described. When the acquisition unit 2121 acquires a switching signal to switch the traveling mode to the MT mode, the component control unit 2122 controls the rotation motor 251 to tilt the seat back 220 rearward with respect to the seat cushion 210, based on the control pattern.

In such a manner, when the traveling mode is switched to the MT mode, the seat back 220 moves with respect to the seat cushion 210, so that a seating comfort similar to that of a sports vehicle can be imparted to the occupant. In addition, the occupant can be informed that the traveling mode has transitioned to the MT mode.

In addition, when a signal to change the torque characteristics in the MT mode is input, the component control unit 2122 controls the rotation motor 251 to move the seat body with respect to the vehicle body floor F200, based on the set instruction torque. In such a manner, when the traveling mode is switched to the MT mode, the seat back 220 moves with respect to the seat cushion 210 based on the torque, so that the sensation of driving an MT vehicle can be imparted to the occupant.

The control of the seat movement device 260 by the component control unit 2122 will be specifically described. When the acquisition unit 2121 acquires a switching signal to switch the traveling mode to the MT mode, the component control unit 2122 controls the air supply unit 265 to adjust the movement range (amount of movement) of the bags 264, based on the control pattern.

In detail, when a switching signal to switch the traveling mode to the MT mode is acquired, the bags 264 in a folded state are bulged and deployed toward the front of the seat by receiving a supply of compressed air from the air supply unit 265.

Incidentally, the component control unit 2122 may control not only the seat movement device 260 provided in the driver's seat, but also the seat movement device 260 of the vehicle seat S200 other than the driver's seat.

In such a manner, when the traveling mode is switched to the MT mode, the bags 264 are bulged and deployed toward the front of the seat, so that a seating comfort similar to that of a sports vehicle can be imparted to the occupant. In addition, the sense of holding is increased, so that safety can be improved. In addition, the occupant can be informed that the traveling mode has transitioned to the MT mode.

In addition, when a signal to change the torque characteristics in the MT mode is input, the component control unit 2122 controls the air supply unit 265 to adjust the movement range (amount of protrusion) of the bags 264, based on the set instruction torque.

In detail, the component control unit 2122 may change the amount of protrusion of the bags 264 depending on the speed of the vehicle body B200 detected by the vehicle speed sensor 209 or road situations (for example, map information obtained from a car navigation system or information determined from an image detected by the exterior vehicle camera 207).

In more detail, the component control unit 2122 performs control to increase the amount of protrusion of the bags 264 and intensify tightening each time the speed reaches a certain threshold value (for example, 60 km, 80 km, 100 km, or the like). In addition, the component control unit 2122 performs control to increase the amount of protrusion of the bags 264 and intensify tightening as consecutive curves approach.

In addition, the component control unit 2122 may perform control to change the amount of protrusion of the bags 264 depending on the selected shift position of the simulated shift lever 204a. For example, the amount of protrusion is set to be small in the case of the first gear, or the amount of protrusion is set to be large in the case of the fifth gear.

Further, the amount of protrusion of the bags 264 may be settable by the occupant. For example, an occupant who prefers a stronger sense of restraint can further increase a sense of restraint by setting the amount of protrusion of the bags 264 to be larger.

In such a manner, when the traveling mode is switched to the MT mode, the amount of protrusion of the bags 264 is adjusted based on the torque, so that the sensation of driving an MT vehicle can be imparted to the occupant.

Incidentally, the component control unit 2122 may check with the occupant via a monitor of the touch panel 206 or by voice whether to move the bags 264, and may control the air supply unit 265 only when the occupant gives permission.

In addition, the component control unit 2122 may prohibit the movement of the bags 264 using the touch panel 206, a switch provided in the vehicle seat S200 or the vehicle door D200, or the like.

In such a manner, the component control unit 2122 can control the seat movement device 260 according to a preference of the occupant.

The control of the seat belt device 270 by the component control unit 2122 will be specifically described. When the acquisition unit 2121 acquires a switching signal to switch the traveling mode to the MT mode, the component control unit 2122 controls the winding motor 274a to increase the amount of winding of the seat belt 271 and tighten the occupant, based on the control pattern.

In such a manner, when the traveling mode is switched to the MT mode, a sense of restraint of the upper body of the seated occupant is adjusted, so that a seating comfort similar to that of a sports vehicle can be imparted to the occupant. In addition, the occupant can be informed that the traveling mode has transitioned to the MT mode.

In addition, when a signal to change the torque characteristics in the MT mode is input, the component control unit 2122 controls the winding motor 274a to adjust a sense of restraint of the upper body of the seated occupant, based on the set instruction torque. In such a manner, when the traveling mode is switched to the MT mode, a sense of restraint of the upper body of the seated occupant is adjusted, so that the sensation of driving an MT vehicle can be imparted to the occupant.

The control of the seat notification device 280 by the component control unit 2122 will be specifically described. When the acquisition unit 2121 acquires a switching signal to switch the traveling mode to the MT mode, the component control unit 2122 controls the sound output device 281 and the light-emitting device 282 to notify the occupant that the traveling mode has transitioned to the MT mode, based on the control pattern.

In such a manner, when the traveling mode is switched to the MT mode, the occupant is notified of the current mode by voice or the emission of light, so that the occupant can be appropriately informed that the mode is switched.

In addition, when a signal to change the torque characteristics in the MT mode is input, the component control unit 2122 controls the sound output device 281 and the light-emitting device 282. The component control unit 2122 causes the sound output device 281 to output a sound that imitates an engine sound, based on the control pattern. The volume or pitch of the output sound changes according to the instruction torque, the operation of the simulated shift lever 204a, or the like. In addition, the component control unit 2122 causes the LEDs of the light-emitting device 282 to change from blue to red or to blink.

In such a manner, the reproducibility of the operational feel of an MT vehicle can be further increased.

### <Door ECU>

As shown in FIG. 32, the door ECU 2130 includes, as main components, a door acquisition unit 2131 that acquires a control signal from the ECU 2100, and a door component control unit 2132 that controls the door notification device 290 provided in the vehicle door D200.

### (Door Acquisition Unit 2131)

The door acquisition unit 2131 acquires a control signal from the ECU 2100 through the in-vehicle network to control a door sound output device 291 and a door light-emitting device 292 of the door notification device 290.

### (Door Component Control Unit 2132)

When the traveling mode is switched to the MT mode by the mode switching unit 2108, the door component control unit 2132 controls vehicle interior components provided in the vehicle door D200. In detail, when the door acquisition unit 2131 acquires a control signal from the ECU 2100, the door component control unit 2132 controls the vehicle interior components such as the door sound output device 291 and the door light-emitting device 292 based on the control pattern.

The control of the door notification device 290 by the door component control unit 2132 will be specifically described. When the door acquisition unit 2131 acquires a switching signal to switch the traveling mode to the MT mode, the door component control unit 2132 controls the door sound output device 291 and the door light-emitting device 292 to notify the occupant that the traveling mode is to be switched to the MT mode, based on the control pattern.

In such a manner, when the traveling mode is switched to the MT mode, the occupant is notified of the current mode by voice or the emission of light, so that the occupant can be appropriately informed that the mode is switched.

In addition, when a signal to change the torque characteristics in the MT mode is input, the door component control unit 2132 controls the door sound output device 291 and the door light-emitting device 292 based on the control pattern. The component control unit 2122 causes the sound output device 281 to output a sound that imitates an engine sound. The volume or pitch of the output sound changes according to the instruction torque, the operation of the simulated shift lever 204a, or the like. In addition, the component control unit 2122 causes the LEDs of the light-emitting device 282 to change from blue to red or to blink.

In such a manner, the reproducibility of the operational feel of an MT vehicle can be further increased.

### <Regarding Mode Switching Process>

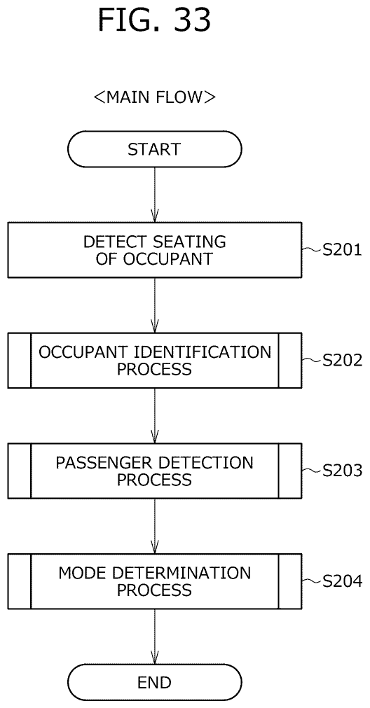

Next, the flow of a mode switching process executed by the ECU 2100 will be described. The mode switching process is executed to switch the traveling mode of the electric vehicle 201 when an occupant is seated in the driver's seat as shown in FIG. 33. Specifically, when it is detected that the occupant is seated in the driver's seat (step S201), the ECU 2100 executes an occupant identification process (step S202), a passenger detection process (step S203), and a mode determination process (step S204).

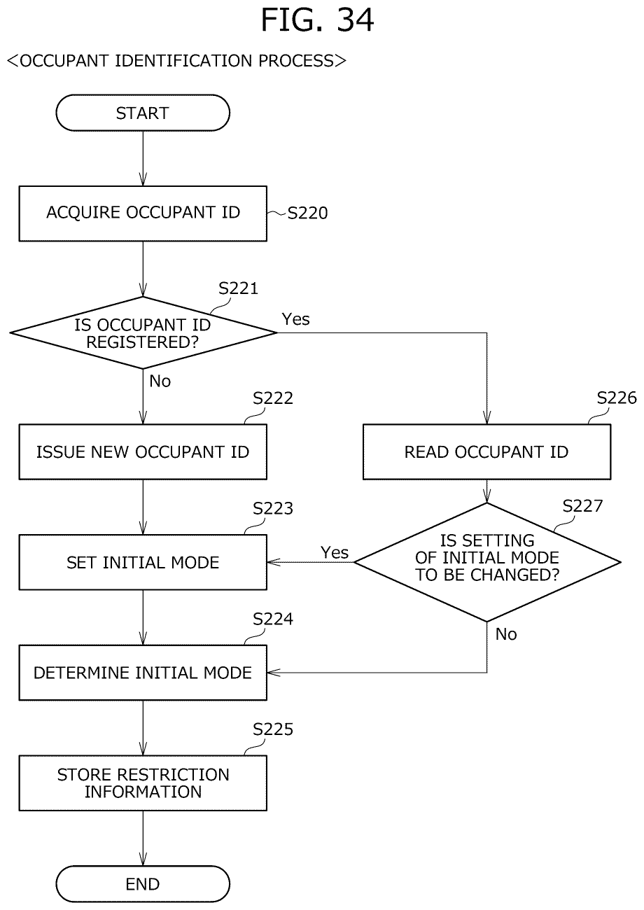

The occupant identification process (step S202) executed by the ECU 2100 when an occupant is seated in the driver's seat will be described with reference to FIG. 34.

When it is detected that the occupant is seated in the driver's seat, the ECU 2100 captures a face image of the occupant seated in the driver's seat using the interior vehicle camera 208, and acquires identification information of the driver (step S220). Then, it is determined whether the identification information of the driver is registered in the mode management table of the storage unit 2105 (step S221). When it is determined that the identification information is not registered (step S221: No), the ECU 2100 issues new identification information (new ID) (step S222). In this case, the ECU 2100 prompts the driver to input information regarding the driver's license. When the new ID is issued, the setting of the initial traveling mode by the occupant is accepted (step S223). Then, the initial traveling mode set by the occupant is determined (step S224). Then, the ECU 2100 stores the identification information of the driver, the determined initial traveling mode, and restriction information that restricts driving of MT vehicles in the mode management table, in association with each other (step S225).

On the other hand, when it is determined that the identification information of the driver is registered in the mode management table of the storage unit 2105 (step S221: Yes), the ECU 2100 reads the identification information (ID) (step S226). In this case, when there is a change in information regarding the driver's license, the driver is prompted to update the restriction information.

Then, it is determined whether the driver changes the setting of the initial traveling mode (step S227). When it is determined that the setting of the initial traveling mode is to be changed (step S227: Yes), the process proceeds to step S223. On the other hand, when it is determined that the setting of the initial traveling mode is not to be changed (step S227: No), the process proceeds to step S224.

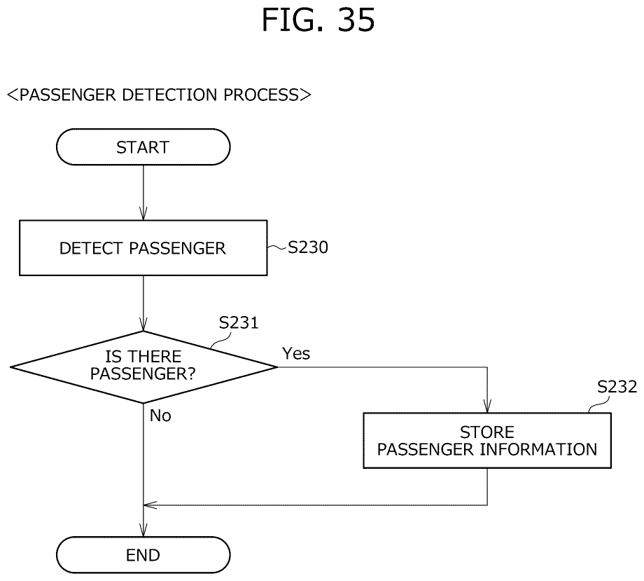

The passenger detection process (step S203) executed by the ECU 2100 after the occupant identification process (step S202) will be described with reference to FIG. 35.

The ECU 2100 captures an image of the vehicle interior using the interior vehicle camera 208, and checks whether there is an occupant seated in a seat other than the driver's seat (step S230). Then, it is determined whether a passenger is detected by the interior vehicle camera 208 (step S231). When it is determined that the passenger is not detected (step S231: No), the ECU 2100 ends the passenger detection process.

On the other hand, when it is determined that the passenger is detected (step S231: Yes), the ECU 2100 stores passenger information in the storage unit 2105 (step S232), and ends the passenger detection process.

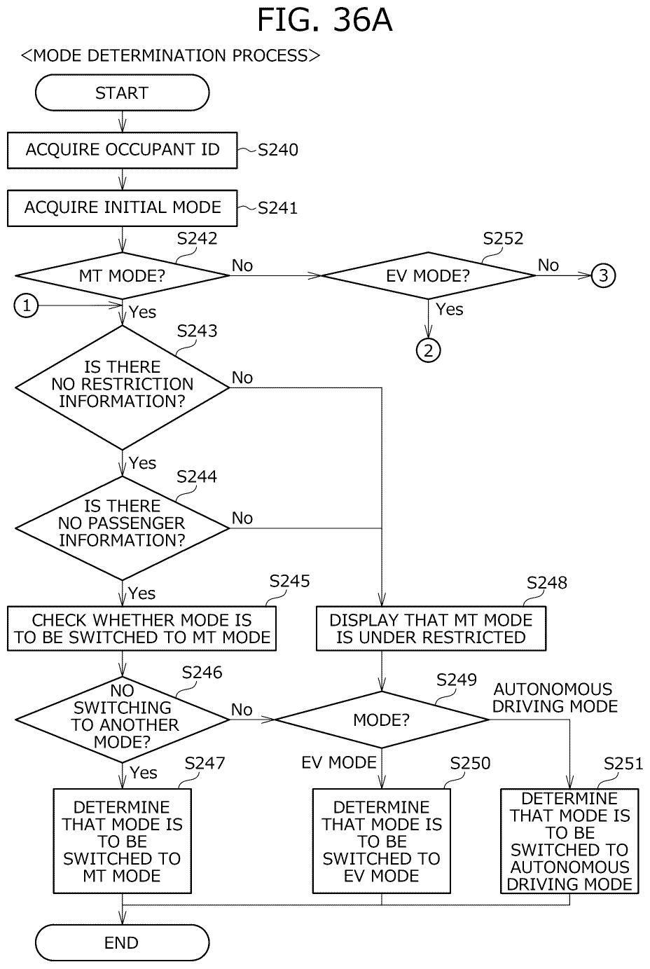

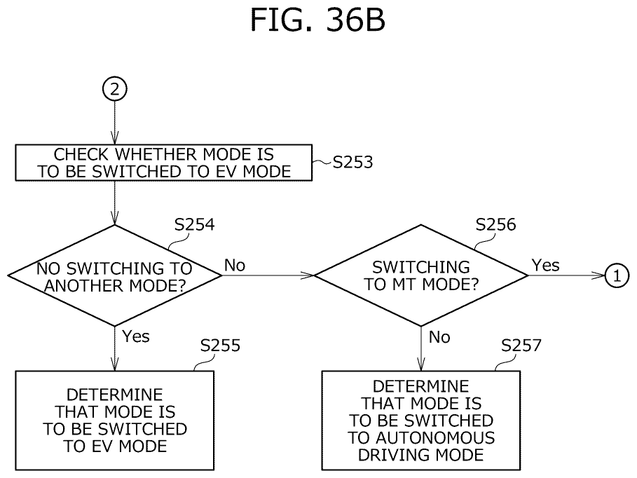

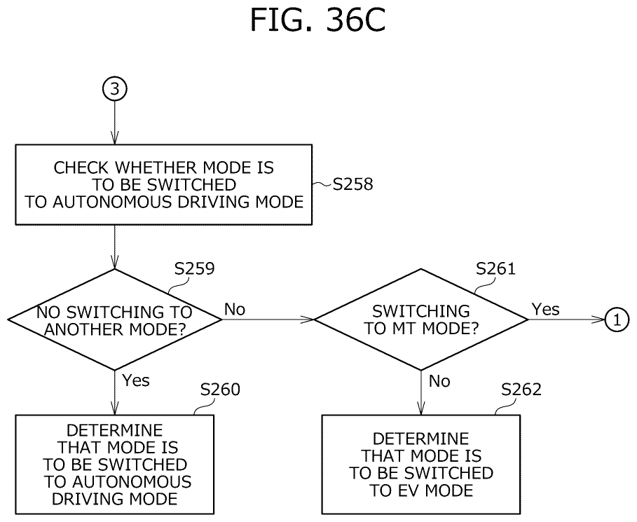

The mode determination process (step S204) executed by the ECU 2100 after the passenger detection process (step S203) will be described with reference to FIGS. 36A to 36C. Incidentally, a mode determined in the mode determination process is transmitted to the seat ECU 2120 and the door ECU 2130 by the communication unit 2109.

The ECU 2100 acquires the identification information of the driver detected by the identification information acquisition unit 2104 (step S240). Then, the ECU 2100 acquires an initial traveling mode corresponding to the identification information of the driver from the mode management table of the storage unit 2105 (step S241). Then, the ECU 2100 determines whether the initial traveling mode is the MT mode (step S242).

As shown in FIG. 36A, when it is determined that the initial traveling mode is the MT mode (step S242: Yes), the ECU 2100 determines the presence or absence of the restriction information (step S243). When it is determined that there is no restriction information (step S243: Yes), the ECU 2100 determines the presence or absence of the passenger information (step S244). When it is determined that there is no passenger information (step S244: Yes), the ECU 2100 checks with the occupant whether to determine to switch the traveling mode to the MT mode (step S245). Specifically, the ECU 2100 displays that the traveling mode is to be switched to the MT mode, on the touch panel 206, and when the traveling mode is to be switched to another mode, the ECU 2100 displays a message to prompt the occupant to perform a switching operation using the touch panel 206 (switching operating unit) within a predetermined time. Then, the ECU 2100 determines whether an operation for switching to another mode is performed (step S246). When it is determined that an operation for switching to another mode is not performed (step S246: Yes), the ECU 2100 determines that the traveling mode is to be switched to the MT mode (step S247), and ends the mode determination process.

On the other hand, when it is determined in step S243 that there is the restriction information (step S243: No), or when it is determined in step S244 that there is the passenger information (step S244: No), the ECU 2100 displays that switching to the MT mode is under restriction (step S248). Specifically, the ECU 2100 displays that switching to the MT mode is under restriction, on the touch panel 206, and the ECU 2100 displays a message to prompt the occupant to perform a switching operation using the touch panel 206 (switching operating unit) to switch the traveling mode to another mode. Then, the ECU 2100 determines the mode to which the traveling mode is switched (step S249). When the traveling mode is to be switched to the EV mode (step S249: EV mode), the ECU 2100 determines that the traveling mode is to be switched to the EV mode (step S250), and ends the mode determination process. When the traveling mode is to be switched to the autonomous driving mode (step S249: autonomous driving mode), the ECU 2100 determines that the traveling mode is to be switched to the autonomous driving mode (step S251), and ends the mode determination process.

In addition, as shown in FIG. 36A, when it is determined in step S242 that the initial traveling mode is not the MT mode (step S242: No), it is determined whether the initial traveling mode is the EV mode (step S252).

When it is determined that the initial traveling mode is the EV mode (step S252: Yes), as shown in FIG. 36B, the ECU 2100 checks with the occupant whether to determine to switch the traveling mode to the EV mode (step S253). Specifically, the ECU 2100 displays that the traveling mode is to be switched to the EV mode, on the touch panel 206, and when the traveling mode is to be switched to another mode, the ECU 2100 displays a message to prompt the occupant to perform a switching operation using the touch panel 206 (switching operating unit) within a predetermined time. Then, the ECU 2100 determines whether an operation for switching to another mode is performed (step S254). When it is determined that an operation for switching to another mode is not performed (step S254: Yes), the ECU 2100 determines that the traveling mode is to be switched to the EV mode (step S255), and ends the mode determination process.

When it is determined in step S254 that an operation for switching to another mode is performed (step S254: No), the ECU 2100 determines whether an operation for switching to the MT mode is performed (step S256). When it is determined that an operation for switching to the MT mode is not performed (step S256: No), the ECU 2100 determines that the traveling mode is to be switched to the autonomous driving mode (step S257), and ends the mode determination process. When it is determined that an operation for switching to the MT mode is performed (step S256: Yes), the ECU 2100 proceeds to step S243 in FIG. 36A.

In addition, as shown in FIG. 36A, when it is determined in step S252 that the initial traveling mode is not the EV mode (step S252: No), as shown in FIG. 36C, the ECU 2100 checks with the occupant whether to determine to switch the traveling mode to the autonomous driving mode (step S258). Specifically, the ECU 2100 displays that the traveling mode is to be switched to the autonomous driving mode, on the touch panel 206, and when the traveling mode is to be switched to another mode, the ECU 2100 displays a message to prompt the occupant to perform a switching operation using the touch panel 206 (switching operating unit) within a predetermined time. Then, the ECU 2100 determines whether an operation for switching to another mode is performed (step S259). When it is determined in step S259 that an operation for switching to another mode is not performed (step S259: Yes), the ECU 2100 determines that the traveling mode is to be switched to the autonomous driving mode (step S260), and ends the mode determination process.

When it is determined in step S259 that an operation for switching to another mode is performed (step S259: No), the ECU 2100 determines whether an operation for switching to the MT mode is performed (step S261). When it is determined that an operation for switching to the MT mode is not performed (step S261: No), the ECU 2100 determines that the traveling mode is to be switched to the EV mode (step S262), and ends the mode determination process. When it is determined that an operation for switching to the MT mode is performed (step S261: Yes), the ECU 2100 proceeds to step S243 in FIG. 36A.

### <Regarding Mode Acquisition Process>

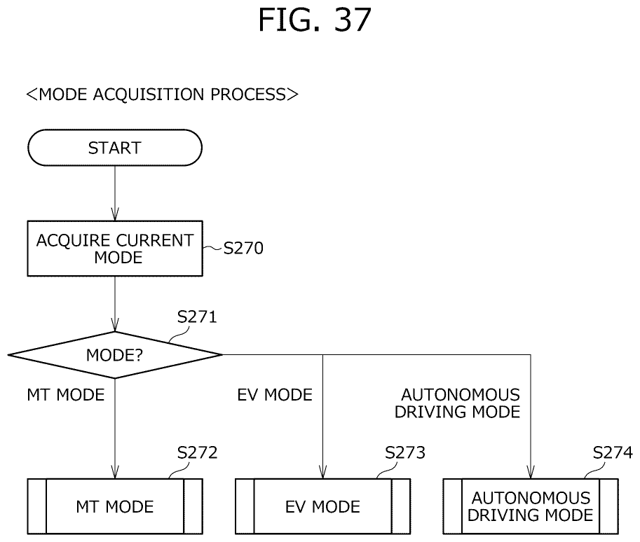

Next, the flow of a mode acquisition process executed by the seat ECU 2120 will be described with reference to FIG. 37. The mode acquisition process is executed to acquire whether the current traveling mode is the MT mode, the EV mode, or the autonomous driving mode.

Incidentally, the door ECU 2130 also executes the similar process; however, since the process is similar to that of the seat ECU 2120, a description thereof will be omitted.

When the seat ECU 2120 receives a mode switching signal from the ECU 2100, the seat ECU 2120 acquires information on whether the determined mode is the MT mode, the EV mode, or the autonomous driving mode (step S270). Then, the seat ECU 2120 determines whether the acquired mode is the MT mode, the EV mode, or the autonomous driving mode (step S271).

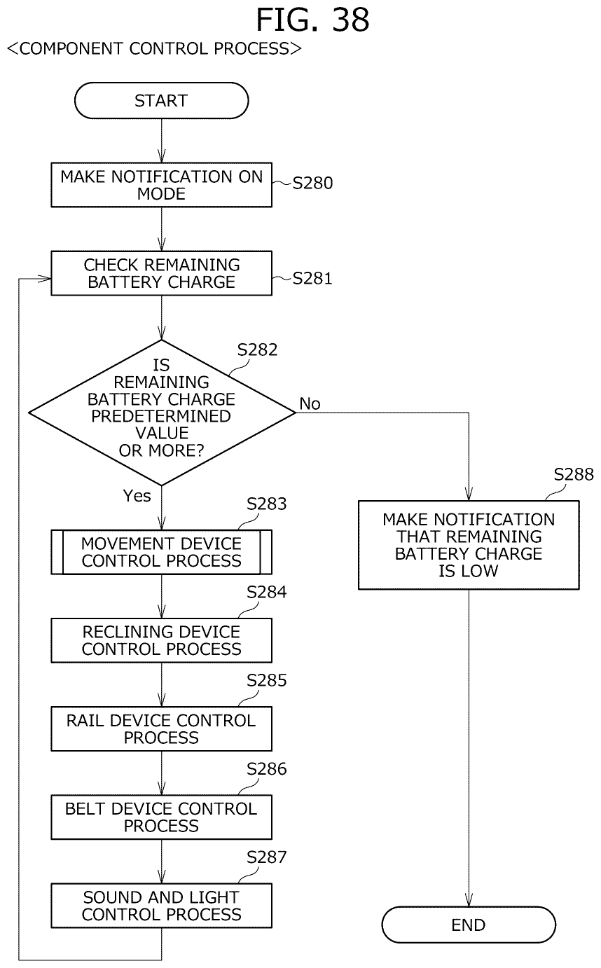

When it is determined that the acquired mode is the MT mode (step S271: MT mode), a component control flow shown in FIG. 38 is executed (step S272).

### <Regarding Component Control Process>

Next, the flow of the component control process executed by the seat ECU 2120 will be described. As shown in FIG. 38, the component control process is executed to notify the switched mode and to control the vehicle interior components according to the mode.

Incidentally, the door ECU 2130 also executes the similar process; however, since the process is similar to that of the seat ECU 2120, a description thereof will be omitted.

After the mode acquisition process, the seat ECU 2120 notifies the occupant that the acquired mode is the MT mode (step S280). Specifically, the seat ECU 2120 controls the rail drive motor 243 to move the seat body rearward with respect to the vehicle body floor F200. In addition, the seat ECU 2120 controls the rotation motor 251 to tilt the seat back 220 rearward with respect to the seat cushion 210. Further, the seat ECU 2120 controls the air supply unit 265 to bulge and deploy the bags 264 in a folded state toward the front of the seat. In addition, the seat ECU 2120 controls the winding motor 274a to increase the amount of winding of the seat belt 271 and tighten the occupant. In addition, the seat ECU 2120 controls the sound output device 281 and the light-emitting device 282 to notify the occupant that the traveling mode has transitioned to the MT mode.

In such a manner, when the traveling mode is switched to the MT mode, the vehicle seat S200 and a part of the vehicle seat S200 are moved, so that a seating comfort similar to that of a sports vehicle can be imparted to the occupant. In addition, since a notification is made by sound and the emission of light, the occupant can be appropriately informed that the traveling mode is switched to the MT mode.

After it is notified that the acquired mode is the MT mode, the seat ECU 2120 checks a remaining battery charge (step S281). Then, it is determined whether the remaining battery charge is a predetermined value or more (step S282). When it is determined that the remaining battery charge is the predetermined value or more (step S282: Yes), the seat ECU 2120 executes control of the vehicle interior components provided in the vehicle seat S200. Specifically, the seat ECU 2120 executes a movement device control process (step S283), a reclining device control process (step S284), a rail device control process (step S285), a belt device control process (step S286), and sound and light control (step S287). After step S287 is ended, the process returns to step S281, and the control process for the vehicle interior components is repeatedly executed.

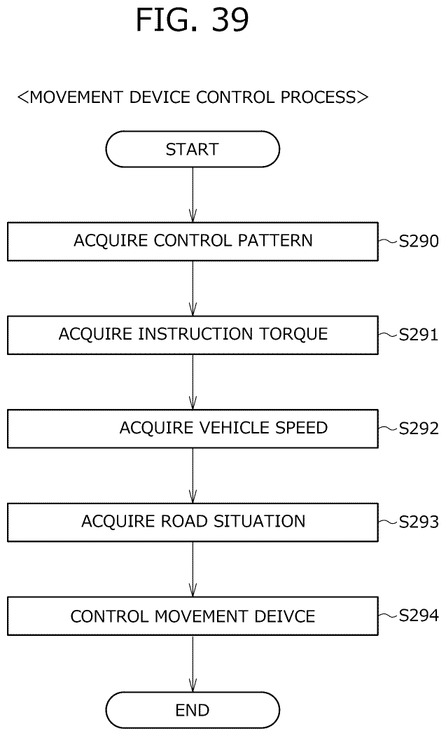

Incidentally, regarding the control of the vehicle interior components, the movement device control process shown in FIG. 39 will be representatively described. Since the reclining device control process, the rail device control process, the belt device control process, and the sound and light control process have the same flow as the movement device control process, descriptions thereof will be omitted. In addition, the control process for the vehicle interior components in steps S283 to S287 is not limited to the order.

On the other hand, when it is determined in step S282 that the remaining battery charge is not the predetermined value or more (step S282: No), the seat ECU 2120 notifies the occupant that the remaining battery charge is low (step S288). Specifically, the seat ECU 2120 displays that the vehicle interior components cannot be controlled since the remaining battery charge is low, on the touch panel 206 via the ECU 2100. In addition, the seat ECU 2120 may display a message to prompt charging on the touch panel 206. In addition, the means for notifying the occupant that the remaining battery charge is low is not limited to displaying a message on the touch panel 206, and a notification may be made by voice.

Incidentally, in the present embodiment, the seat ECU 2120 displays that the vehicle interior components cannot be controlled since the remaining battery charge is low, on the touch panel 206 via the ECU 2100; however, the present invention is not limited thereto, and the seat ECU 2120 may control the display on the touch panel 206.

In addition, in the present embodiment, the seat ECU 2120 is configured to check the remaining battery charge and determine whether the remaining battery charge is the predetermined value or more. However, the present invention is not limited thereto, and the ECU 2100 may be configured to check the remaining battery charge and determine whether the remaining battery charge is the predetermined value or more.

### <Regarding Movement Device Control Process>

Next, the flow of the movement device control process executed by the seat ECU 2120 will be described. As shown in FIG. 39, the movement device control process is executed to control the seat movement device 260.

The seat ECU 2120 acquires the amount of movement of the bags 264 set by the control pattern in the MT mode (step S290). Incidentally, the amount of movement of the bags 264 may be configured to be set by the occupant. Subsequently, the seat ECU 2120 acquires the instruction torque set in the ECU 2100 (step S291). Then, the seat ECU 2120 acquires the vehicle speed detected by the vehicle speed sensor 209 from the ECU 2100 (step S292). Further, the seat ECU 2120 acquires road situations, which are detected by the exterior vehicle camera 207 or the car navigation system, from the ECU 2100 (step S293). Then, the seat ECU 2120 controls the air supply unit 265 to adjust the amount of movement of the bags 264 that are bulged and deployed, according to the set value according to the control pattern, the acquired instruction torque, the speed of the vehicle body B200, and the road situations (step S294), and ends the movement device control process.

Incidentally, in step S271 of the mode acquisition process shown in FIG. 37, when it is determined that the acquired mode is the EV mode (step S271: EV mode), similarly to the component control process in the MT mode shown in FIG. 38, the control of the vehicle interior components is executed (step S273). As described above, in the EV mode, the seat ECU 2120 performs control of the vehicle interior components based on the control pattern in which the amounts of drive of the vehicle interior components are smaller than those in the control pattern referenced in the MT mode.

In addition, when it is determined in step S271 that the acquired mode is the autonomous driving mode (step S271: autonomous driving mode), only the notification of the mode is executed in the component control process shown in FIG. 38 (step S280). In the present embodiment, in the autonomous driving mode, control of the vehicle interior components is not performed; however, similarly to the MT mode or the EV mode, control of the vehicle interior components may be performed.

With the above-described configuration, when the traveling mode is switched to the MT mode by the mode switching unit 2108, the seat ECU 2120 and the door ECU 2130 can control the vehicle interior components provided in the vehicle seat S200 and the vehicle door D200. In detail, when the traveling mode is switched to the MT mode and the MT mode is started (when a switching signal to switch to the traveling mode to the MT mode is acquired), and when the instruction torque is changed in the MT mode (when a signal to change the torque characteristics in the MT mode is input), the seat ECU 2120 and the door ECU 2130 can improve comfort and entertainment of the occupant in the MT mode by controlling the vehicle interior components such as the rail device 240, the reclining device 250, the seat movement device 260, the seat belt device 270, the seat notification device 280, and the door notification device 290.

In the above-described embodiment, the electric vehicle and the vehicle seat used in the electric vehicle have been described as a specific example; however, the present invention is not particularly limited thereto, and can be used for various seats such as office chairs for work, wheelchairs, and child chairs in shopping carts, in addition to two-wheeled seats for two-wheeled vehicles, vehicle seats for trains, buses, or the like, and conveyance seats for airplanes, ships, or the like.

In the present embodiment, the electric vehicle according to the present invention has been mainly described. However, the embodiment is merely one example for easy understanding of the present invention, and does not limit the present invention. The present invention can be modified and improved without departing from the concept of the present invention, and it goes without saying that the present invention includes its equivalents.

Supplementary notes regarding the second embodiment and the third embodiment will be provided as follows.

### Supplementary Note 1

A conveyance seat assembly, comprising:
a seat in which an occupant is seated;
a battery disposed below the seat; and
a battery support member, that supports the battery, between the seat and the battery,
wherein a recess is formed on a lower surface of the seat, which faces the battery, and
at least a part of the battery support member is inserted into the recess.

### Supplementary Note 2

The conveyance seat assembly according to Supplementary Note 1,
wherein the battery support member is provided to extend in a seat front to rear direction and a seat width direction, and
the recess formed on the lower surface of the seat is formed along a direction in which the battery support member extends.

### Supplementary Note 3

The conveyance seat assembly according to Supplementary Note 2,
wherein a seat movement mechanism that changes a position of the seat is provided on the lower surface of the seat, and
the seat movement mechanism is disposed at a position where the seat movement mechanism avoids the recess formed in the seat.

### Supplementary Note 4

The conveyance seat assembly according to Supplementary Note 2,
wherein a plurality of seat movement mechanisms that change a position of the seat are provided on the lower surface of the seat, and
the plurality of the seat movement mechanisms are disposed along the direction in which the recess extends.

### Supplementary Note 5

The conveyance seat assembly according to Supplementary Note 4,
wherein the plurality of seat movement mechanisms are disposed at bilaterally symmetrical positions on the lower surface of the seat.

### Supplementary Note 6

The conveyance seat assembly according to Supplementary Note 3,
wherein the seat movement mechanism is an air cell that is inflated and deflated by supplying and discharging air.

### Supplementary Note 7

The conveyance seat assembly according to Supplementary Note 6,
wherein a plurality of the air cells are provided, and
the plurality of air cells are disposed at bilaterally symmetrical positions on the lower surface of the seat.

### Supplementary Note 8

The conveyance seat assembly according to Supplementary Note 1,
wherein the recess is formed at a center of the lower surface of the seat in a seat width direction.

### Supplementary Note 9

The conveyance seat assembly according to Supplementary Note 2,
wherein a length of the recess in a longitudinal direction is longer than a length of the battery support member in the longitudinal direction.

### Supplementary Note 10

The conveyance seat assembly according to Supplementary Note 2,
wherein a length of the recess in a lateral direction is longer than a length of the battery support member in the lateral direction.

### Supplementary Note 11

An electric vehicle, comprising:
a rotating machine that transmits torque to wheels;
a vehicle interior component provided in a vehicle seat or a vehicle door;
a control unit that controls the rotating machine; and
a component control unit that controls the vehicle interior component, the electric vehicle not comprising an engine and a transmission and a clutch mechanism connected to the engine,
wherein the control unit includes a mode switching unit that switches a mode between a manual mode in which the rotating machine is controlled to simulate a manual transmission in response to an operation by the occupant and a normal mode in which the rotating machine is controlled differently from the manual mode, and
when the mode is switched to the manual mode by the mode switching unit, the component control unit controls the vehicle interior component.

### Supplementary Note 12

The electric vehicle according to Supplementary Note 11,
wherein the vehicle interior component includes a movable body that is attached inside of the vehicle seat, and that operates to protrude a part of the vehicle seat toward a seated occupant side from a normal position, and
when the mode is switched to the manual mode by the mode switching unit, the component control unit controls the movable body.

### Supplementary Note 13

The electric vehicle according to Supplementary Note 12,
wherein when a predetermined condition is satisfied in the manual mode, the component control unit changes an amount of protrusion of the movable body.

### Supplementary Note 14

The electric vehicle according to Supplementary Note 11,
wherein the vehicle interior component is a seat belt device provided in the vehicle seat,
the seat belt device includes a seat belt that restrains the occupant, and a belt retractor that extractably winds the seat belt, and
when the mode is switched to the manual mode by the mode switching unit, the component control unit controls the belt retractor.

### Supplementary Note 15

The electric vehicle according to Supplementary Note 11,
wherein the vehicle seat includes a seat body including a seat cushion and a seat back, and a rail device that supports the seat body so as to be movable forward and rearward with respect to a vehicle body floor or a reclining device that rotatably connects the seat back to the seat cushion, and
when the mode is switched to the manual mode by the mode switching unit, the component control unit controls the rail device or the reclining device.

### Supplementary Note 16

The electric vehicle according to Supplementary Note 15,
wherein the mode switching unit is switchable between the manual mode, the normal mode, and an autonomous driving mode in which the electric vehicle is capable of autonomous driving, and
an amount of movement of the seat body or the seat back when the mode is switched to the autonomous driving mode by the mode switching unit is more restricted than an amount of movement of the seat body or the seat back when the mode is switched to the manual mode.

### Supplementary Note 17

The electric vehicle according to Supplementary Note 11,
wherein the control unit includes an identification information acquisition unit that acquires identification information of the occupant, a mode setting unit that sets the mode in response to an operation by the occupant, and a storage unit that stores the mode set by the mode setting unit, in association with the identification information of the occupant, and
the mode switching unit switches the mode based on the mode associated with the identification information of the occupant.

### Supplementary Note 18

The electric vehicle according to Supplementary Note 17,
wherein the storage unit stores restriction information that restricts the occupant from driving a manual transmission vehicle, in association with the identification information of the occupant, and
when the restriction information is stored in the storage unit, the mode switching unit restricts the mode from being switched to the manual mode.

### Supplementary Note 19

The electric vehicle according to Supplementary Note 11,
wherein the electric vehicle includes a passenger detection unit that detects a passenger different from the occupant, and
when the passenger is detected by the passenger detection unit, the mode switching unit restricts the mode from being switched to the manual mode.

### Supplementary Note 20

A vehicle seat that is mounted in an electric vehicle including a rotating machine that transmits torque to wheels, and not including an engine and a transmission and a clutch mechanism connected to the engine, the vehicle seat, comprising:
a seat body;
a vehicle interior component provided in the seat body;
a component control unit that controls the vehicle interior component; and
an acquisition unit that acquires a switching signal to switch between a manual mode in which the rotating machine is controlled to simulate a manual transmission in response to an operation by an occupant and a normal mode in which the rotating machine is not controlled to simulate the manual transmission,
wherein the switching signal is acquired by the acquisition unit, the component control unit controls the vehicle interior component.

### REFERENCE SIGNS LIST

### First Embodiment

V: vehicle
S, S′: conveyance seat (interior member)
S1: front seat (interior member)
S2: middle seat (interior member)
S3: rear seat (interior member)
Sh: seat body
DR: vehicle door (interior member)
F: seat frame
SW: steering wheel
IP: instrument panel
R1, R2: range
M: interior member
G: gap
100: acoustic system
1, 1′: seat back
2: seat cushion
3: headrest
4: ottoman
6: reclining device
   6a: angle sensor
7: slide device
   7a: position sensor
8: seat rotating device
   8a: rotation angle sensor
10: seat back frame
11: back side frame
12: upper frame
13: lower frame
14: headrest holder
15: seat back movable portion
   15a: actuator
20: seat cushion frame
21: cushion side frame
22: pan frame
23: front connecting frame
24: rear connecting frame
25: seat cushion movable portion
   25a: actuator
30: headrest pillar
   30a: upper portion
   30b: upper pillar portion
   30c: lower pillar portion
   30d: bent portion
31: headrest frame
   31a: front cover
   31b: rear cover
   31c: connecting member
   31d: connector
   31e: recess
32: cover fixing portion
   32a, 321a, 322a: upper fixing portion
   32b: lower fixing portion
33: headrest movable portion
35: ottoman frame
36: ottoman movable portion
   36a: actuator
40: speaker
41: back speaker
42: cushion speaker
43: headrest speaker
44: ottoman speaker
45: door speaker
50: damper
51: back damper
52: cushion damper
53: headrest damper
54: ottoman damper
55: body casing
   55a: storage portion
   55b: lid portion
56: damper attachment portion
   56a, 561a, 562a: upper attachment portion
   56b: side attachment portion
57: weight
60: state detection unit
61: seating detection unit
62: brain wave detection unit
63: wakefulness detection unit
64: interior vehicle camera
65: infrared camera
66: door sensor
67: microphone
70: ECU
71: CPU
72: ROM
73: RAM
74: HDD
75: communication interface
80: storage unit
81: state determination unit
82: acoustic control unit

### Second Embodiment

B: vehicle body (conveyance)
101, 1101, 1201, 1301: conveyance seat assembly
110, 1110, 1210, 1310: conveyance seat (seat)
111, 1111, 1211, 1311: bottom plate
113: skin material
   113a: front surface-side skin material
   113b: back surface-side skin material
114: first recess
115: second recess
116: engaging pawl
120: battery
121, 1121: battery support member
122: battery accommodation portion
130: air cell (seat movement mechanism)

### Third Embodiment

S200: vehicle seat
D200: vehicle door
B200: vehicle body
F200: vehicle body floor
P200: power supply
201: electric vehicle
202: rotating machine
   202a: traveling motor
203: battery
204: simulated shift device
   204a: simulated shift lever
   204b: vibration imparting unit
   204c: shift lever sensor
205: simulated clutch device
   205a: simulated clutch pedal
   205b: resistance force imparting portion
   205c: pedal sensor
206: touch panel
207: exterior vehicle camera
208: interior vehicle camera
209: vehicle speed sensor
210: seat cushion
   210a: pad material
   210b: skin material
220: seat back
220A: central portion
220B: side portion
   220a: pad material
   220b: skin material
221: back frame
230: headrest
240: rail device
241: lower rail
242: upper rail
243: rail drive motor
250: reclining device
251: rotation motor
260: seat movement device
261: base member
262: rotating shaft
263: rotating member
264: bag
   264a: first bag
   264b: second bag
   264c: third bag
265: air supply unit
270: seat belt device
271: seat belt
272: belt guide
273: belt buckle
274: belt retractor
274a: winding motor
280: seat notification device
281: sound output device
282: light-emitting device
290: door notification device
291: door sound output device
292: door light-emitting device
2100: ECU
2101: torque control unit
2102: lever pedal control unit
2103: seating detection unit
2104: identification information acquisition unit
2105: storage unit
2106: mode setting unit
2107: determination unit
2108: mode switching unit
2109: communication unit
2110: motor ECU
2120: seat ECU
2121: acquisition unit
2122: component control unit
2130: door ECU
2131: door acquisition unit
2132: door component control unit

1. An acoustic system, comprising:
an interior member for a conveyance including at least one speaker;
a state detection unit that detects a state of an occupant or the interior member; and
a control unit that is connected to the speaker and the state detection unit, and that controls the speaker,
wherein the control unit includes a state determination unit that determines the state of the occupant or the interior member based on information received from the state detection unit, and an acoustic control unit that controls, when sound is emitted from the speaker, at least one of a volume, a tempo, and a direction of the sound emitted from the speaker, based on the determined state of the occupant or the interior member.

2. The acoustic system according to claim 1,
wherein the state detection unit can acquire biometric information of the occupant,
the state determination unit determines the state of the occupant based on the biometric information of the occupant, and
the acoustic control unit controls the sound emitted from the speaker, based on the state of the occupant.

3. The acoustic system according to claim 2,
wherein the state determination unit determines a wakefulness of the occupant based on the biometric information of the occupant, and
the acoustic control unit controls the sound emitted from the speaker, based on the determined wakefulness of the occupant.

4. The acoustic system according to claim 3,
wherein when the wakefulness of the occupant decreases, the acoustic control unit increases the volume of the sound emitted from the speaker, or makes the tempo of the sound faster.

5. The acoustic system according to claim 1,
wherein the interior member is a conveyance seat in which the occupant is seated,
the conveyance seat includes at least two speakers disposed to be separated from each other in a seat width direction,
the state determination unit determines a posture of the occupant or a position of the conveyance seat based on the information received from the state detection unit, and
the acoustic control unit controls the sound emitted from the speakers, based on the determined posture of the occupant or the determined position of the conveyance seat.

6. The acoustic system according to claim 5,
wherein the conveyance seat is rotatable about a rotation axis in a seat up to down direction,
the state determination unit determines a rotation angle of the conveyance seat, and
the acoustic control unit controls the sound emitted from the speakers, based on the determined rotation angle.

7. The acoustic system according to claim 5,
wherein the interior members for the conveyance are a plurality of rows of the conveyance seats disposed side by side in a front to rear direction,
the state determination unit determines whether the occupant is seated in the conveyance seat, and
the acoustic control unit controls the sound emitted from the speakers according to a seating state of the occupant.

8. The acoustic system according to claim 5,
wherein the state determination unit determines a position of a head of the occupant, and
the acoustic control unit controls the sound emitted from the speakers, based on the determined position of the head of the occupant.

9. The acoustic system according to claim 1,
wherein the interior member is a conveyance seat in which the occupant is seated, and
the conveyance seat includes a damper for suppressing vibration at a position adjacent to the speaker.

10. The acoustic system according to claim 9,
wherein the conveyance seat includes a headrest that supports a head of the occupant,
the conveyance seat includes at least two speakers inside the headrest, the two speakers being disposed to be separated from each other in a seat width direction,
the headrest includes a headrest pillar serving as a skeleton, and
the damper is attached to the headrest pillar at a position sandwiched between the two speakers.

11. A vehicle, comprising:
the acoustic system according to claim 1.
